(19) United States
(12) Patent Application Publication
(10) Pub. No.: US 2018/0141126 A1
(43) Pub. Date: May 24, 2018

(54) TRANSFER OF PARTICULATE MATERIAL

(71) Applicant: Velo3D, Inc., Campbell, CA (US)

(72) Inventors: Benyamin BULLER, Cupertino, CA (US); Erel MILSHTEIN, Cupertino, CA (US); Xinrong JIANG, Palo Alto, CA (US); Sherman SEELINGER, San Jose, CA (US); Adam FISCHBACH, San Jose, CA (US); Thomas Blasius BREZOCZKY, Los Gatos, CA (US)

(21) Appl. No.: 15/873,832

(22) Filed: Jan. 17, 2018

Related U.S. Application Data
(63) Continuation of application No. PCT/US16/42818, filed on Jul. 18, 2016.
(60) Provisional application No. 62/216,324, filed on Sep. 9, 2015.
(60) Provisional application No. 62/194,770, filed on Jul. 20, 2015.

(51) Int. Cl. B22F 3/105; B22F 1/00

(52) U.S. Cl. CPC B22F 3/1055; B33Y 40/00; B22F 2003/1057; B22F 1/0018

(57) ABSTRACT

The present disclosure provides three-dimensional (3D) printing processes and systems, including methods, apparatuses, software, and systems for transferring a particulate material from one position (e.g., on one surface) to another position (e.g., on a different surface), which particulate material may be used for the production of a 3D object. In some embodiments, the particulate material may be transferred using, for example, a charged particle optical device.

### CROSS-REFERENCE

This application is a continuation of PCT Patent Application Serial Number PCT/US16/42818, filed Jul. 18, 2016, titled “TRANSFER OF PARTICULATE MATERIAL,” which claims priority to U.S. Provisional Patent Application Ser. No. 62/194,770, filed Jul. 20, 2015 titled “APPARATUSES, SYSTEMS AND METHODS FOR POWDER TRANSFER AND PRINTING,” and U.S. Provisional Patent Application Ser. No. 62/216,324, filed Sep. 9, 2015 titled “APPARATUSES, SYSTEMS AND METHODS FOR POWDER TRANSFER AND PRINTING,” each of which is entirely incorporated herein by reference.

### BACKGROUND

Three-dimensional (3D) printing (e.g., additive manufacturing) is a process for making a 3D object of any shape from a design. The design may be in the form of a data source such as an electronic data source, or may be in the form of a hard copy. The hard copy may be a two dimensional representation of a 3D object. The data source may be an electronic 3D model. 3D printing may be accomplished through an additive process in which successive layers of material are laid down one on top of each other. This process may be controlled (e.g., computer controlled, manually controlled, or both). A 3D printer can be an industrial robot.

3D printing can generate custom parts quickly and efficiently. A variety of materials can be used in a 3D printing process including elemental metal, metal alloy, ceramic, elemental carbon, or polymeric material. In a typical additive 3D printing process, a first material-layer is formed from a particulate starting material (e.g., powder), and thereafter, successive material-layers (or parts thereof) are added one by one, wherein each new material-layer is added on a pre-formed material-layer, until the entire designed 3D structure (3D object) is materialized.

Three-dimensional models may be created utilizing a computer aided design package or via 3D scanner. The manual modeling process of preparing geometric data for 3D computer graphics may be similar to plastic arts, such as sculpting or animating. In an example, three-dimensional scanning is a process of analyzing and collecting digital data on the shape and appearance of a real object. Based on this data, 3D models of the scanned object can be produced. The 3D models may include computer-aided design (CAD).

A large number of additive processes are currently available. They may differ in the manner layers are deposited to create the materialized structure. They may vary in the material or materials that are used to generate the designed structure. Some methods melt or soften material to produce the layers. Examples for 3D printing methods include selective laser melting (SLM), selective laser sintering (SLS), direct metal laser sintering (DMLS), shape deposition manufacturing (SDM), or fused deposition modeling (FDM). Other methods cure liquid materials using different technologies such as stereo lithography (SLA). In the method of laminated object manufacturing (LOM), thin layers (made inter alia of paper, polymer, metal) are cut to shape and joined together.

At times, the printed 3D object may bend, warp, roll, curl, or otherwise deform during the 3D printing process. Auxiliary supports may be inserted to circumvent such bending, warping, rolling, curling, or other deformation. These auxiliary supports may be subsequently removed from the printed 3D object to produce a desired 3D product (e.g., 3D object).

### SUMMARY

In an aspect is a method for forming a three-dimensional (3D) object, that comprises: (a) generating a pattern of particulate material on a first surface, which pattern is in accordance with a model design of the 3D object; (b) using one or more electrodes to subject the particulate material to an attractive field to release at least a portion of the particulate material from the first surface for deposition on a second surface; and (c) forming at least a portion of the 3D object from the at least a portion of the particulate material on the second surface.

The particulate material may be a powder material. The material bed may be a powder bed.

The second surface can be an exposed surface of a material bed. The formation of at least a portion of the 3D object can comprise transforming the particulate material into a transformed material. The transformed material may (e.g., subsequently) harden into a hardened material as part of the 3D object. The transformation can comprise melting, sintering, bonding, or connecting the particulate material. The formation of at least a portion of the 3D object can comprise a 3D manufacturing method. The formation of at least a portion of the 3D object can comprise an additive manufacturing method. The formation of at least a portion of the 3D object can comprise selective laser sintering. In some embodiments, the method further comprises in operation (c), emitting an energy (e.g., beam) to form the transformed material. The energy can comprise radiative energy. The energy can comprise an energy beam. The deposition can comprise a charged particle optical device (abbreviated herein as “CPOD”) that assists in depositing the at least a portion of the particulate material to the second surface. The CPOD may accelerate the at least a portion of the particulate material from the first surface onto the second surface. The particulate material can be heated prior to being accelerated. The particulate material can be heated while being accelerated. The particulate material can be heated on the second surface. The particulate material can be heated on the first surface. The second surface can comprise a planar surface or wire. The planar surface or wire was generated by a 3D printing methodology. Formation of the 3D object can comprise deforming the at least a portion of the particulate material into a deformed material. The deformation can include plastic deformation. The deformation can comprise deforming a shape of the particulate material. The deformation can comprise (e.g., substantial) permanent deformation. The deformation can comprise breaking of one or more bonds between the atoms in the particulate material. The deformation can comprise movement of one or more dislocations within the particulate material (e.g., grain thereof). The deformation can comprise slippage of one or more crystal planes of the particulate material (e.g., grain thereof). The deformation can comprise appearance of crystal slip bands within the particulate material (e.g., grain thereof). The slip bands can be detected by a microscopy method.

The microscopy method can comprise optical microscopy. The microscopy method can comprise electromagnetic, electron, or proximal probe microscopy. The electron microscopy can comprise scanning, tunneling, X-ray photo-, or Auger electron microscopy. The electromagnetic microscopy can comprise confocal, stereoscope, or compound microscopy. The proximal probe microscopy can comprise atomic force, or scanning tunneling microscopy.

In some embodiments, a portion of the material bed supports the 3D object. The 3D object may lack auxiliary support. The 3D object can comprise two auxiliary supports that are spaced apart by at least 2 millimeters. The 3D object can be suspended in the material bed. The second surface can comprise a 3D plane or a wire. The second surface can be an exposed surface of a material bed (e.g., powder bed). The portion of a material bed may serve as support for the 3D object or wire. The energy beam can be an electromagnetic beam or a charged particle beam. The particulate material can comprise elemental metal, metal alloy, ceramic, or an allotrope of elemental carbon. The particulate material can be selected from the group consisting of elemental metal, metal alloy, ceramic, and an allotrope of elemental carbon. The particulate material can be selected from the group consisting of elemental metal and metal alloy. The particulate material can comprise a metal alloy. The particulate material may exclude an organic polymer. The particulate material may exclude a hydrocarbon. The particulate material may exclude a resin. The first surface can be a photoconductive surface.

The method may further comprise prior to operation (a), (i) generating a charged pattern on the photoconductive surface using an energy source, wherein the charged pattern is of a first type of electrical polarity; and (ii) adhering the particulate material to the charged pattern, wherein the particulate material is of a second type of electrical polarity that is of a sign opposite to the first type of electrical polarity. The method may further comprise prior to operation (a), charging the particulate material with the second type of electrical polarity to form a charged particulate material. The first surface can be an exposed surface of a cylinder, a plate, or a conveyor. The first surface can be the exposed surface of a cylinder. The cylinder can comprise a conductive core. The conductive core can be of the second type of electrical polarity. Generating the charged pattern can comprise quenching the charge of the photoconductive surface in at least one (e.g., particular) position to reveal the charge of the conductive core. The cylinder can span the width or length of the material bed. The cylinder can translate (e.g., laterally) along the exposed surface of the material bed. The cylinder may rotate (e.g., revolve). The rotation may be in a direction (e.g., substantially) perpendicular to the direction of translation.

The method may further comprise before operation (ii), dispensing the charged particulate material onto an intermediate surface. The intermediate surface can be of the first type of electrical polarity. The intermediate surface can be the exposed surface of a cylinder, plate, or conveyor belt. The intermediate surface can be the exposed surface of a cylinder. The intermediate surface may rotate in one direction, wherein the photoconductive surface may be an exposed surface of a cylinder. The photoconductive surface may rotate in a second direction that is opposite to the one direction.

The deposition can comprise imaging the pattern of the particulate material on the first surface onto the second surface. The deposition can comprise guiding the particulate material. The deposition can comprise distorting a projection of the pattern of the particulate material, which pattern is formed on the first surface, which projection is on the second surface. The deposition can comprise enlarging, contracting, or preserving the pattern of the particulate material on the first surface as it is projected to the second surface. The deposition can comprise using an imaging device. The imaging device can comprise a lens. The lens can include an optical lens. The lens can include an electrostatic lens. The lens can include a magnetic lens. The lens can comprise an electrode. The imaging device can comprise a CPOD. The CPOD can comprise an electrostatic lens. The CPOD can comprise an electrostatic or magnetic electrode. The CPOD can comprise an electrostatic or magnetic field. The CPOD can comprise pneumatic electrodes. The CPOD can comprise positive or negative gas pressure. The CPOD imparts positive, neutral, or negative gas pressure. The CPOD may reside in an environment of positive, neutral (e.g., ambient), or negative gas pressure.

The method can exclude transporting the particulate material from the first surface onto a conveyor belt. The method can exclude heating the particulate material after it was released from the first surface and before it reached the second surface (e.g., during the deposition and/or imaging process). The method can exclude transforming the particulate material after it was released from the first surface and before it reached the second surface. The method can exclude heating the particulate material after it was released from the first surface and before it reached the second surface. The method can exclude rendering the particulate material tacky with an additional material before it reached the second surface. The method can comprise directly transporting the particulate material from the first surface to the second surface. Directly comprises obstacle free. Directly comprises mediation free. Mediation may comprise mechanical mediation. Mechanical mediation may comprise a stationary or moving 3D plane. The deposition can exclude transforming the particulate material. At times, the deposition can further comprise transforming the particulate material. The deposition can comprise direct deposition. The direct deposition can exclude a conveyor. The direct deposition can comprise transport tough an atmospheric gap (e.g., directly to the second surface). The direct deposition can exclude or include transforming the particulate material. The gap can be at least 0.5 mm high.

A requested 3D object and the generated 3D object may deviate (e.g., in their respective fundamental length scales) by at most 10% from each other. A fundamental length scale is the diameter, spherical equivalent diameter, length, width, or diameter of a bounding sphere, and is abbreviated herein as “FLS.” The deviation may be in circumference, cross-section, weight, or volume. A requested 3D object and the generated 3D object may deviate by at most the sum of 25 micrometers and 1/1000 times the fundamental length scale of a requested 3D object. A requested 3D object and the generated 3D object may deviate by at most about the sum of 25 micrometers and 1/2500 times the FLS of a requested 3D object.

The method may generate the 3D object without the use of auxiliary support. The method may generate the 3D object having a surface roughness of at most about 50 micrometers as measured according to the arithmetic average of the roughness profile. A FLS of the 3D object can be about 120 micrometers or more. A radius of curvature of layers of hardened material within the 3D object can be at least about 50 centimeters.

The method may further comprise after operation (d) removing residual particulate material from the first surface. The removal of residual particulate material can comprise neutralizing or reversing the charge of the photoconductive surface. The removal of residual particulate material can comprise scraping. For example, the removing can comprise scraping the first surface. The scraping can comprise using a blade or brush. The scraping can comprise using a rotating blade or brush. The method may further comprise in operation (a) leveling the particulate material on the first surface (and/or on the intermediate surface). The leveling can comprise a 3D plane (e.g., comprising a blade). The blade can comprise a doctor blade.

The particulate material can be charged using a device comprising a corona discharge, charged particle gun, a static charge device, or electrical potential difference generating device. The charged particle gun can comprise an ion gun. The static charge device can comprise a charged surface.

The method may further comprise prior to operation (c), generating a mask comprising an organic polymer. The method may further comprise disposing the mask on the second surface. The mask can be generated by a method comprising a 3D printing methodology. The mask can comprise a raster. The raster can comprise rasterized holes.

In another aspect is a system for generating a 3D object that comprises: a first surface that is configured to retain a pattern comprising a particulate material, which pattern is in accordance with a model design of the 3D object; a second surface for forming the 3D object from at least a portion of the particulate material deposited from the first surface to the second surface; one or more electrodes that are configured to subject the particulate material to an attractive field in order to (a) release at least a portion of the particulate material from the first surface, and (b) deposit the particulate material on the second surface; and a controller operatively coupled to the first surface, the one or more electrodes (e.g., material attracting electrodes), and the second surface, and wherein the controller is programmed to: (i) form the pattern of the particulate material on the first surface, (ii) use the one or more electrodes to subject the particulate material to the attractive field to release of the at least a portion of the particulate material from the first surface for deposition on the second surface, and (iii) generate at least a portion of the 3D object from the at least a portion of the particulate material at the second surface or adjacent thereto.

The first surface can be a photoconductive surface. The photoconductive surface may have a first type of electrical polarity. The system may further comprise a first energy source that causes the photoconductive surface to selectively display a second type of electrical polarity that can be opposite to the first type of electrical polarity. The system may further comprise a first energy source that causes the photoconductive surface to selectively display a neutral electrical polarity (e.g., no polarity or substantially no polarity). The polarity may correspond to a charge type). The particulate material can be a charged particulate material of the first type of electrical polarity. The second surface can be an exposed surface of a material bed.

The system may further comprise a second energy source that provides an energy to at least a portion of the material bed. In some embodiments, the energy beam does not intersect the material bed. The system may further comprise a second energy source that provides an energy to at least a portion of the particulate material (e.g., just) before it reaches the material bed. The second energy can be heat energy. The controller can be operatively coupled to the energy source and directs in operation (iii) the energy source to transform the particulate material into a transformed material. The transformed material may (e.g., subsequently) harden into a hardened material as part of the 3D object. The second energy can be an energy beam or radiative heat (e.g., non-directional heat). The second energy source can be a radiator or a lamp. The energy beam can be an electromagnetic beam or a charged particle beam. The second energy can be a second energy beam. The second energy beam can comprise an array of energy beams. The cross-sections of the energy beams may or may not overlap. The controller can be operatively coupled to the second energy beam. The controller may direct the second energy beam along a path. The electrodes may be incorporated within a CPOD that assists in depositing the at least a portion of the particulate material to the second surface. The system may further comprise a CPOD that assists in depositing the at least a portion of the particulate material (e.g., from the first surface) to the second surface. The CPOD may assists (e.g., further assist) in accelerating the at least a portion of the particulate material as it deposits from the first surface to the second surface. The generation of the 3D object can comprise deforming the at least a portion of the particulate material adjacent to, or at, the second surface into a deformed material that constitutes at least a part of the 3D object. The controller can be operatively coupled to the CPOD. The controller may direct an acceleration of the at least a portion of the particulate material. The controller can be operatively coupled to the CPOD and directs the deformation of the at least a portion of the particulate material. The deformation can be plastic deformation.

In another aspect is an apparatus for generating a 3D object that comprises a controller that is programmed to: (a) direct one or more electrodes to assist in releasing a particulate material from a first surface by subjecting at least a portion of the particulate material on a first surface to an attractive field that releases the at least a portion of the particulate material from the first surface to deposit on a second surface, wherein the particulate material is disposed on the first surface in a pattern that is in accordance with a model design of the 3D object, wherein the one or more electrodes are operatively coupled to the first surface and to the second surface; and (b) direct a generation of at least a portion of the 3D object from the particulate material on the second surface.

In another aspect is an apparatus for generating a 3D object that comprises: (a) a first surface that is configured to retain a pattern formed of a particulate material, which pattern is in accordance with a model design of the 3D object; (b) a second surface disposed adjacent to the first surface, wherein the second surface is used in forming at least a portion of the 3D object from at least a portion of the particulate material that is deposited on the second surface from the first surface; and (c) one or more electrodes disposed between the first surface and the second surface, wherein the one or more electrodes subject the particulate material to an attractive field that releases the at least a portion of the particulate material from the first surface for the deposited on the second surface (e.g., in order to deposit the particulate material on the second surface).

The apparatus may further comprise a material dispenser (e.g., as part of a material dispensing mechanism) comprising the particulate material, wherein the material dispenser dispenses the particulate material onto the first surface, wherein the material dispenser is disposed adjacent to the first surface. The apparatus may further comprise an intermediate surface. The particulate material may be disposed from the material dispenser onto the intermediate surface. The particulate material may be disposed from the intermediate surface onto the first surface. The intermediate surface may be disposed between the material dispenser and the first surface. The first surface may be a photoconductive surface. The apparatus may further comprise a first energy source that generates (e.g., emits) a first energy beam. The first energy beam may travel along a path on the photoconductive surface (e.g., at specified locations), thus facilitating the generation of a charged (e.g., or neutral) path in the specified locations. The charge may be a relative charge. Relative may be to the rest of the photoconductive surface with which the energy beam did not interact. The particulate material may be of a first type of electrical polarity. The charged path may be of a second type of electrical polarity that is opposite to the first type of electrical polarity. The apparatus may further comprise a second energy source emitting a second energy. The second energy source may transform at least a portion of the particulate material within the material bed to a transformed material that subsequently hardens to yield at least a portion of the 3D object. The apparatus may further comprise a CPOD that assists in transporting the at least a portion of the particulate material onto the second surface. The CPOD may accelerate the at least a portion of the particulate material on its transportation to the second surface. The accelerating may cause the particulate material to deform and form the at least a portion of the 3D object. The deformation may comprise plastic deformation.

In another aspect is a method for forming a 3D object that comprises: (a) generating a pattern of particulate material on a first surface, which pattern is in accordance with a model design of the 3D object; (b) using a CPOD to deposit at least a portion of the particulate material from the first surface onto a second surface; and (c) forming at least a portion of the 3D object from the at least a portion of the particulate material on the second surface.

In another aspect is a system for generating a 3D object that comprises: a first surface that is configured to retain a pattern comprising a particulate material, which pattern is in accordance with a model design of the 3D object; a second surface for forming the 3D object from at least a portion of the particulate material deposited from the first surface to the second surface; a CPOD that assists in depositing at least a portion of the particulate material from the first surface onto the second surface; and a controller operatively coupled to the first surface, the CPOD, and the second surface, and wherein the controller is programmed to: (i) form the pattern of the particulate material on the first surface, (ii) use the CPOD to transport the at least a portion of the particulate material from the first surface for deposition on the second surface, and (iii) generate at least a portion of the 3D object from the at least a portion of the particulate material at the second surface.

In another aspect is an apparatus for generating a 3D object that comprises a controller that is programmed to: (a) direct a CPOD to assist in depositing a particulate material from a first surface to a second surface, wherein the particulate material is disposed on the first surface in a pattern that is in accordance with a model design of the 3D object, wherein the CPOD is operatively coupled to the first surface and to the second surface; and (b) direct a generation of at least a portion of the 3D object from the particulate material on the second surface.

In another aspect is an apparatus for generating a 3D object that comprises: (a) a first surface that is configured to retain a pattern formed of a particulate material, which pattern is in accordance with a model design of the 3D object; (b) a second surface disposed adjacent to the first surface, wherein the second surface is for forming at least a portion of the 3D object from at least a portion of the particulate material that is deposited on the second surface from the first surface; and (c) a CPOD that deposits at least a portion of the pattern (formed of the particulate material) from the first surface to the second surface, wherein the CPOD is disposed between the first surface and the second surface, wherein the deposited particulate material subsequently forms at least a part of the 3D object.

The CPOD can comprise a magnetic or electrostatic lens. The CPOD can comprise an electrostatic column. The apparatus may further comprise a material releasing electrode. The material releasing electrode may release the particulate material from the first surface. The release may be by attracting the particulate material towards the material releasing electrode. The material releasing electrode may be disposed between the first surface and the material bed. The material releasing electrode may be included in the CPOD. The material releasing electrode can comprise a pair of electrodes. The material releasing electrode may remove the particulate material from the first surface. The release may be by repelling the particulate material from the first surface. The material releasing electrode may be disposed within the cylinder. The material releasing electrode can comprise a sharp point (e.g., a blade). The blade may be aligned along the long axis of the cylinder. A tip of the blade may be disposed adjacent to the position of powder release. The sharp point may be a tip. The tip of the blade may face the exposed surface of the material bed. The CPOD can comprise an electrostatic column. The tip of the blade may face the center of the electrostatic column.

In another aspect is a method for forming a 3D object that comprises: (a) generating a pattern of a particulate material on a first surface, which pattern is in accordance with a model design of the 3D object; (b) using an imaging device to image at least a portion of the charged particulate material from the first surface onto a second surface; and (c) forming at least a portion of the 3D object from the at least a portion of the particulate material on the second surface.

The imaging device can comprise a lens. The lens can be an optical lens. The lens can be an electrostatic lens. The lens can be a magnetic lens. Imaging can comprise deposition. Imaging can comprise transfer. Imaging can comprise relocation.

In another aspect is a system for generating a 3D object that comprises: a first surface that is configured to retain a pattern comprising a particulate material, which pattern is in accordance with a model design of the 3D object; a second surface for forming the 3D object from at least a portion of the particulate material that is imaged from the first surface to the second surface; an imaging device that images at least a portion of the particulate material from the first surface onto the second surface; and a controller operatively coupled to the first surface, the one or more material attracting electrodes, and the second surface, and wherein the controller is programmed to: (i) form the pattern of the particulate material on the first surface, (ii) use the imaging device to image (e.g., comprising transfer) the at least a portion of the particulate material from the first surface for deposition to the second surface, and (iii) generate at least a portion of the 3D object from the at least a portion of the particulate material at (or adjacent to) the second surface. The imaging device can comprise a lens. The imaging device can comprise an electrode.

In another aspect is an apparatus for generating a 3D object that comprises a controller that is programmed to: (a) direct an imaging device to image a particulate material from a first surface to a second surface, wherein the particulate material is disposed on the first surface in a pattern that is in accordance with a model design of the 3D object, wherein the imaging device is operatively coupled to the first surface and to the second surface; and (b) direct a generation of at least a portion of the 3D object from the particulate material on (or adjacent to) the second surface.

In another aspect is an apparatus for generating a 3D object that comprises: (a) a first surface that is configured to retain a pattern formed of a particulate material, which pattern is in accordance with a model design of the 3D object; (b) a second surface disposed adjacent to the first surface, wherein the second surface is for forming at least a portion of the 3D object from at least a portion of the particulate material that is deposited on the second surface from the first surface; and (c) an imaging device that images at least a portion of the pattern (comprising the particulate material) from the first surface onto the second surface, wherein the imaging device is disposed between the first surface and the second surface, wherein the imaged particulate material (e.g., subsequently) forms at least a portion of the 3D object.

In another aspect, a method for forming a 3D object comprises: (a) generating a first pattern of a particulate material on a first surface, which pattern is in accordance with a model design of the 3D object, wherein the first surface comprises a curved surface; (b) depositing at least a portion of the particulate material directly from the first surface to a second surface though a gap, wherein the first surface and the second surface are separated by the gap; and (c) forming at least a portion of a generated 3D object from the at least a portion of the particulate material on the second surface, which generated 3D object substantially corresponds to the model design of the 3D object. The particulate material can be a powder material.

Directly can comprise obstacle free. Directly can comprise (e.g., mechanical) mediation free. The gap can be an atmospheric gap. The gap can comprise a gas. The gap may exclude a third surface to which the particulate material is deposited. The deposition can be an atmospheric deposition. The atmosphere may comprise a gas. Generating in operation (a) can comprise an attractive force. The attractive force can comprise electrical or magnetic force. The first surface can include a photoconductive material. The generating in operation (a) can include using an energy beam. The energy beam may induce an alteration in a charge on the first surface. The second surface can be an exposed surface of a material (e.g., powder) bed or a platform. For example, the second surface can be an exposed surface of a material bed. Forming can include layer by layer forming. Forming can include additive manufacturing. The second surface can be substantially planar. Depositing can comprise using a charged particle optical device. Depositing can include an electrode that attracts the particulate material from the first surface. Depositing can include using an electrode that repels the particulate material from the first surface. Depositing can comprise imaging. Imaging may comprise forming a second pattern comprising the powder material on the second surface. Imaging may comprise forming on the second surface a second pattern comprising the powder material of the first pattern. The second pattern can be (e.g., substantially) identical to the first pattern. The second pattern can be (e.g., substantially) focused as compared to the first pattern. The second pattern can be (e.g., substantially) distorted as compared to the first pattern. The distorted can comprise at least partially enlarged. The distorted can comprise at least partially blurred. The distorted can comprise at least partially focused. The distorted can comprise at least partially shifted. Shifted can be in a lateral direction. Shifted can be in the average plane of the second surface. At least partially can be at least part of the imaged first pattern on the second surface. At least partially can be at least part of the second pattern. Depositing can comprise deforming at least a portion of the particulate material. Deforming can include plastically deforming. The generated 3D object may deviate by at most about the sum of 25 micrometers and 1/1000 times the fundamental length scale of the model of the 3D object. The shape of the generated 3D object may deviate by at most about ten percent from the model of the 3D object. The volume of the generated 3D object may deviate by at most about ten percent from the model of the 3D object. The material density of the generated 3D object may deviate by at most about ten percent from a requested material density of the 3D object.

A system for generating a 3D object, comprising: (a) a first surface that is configured to retain a first pattern comprising a particulate material, which first pattern is in accordance with a model design of the 3D object, wherein the first surface comprises a curved surface; (b) a second surface for forming the 3D object from at least a portion of the particulate material deposited from the first surface to the second surface, wherein the second surface is separated from the first surface by a gap; and (c) a controller operatively coupled to the first surface, the one or more particulate attracting electrodes, and the second surface, and wherein the controller is programmed to: (i) form the first pattern of the particulate material on the first surface, (ii) generate at least a portion of the 3D object from the at least a portion of the particulate material that is deposited on the second surface from the first surface though the gap, which generated 3D object substantially corresponds to the model design of the 3D object. Deposited may comprise forming a second pattern comprising the particulate material on the second surface.

In another aspect is an apparatus for generating a 3D object that comprises a controller that is programmed to: (a) direct deposition of at least a portion of a particulate material from a first surface to a second surface, wherein the particulate material is disposed on the first surface in a first pattern that is in accordance with a model design of the 3D object, wherein the first surface comprises a curved surface, wherein the first surface is separated from the second surface by a gap, wherein the one or more electrodes are operatively coupled to the first surface and to the second surface; and (b) direct a generation of at least a portion of the 3D object from the particulate material on (or adjacent to) the second surface. Deposition may comprise forming a second pattern comprising the particulate material on the second surface.

In another aspect is an apparatus for generating a 3D object that comprises: a first surface that is configured to retain a first pattern formed of particulate material, which pattern is in accordance with a model design of the 3D object, wherein the first surface comprises a curved surface; and a second surface disposed adjacent to the first surface, wherein the second surface is for accommodating (e.g., and forming) at least a portion of the 3D object from at least a portion of the particulate material deposited on (or adjacent to) the second surface from the first surface, wherein the second surface is separated from the first surface by a gap. Deposited may comprise forming a second pattern comprising the particulate material on the second surface.

In another aspect is a method for forming a 3D object that comprises: (a) generating a pattern of particulate material on a first surface, which pattern is in accordance with a model design of the 3D object, wherein the first surface comprises a curvature (e.g., a curved surface); (b) using one or more electrodes to deposit at least a portion of the particulate material from the first surface to a second surface; and (c) forming at least a portion of the 3D object from the at least a portion of the particulate material on (or adjacent to) the second surface. A curved surface of a cylinder can comprise the first surface.

Adjacent to the second surface may exclude the first surface. Adjacent to may be close to. Close to may be just at.

In another aspect is a system for generating a 3D object that comprises: a first surface that is configured to retain a pattern comprising a particulate material, which pattern is in accordance with a model design of the 3D object, wherein the first surface comprises a curvature (e.g., a curved surface); a second surface for accommodating (e.g., and forming) the 3D object from at least a portion of the particulate material deposited from the first surface to the second surface; one or more electrodes that are configured to deposit at least a portion of the particulate material from the first surface onto the second surface; and a controller operatively coupled to the first surface, the one or more electrodes, and the second surface, and wherein the controller is programmed to: (i) direct forming the pattern of the particulate material on the first surface, (ii) use the one or more electrodes to deposit the at least a portion of the particulate material from the first surface onto the second surface, and (iii) generate at least a portion of the 3D object from the at least a portion of the particulate material at (or adjacent to) the second surface.

In another aspect is an apparatus for generating a 3D object that comprises a controller that is programmed to: (a) direct one or more electrodes to assist in depositing a particulate material from a first surface onto a second surface, wherein the particulate material is disposed on the first surface in a pattern that is in accordance with a model design of the 3D object, wherein the first surface comprises a curvature, wherein the one or more electrodes are operatively coupled to the first surface and to the second surface; and (b) direct a generation of at least a portion of the 3D object from the particulate material deposited at (or adjacent to) the second surface.

In another aspect is an apparatus for generating a 3D object that comprises: (a) a first surface that is configured to retain a pattern formed of particulate material, which pattern is in accordance with a model design of the 3D object, wherein the first surface comprises a curved surface; (b) a second surface disposed adjacent to the first surface, wherein the second surface is for forming at least a portion of the 3D object from at least a portion of the particulate material deposited on (or adjacent to) the second surface from the first surface; and (c) one or more electrodes disposed between the first surface and the second surface, wherein the one or more electrodes assist in depositing the at least a portion of the particulate material from the first surface to the second surface.

In another aspect is a method for forming a 3D object that comprises: (a) dispensing a charged particulate material onto a first surface comprising a pattern having a variation in electrical charge, which pattern is in accordance with a model design of the 3D object, wherein a portion of the charged particulate material is attached to the first surface, wherein a non-attached particulate material (e.g., that does not attach to the first surface) is dispensed onto a second surface; and (b) forming at least a portion of the 3D object from the at least a portion of the non-attached particulate material on (or adjacent to) the second surface. The attachment of the particulate material to the first surface at a particular position may depend on the electrical charge (or absence thereof) of that position (e.g., the particular position in the pattern). The attachment may be selective attachment.

In another aspect is a system for generating a 3D object that comprises: a first charged surface that is configured to retain a charged or neutral pattern, which pattern is in accordance with a model design of the 3D object, and to which a charged particulate material (e.g., substantially) does not adhere; a second surface for forming the 3D object from at least a portion of the charged particulate material that does not adhere to the charged or neutral pattern, wherein the second surface is separated from the first surface by a gap; and a controller operatively coupled to the first surface, and the second surface, and wherein the controller is programmed to: (i) direct forming the charged or neutral pattern on the first surface, (ii) assist in depositing to the second surface the charged particulate material that did not adhere to the charged or neutral pattern at the first surface, and (iii) generate at least a portion of the 3D object from the at least a portion of the charged particulate material at (or adjacent to) the second surface.

The system may further comprise a material dispenser that dispenses the charged particulate material, wherein the controller is operatively coupled to the material dispenser and is programmed to direct dispensing the particulate material onto the first surface. The system may further comprise an energy source that emits energy that transforms the charged particulate material at (or adjacent to) the second surface to a transformed material. The controller may be programmed to direct the energy source to transform the particulate material that did not adhere to the charged pattern into a transformed material. The transformed material may (e.g., subsequently) hardens into a hardened material as part of the 3D object.

In another aspect is an apparatus for generating a 3D object that comprises a controller that is programmed to: (a) direct formation of a charged particulate material on a first surface comprising a pattern having at least one variation in electrical charge, wherein the pattern is in accordance with a model design of the 3D object, wherein a portion of a charged particulate material is attached to the first surface, wherein the attached depends on the electrical charge of a position on the first surface; and (b) direct a generation of at least a portion of the 3D object from the particulate material that did not attach to the first surface and is subsequently deposited on (or travels to) the second surface.

In another aspect is an apparatus for generating a 3D object that comprises: (a) a first surface that is configured to retain a pattern formed of a particulate material, which pattern is in accordance with a model design of the 3D object, wherein a portion of a particulate material is attached to the first surface in positions different from the pattern; (b) a second surface disposed adjacent to the first surface and separated from the first surface by a gap, wherein the second surface is for forming at least a portion of the 3D object from at least a portion of the particulate material that does not attach to (e.g., detaches from) the first surface and is subsequently deposited on (or travels to) the second surface.

The particulate material that does not attach to (e.g., detaches from) the first surface, may not attach to the first surface at the positions of the pattern. The apparatus may further comprise a material dispenser that dispenses the particulate material onto the first surface. The first surface can comprise a curved surface. The curved surface may be at least a portion of a cylinder. The first surface can comprise a photoconductive surface. The particulate material may be of a first type of electrical polarity, and the pattern can comprise locations having a first type of electrical polarity or be polarity neutral. The apparatus may further comprise a first energy source generating a first energy beam. The pattern on the first surface may form due to the interaction of the energy beam with the photoconductive surface. The energy beam may travel along a (e.g., predetermined) path. The apparatus may further comprise a second energy that transforms at least a portion of the non-attached particulate material to a transformed material that (e.g., subsequently) hardens to yield at least a portion of the formed 3D object. The apparatus may further comprise a second energy source generating the second energy. The second energy can comprise a radiative energy. The second energy can comprise a collimated energy beam. The second energy can comprise a dispersed energy beam. The second energy can comprise an energy beam. The first energy beam can comprise an electromagnetic beam or a charged particle beam. The material dispenser can comprise a particulate material reservoir and a particulate material opening exit. The material dispenser can comprise a slanted plane that is external to the particulate material reservoir (e.g., that is a portion of the material dispenser). The slanted plane can comprise a rough surface on which the particulate material is dispensed. The slanted plane can be disposed below the particulate material exit opening. The slanted plane can be disposed between the exit opening and the photoconductive surface. The exit opening can comprise an obstruction. The obstruction can comprise a mesh. The material dispenser can comprise an electrical field potential. The material dispenser can comprise an apparatus that injects into the particulate material a charge density. The material dispenser can comprise one or more particulate material fluidization members. The material dispenser can comprise one or more gas openings. The material dispenser can comprise one or more mixing members. The material dispenser can comprise one or more vibrators.

In another aspect is a method for non-contact leveling of a material bed that comprises: (a) identifying a height variation in an exposed surface of a material bed, wherein the material bed is utilized to accommodating (e.g., and optionally forming) at least a portion of a 3D object; and (b) adding a particulate material to the exposed surface of the material bed to form a planar surface without contacting the exposed surface of the material bed, wherein the adding is according to the identifying. The addition of the particulate material may include selective addition. The height variation may comprise a variation in the planarity of the exposed surface. The height variation may comprise a variation in the leveling of the exposed surface. The identification may comprise calculating the planarity of the exposed surface. The identification may comprise anticipating the planarity of the exposed surface. The identification may comprise measuring the planarity of the exposed surface. The identification may comprise comparing the measured variation to the calculating.

In another aspect is a system for non-contact leveling of a material bed that comprises: a material bed comprising a particulate material; a material adding mechanism that adds particulate material to the material bed, wherein the material adding mechanism comprises a exit opening port; a surface level identifier that identifies a (e.g., at least one) height variation in an exposed surface of the material bed; and a controller that is operatively coupled to the material bed, the material adding mechanism, and the surface level identifier, and is programmed to: (i) direct the surface level identifier to identify the height variation in the exposed surface of the material bed, wherein the material bed is utilized to accommodate (e.g., and optionally form) a 3D object; (ii) direct the material adding mechanism to add the particulate material to the exposed surface of the material bed according to the identification of height variation in order to form a planar surface, wherein the adding is conducted without contacting the exposed surface of the material bed.

Any of the systems, apparatuses, members, mechanisms, devices, or parts thereof disclosed herein may comprise a socket and/or a communication port. For example, the surface level identifier can comprise a socket. For example, the surface level identifier can comprise a communication port.

In another aspect is an apparatus for non-contact leveling of a material bed that comprises a controller that is programmed to: (a) direct a surface level identifier to identify a (e.g., at least one) height variation in the exposed surface of the material bed, wherein the material bed is utilized to accommodate (e.g., and form) a 3D object wherein the surface level identifier is operatively coupled to the exposed surface of the material bed; and (b) direct a material adding mechanism to add a particulate material to the exposed surface of the material bed according to the identification of height variation in order to form a planar surface, wherein the adding is conducted without contacting the exposed surface of the material bed, wherein the material adding mechanism is operatively coupled to the exposed surface of the material bed, wherein the material adding mechanism comprises an exit opening port.

In another aspect is an apparatus for non-contact leveling of a material bed that comprises: (a) a material bed having an exposed surface and a particulate material; (b) a surface level identifier that identifies a (e.g., at least one) height variation in the exposed surface of the material bed; and (c) a material adding mechanism that adds the particulate material to material bed according to the height variation identified by the surface level identification system, wherein the material adding mechanism comprises an exit opening port.

The surface level identifier can comprise a processor (e.g., a computer). The surface level identifier can comprise a software. The surface level identifier can comprise a sensor. The identification can comprise projecting a surface height variation according to procedures previously conducted in the material bed (e.g., historical data). The identification can comprise projecting a surface height variation according to historic data. The identification can comprise projecting a surface height variation according to projected data. The identification can comprise projecting a surface height variation according to software projected data. The identification can comprise detecting the height variation according to one or more sensors. The material adding mechanism can comprise a material dispenser. The material adding mechanism can comprise a first surface that is separated from the exposed surface of the material bed by a gap. The material adding mechanism can comprise generating a pattern on a first surface. The pattern may include charged particulate material. The pattern can correspond to the height variations. The correspond may comprise the variation or an inverse (e.g., negative) of the variation. The correspondence can comprise compensation. The pattern can compensate for the height variations. The material adding mechanism can further comprise a material releasing electrode. The material adding mechanism can further comprise a CPOD. The material adding mechanism can further comprise an imaging device.

The first surface can comprise a curvature. The first surface can be separated from the material bed by a gap. The material adding mechanism may further comprise an electrode situated between the first surface and the exposed surface of the material bed. The first surface can comprise a photoconductive surface. The first surface can comprise at least a portion of a curved surface of a cylinder. The apparatus may further comprise an energy source generating an energy beam that interacts with the photoconductive surface at specific locations to form a pattern. The pattern may be of a first electrical polarity type. The particulate material may be charged in a second electrical polarity type that is opposite to the first electrical polarity type. The charged particulate material may adhere to the pattern by a force comprising an electrostatic force.

In another aspect is a method for transport of a solid material that comprises transporting a charged material to a target surface by utilizing a CPOD, wherein the charged material comprises one or more solid particles.

The CPOD can comprise an electrode. The charged material can comprise a charged particulate material. The CPOD can comprise an electrostatic column. The CPOD can comprise a magnetic column. The method may further comprise heating the material to a temperature below its transforming temperature prior to and/or during the transporting.

The CPOD can comprise a gas pressure. The gas pressure can be a positive pressure. The gas pressure can be a negative pressure. The gas pressure can be an ambient pressure. The solid particles can comprise clusters of two or more (i) molecules, or (ii) non-molecular atoms. The solid particles can include nanoparticles. The solid particles can include micro-particles. The solid particles may have a FLS of five nanometers or more. The solid particles may have a FLS of five micrometers or more. The solid particles of the particulate material may have a (e.g., substantially) identical FLS. The solid particles in the particulate material may have a (e.g., substantially) identical hardness. The solid particles in the particulate material may have a (e.g., substantially) identical elastic modulus. The material can comprise (e.g., substantially) a single material type. The material can comprise two or more material types.

The CPOD can be used to deposit the particulate material to the target surface. The deposit can be a solid-state deposit. The deposit can form a metallic glass. The deposit can form a glassy metal. The deposit can form a single crystal. The deposit can form a brittle material. The deposit can form an amorphous material. The deposit can form a material with porosity of at most about 50 percent. The deposit can form a material with porosity of at most 5 percent. The deposit can form a material with porosity of at most 0.8 percent. The deposit can form a material having a thickness of at least 50 micrometers. The deposit can form a material having a thickness of at least 500 micrometers. The deposit can form a material having a thickness of at least 1500 micrometers. The CPOD can be used to relocate the material from a first surface to the target surface, wherein the first surface is separated from the target surface by a gap. The deposit can (e.g., subsequently) form a hardened material.

The method may further comprise accelerating the charged material by using the CPOD. The method may further comprise accelerating the charged material through the CPOD. At times, the charged material can be continuously accelerated. At times, the charged material can be discontinuously accelerated. For example, the charged material can be accelerated in pulses. The temperature of the accelerated charged material can be below the transforming temperature of the charged material. The charged material can be accelerated to a velocity of at least 300 meter per second. The charged material can be accelerated to at least a supersonic speed. The charged material can be accelerated to at least a transonic, supersonic, or hypersonic speed. The charged material may travel at a Mach number of at least 1. The charged material may travel at a Mach number of at least 3. The charged material can be accelerated to a velocity of at least 900 meter per second. The charged material can be accelerated to a velocity of at most 1200 meter per second. The charged material can be accelerated to a velocity of at most 1500 meter per second. Accelerating can comprise bombarding the charged material onto the target surface. The charged material can adhere to the target surface. The charged material can form at least a portion of a coating on the target surface. The accelerating can comprise spraying the charged material onto the target surface. Accelerating can comprise cold spraying the charged material onto the target surface. Accelerating can comprise kinetically colliding the charge material onto the target surface. The charged material may plastically deform. The charged material disposed on the target surface can comprise a plastically deformed material. The charged particulate material may be of a first type of electrical polarity. The target surface may be of a second type of electrical polarity that is opposite to the first type of electrical polarity. The method may further comprise repeating the method one or more times. At times, the polarity type (e.g., of the charged material) may be constant thought the repeating. At times, the polarity type may alternate in each of the repeating. The polarity type alternation may reduce a charge accumulation at the target surface. The target surface may be substantially electrically neutral. The target surface may be grounded. The charged particulate material may be of a first type of electrical polarity. The first surface can comprise an area of a second type of electrical polarity that is opposite to the first type of electrical polarity. The CPOD may image the arrangement of the solid particles on the first surface onto the target surface. In some instances, the CPOD may not image the arrangement of the solid particles on the first surface onto the target surface. The image on the target surface can comprise an enlargement of the arrangement of the solid particles on the first surface. The image on the target surface can comprise blurring of the arrangement of the solid particles on the first surface. The image on the target surface can comprise focusing of the arrangement of the solid particles on the first surface. The image on the target surface can comprise a contraction of the arrangement of the solid particles on the first surface. The image on the target surface can comprise non-blurring of the arrangement of the solid particles on the first surface. The image on the target surface may be substantially identically to the arrangement of the solid particles on the first surface. The image on the target surface can comprise a distorted image as compared to the arrangement of the solid particles on the first surface. The method may further comprise releasing the solid particles from the first surface. The method may further comprise moving the first surface relative to the target surface in a manner that preserves an (e.g., substantial) accurate image transport from the first surface to the second surface. The image may be transported regardless of the charge of a cluster that is part of the solid particles. The image may be transported regardless of the mass of a cluster that is part of the solid particles.

In another aspect is a system for transport of a solid material that comprises a target surface; a charged particle optical device (CPOD) that assists in transporting a charged material from a position away from the target surface onto the target surface, wherein the charged material comprises a solid particle; and a controller operatively coupled to the target surface and the CPOD, and is programmed to assist in transporting the charged material to the target surface by using the CPOD.

The system may further comprise a material dispensing mechanism comprising the solid material, wherein the controller is operatively connected to the material dispensing mechanism, and directs the material dispensing mechanism to dispense the solid material. The solid material may be a particulate material. The solid material can be charged prior to being disposed into the material dispensing system. The solid material can be charged within the material dispensing system. The solid material can be charged after exiting the material dispensing system. The system can further comprise a first surface. The first surface can comprise the charged solid material. The CPOD can be situated between the first surface and the target surface. The controller can be operatively connected (e.g., coupled) to the first surface. The controller can be programmed to transport the material from the first surface onto the target surface. The first surface can be a photoconductive surface. The charged material can be charged with a first type of electrical polarity. The system may further comprise an energy beam. The energy beam may cause the first surface to present a charged pattern at specified locations. The charged pattern can be of a second type of electrical polarity that can be opposite to the first type. The controller can be operatively coupled to the energy beam. The controller can be programmed to direct the energy beam along a path comprising the specified location(s). The system further can comprise one or more material releasing electrodes that release the solid material from the first surface. The optical device may further accelerate the charged material. The controller can be further programmed to accelerate the particulate material to cause them to deform at (or adjacent to) the target surface. Deformation can comprise plastic deformation.

The system can further comprise a chamber. The CPOD may be disposed within the chamber. The target surface may be disposed within the chamber. The chamber can comprise a pressurized atmosphere. The pressure can be at least about 1 atmosphere. The pressure can be at most about 1 atmosphere. At times, the pressure can be at least about 10⁻⁴ milliTorr. At times, the pressure can be at least about 10⁻⁶ milliTorr. At times, the pressure can be at most about 10⁻⁴ milliTorr. At times, the pressure can be at most about 10⁻⁶ milliTorr.

In another aspect is an apparatus for transport of a solid material that comprises a controller that is programmed to direct a CPOD to assist in transporting a charged material from a position away from a target surface onto the target surface wherein the CPOD and the target surface are operatively coupled to the controller, wherein the solid material comprises a solid particle.

In another aspect is an apparatus for transport of a solid material that comprises a CPOD, which CPOD assists in transporting a charged material from a position away from a target surface onto the target surface, wherein the CPOD is disposed between the position away from the target surface and the target surface, and wherein the charged material comprises a solid particle.

In another aspect is a method for forming a 3D object that comprises: (a) generating a first pattern of a first particulate material on a first surface, which pattern is in accordance with a model design of the 3D object; (b) using a first set of one or more electrodes to subject the first particulate material to an attractive field in order to release at least a portion of the first particulate material from the first surface for deposition on a target surface; and (c) forming at least a portion of the 3D object from the at least a portion of the first particulate material on the target surface, wherein a material bed comprises the target surface, and wherein the material bed further comprises a particulate material that is different from the first particulate material.

The target surface can be an exposed surface of a material bed. The formation of the at least a portion of the 3D object may comprise transformation and/or deformation of the particulate material. The transformation can comprise sintering or (e.g., complete) melting. The deformation can comprise plastic deformation.

The method may further comprise in operation (a), generating a second pattern of a second particulate material on the first surface, which pattern is in accordance with a model design of the 3D object. The method may further comprise in operation (b), using a first set of one or more electrodes to subject the second particulate material to an attractive field to release at least a portion of the second particulate material from the first surface for deposition on a target surface. The method may further comprise in operation (c) depositing the at least a portion of the second particulate material onto the target surface.

The method may further comprise in operation (a), in parallel or sequentially, generating a second pattern of a second particulate material on a second surface, which pattern is in accordance with a model design of the 3D object. The method may further comprise (b) in parallel or sequentially, using a first set of one or more electrodes to subject the second particulate material to an attractive field in order to release at least a portion of the second particulate material from the second surface for deposition on a target surface. The method may further comprise in operation (c), in parallel or sequentially, depositing the at least a portion of the second particulate material onto the target surface.

The method may further comprise in operation (a), in parallel or sequentially, generating a second pattern of a second particulate material on a first surface, which pattern is in accordance with a model design of the 3D object. The method may further comprise (b) in parallel or sequentially, using a second set of one or more electrodes to subject the second particulate material to an attractive field to release at least a portion of the second particulate material from the first surface for deposition on a target surface. The method may further comprise (c) in parallel or sequentially, depositing the at least a portion of the second particulate material onto the target surface.

The method may further comprise in operation (a), generating a second pattern of a second particulate material on a second surface, which pattern is in accordance with a model design of the 3D object. The method may further comprise in operation (b), in parallel or sequentially, using a second set of one or more electrodes to subject the second particulate material to an attractive field to release at least a portion of the second particulate material from the second surface for deposition on a target surface. The method may further comprise in operation (c), in parallel or sequentially, depositing the at least a portion of the second particulate material onto the target surface.

The particulate material that is different from the first particulate material may be a third particulate material. The first particulate material may have a melting point that is different from the melting point of the third particulate material. The first particulate material may have an energy absorption coefficient that is different from the energy absorption coefficient of the third particulate material. During the transforming step, the first particulate material may transform, while the third particulate material (e.g., substantially) may not transform.

The 3D object can comprise a functionally graded material. The third particulate material may provide support for the 3D object. The first pattern may be different than the second pattern. The first charged pattern may substantially complement the second charged pattern. The transformed material may (e.g., substantially) exclude the third particulate material.

The first surface may be a photoconductive surface. The first energy beam may generate the first pattern on the first surface. A first energy beam may generate the second pattern on the first surface (e.g., sequentially). The first particulate material may be charged in a type of electrical polarity that is opposite to the electrical polarity type of a first pattern charge (e.g., charge of the first pattern). The second particulate material may be charged in a type of electrical polarity that is opposite to an electrical polarity type of a second pattern charge (e.g., charge of the second pattern).

The second surface may be a photoconductive surface. A first energy beam may generate the first pattern on the first surface. The first energy beam may generate the second pattern on the second surface. The first particulate material may be charged in an electrical polarity type that is opposite to a charge of the electrical polarity type of the first pattern. The second particulate material may be charged in an electrical polarity type that is opposite to a charge of the electrical polarity type of the second pattern.

A first energy beam may generate a first pattern on the first surface. A second energy beam may generate a second pattern on the second surface. The first particulate material may be charged in an electrical polarity type that is opposite to a charge of the electrical polarity type of the first pattern. The second particulate material may be charged in an electrical polarity type that is opposite to a charge of the electrical polarity type of the second pattern.

The first and the third particulate material may be (e.g., substantially) the same type of particulate material. The first and the third particulate material may differ in the average FLS of their respective particle sizes. The first and the third particulate material may be dispensed by a material dispensing mechanism. The first particulate material may be dispensed by a first material dispensing mechanism, and the third particulate material may be dispensed by a second material dispensing mechanism.

The third and the second particulate material may be (e.g., substantially) the same type of particulate material. The first and the second particulate material may be (e.g., substantially) the same type of particulate material. The first and the second particulate material may differ in the average FLS of their respective particle sizes. The first and the second particulate material may be dispensed by a material dispensing mechanism. The first particulate material may be dispensed by a first material dispensing mechanism, and the second particulate material may be dispensed by a second material dispensing mechanism.

In another aspect is a system for generating a 3D object that comprises: a first surface that is configured to retain a first pattern comprising a first particulate material, which first pattern is in accordance with a model design of the 3D object; a target surface for accommodating (e.g., and optionally forming) the 3D object from at least a portion of the first particulate material deposited from the first surface to the target surface, wherein the target surface is an exposed surface of a material bed, wherein the material bed comprises a particulate material that is different from the first particulate material; a first set of one or more electrodes that are configured to subject the first particulate material to an attractive field to release at least a portion of the first particulate material from the first surface for deposition on the target surface; and a controller operatively coupled to the first surface, the one or more material attracting electrodes, and the second surface, and wherein the controller is programmed to: (i) direct forming the pattern of the particulate material on the first surface, (ii) direct using the first set of one or more electrodes to subject the first particulate material to the attractive field in order to release the at least a portion of the first particulate material from the first surface for deposition on the target surface, and (iii) direct generating at least a portion of the 3D object from the at least a portion of the first particulate material at the target surface.

In another aspect is an apparatus for generating a 3D object that comprises a controller that is programmed to: (a) direct a first set of one or more electrodes to assist in releasing a first particulate material from a first surface by subjecting at least a portion of the first particulate material on a first surface to an attractive field that releases the at least a portion of the first particulate material from the first surface in order to deposit the first particulate material on a target surface, wherein the first particulate material is disposed on the first surface in a pattern that is in accordance with a model design of the 3D object, wherein the first set of one or more electrodes is operatively coupled to the first surface and to the target surface, wherein the target surface is an exposed surface of a material bed, wherein the material bed comprises a particulate material that is different from the first particulate material; and (b) direct a generation of at least a portion of the 3D object from the first particulate material on the target surface.

In another aspect is an apparatus for generating a 3D object that comprises: (a) a first surface that is configured to retain a first pattern formed of a first particulate material, which first pattern is in accordance with a model design of the 3D object; (b) a target surface disposed adjacent to the first surface, wherein the target surface is for forming at least a portion of the 3D object from at least a portion of the first particulate material deposited on the target surface from the first surface; and (c) a first set of one or more electrodes disposed between the first surface and the target surface, wherein the one or more electrodes subject the first particulate material to an attractive field that releases the at least a portion of the first particulate material from the first surface for deposition on the target surface, wherein the target surface is an exposed surface of a material bed, wherein the material bed comprises a particulate material that is different from the first particulate material.

In another aspect is a method for forming a 3D object that comprises dispensing a first particulate material towards an exposed surface to form a layer of particulate material adjacent to the exposed surface, which dispensing comprises: (a) adhering a portion of the first particulate material to a revolving surface to form a second particulate material; (b) scraping the second particulate material on the revolving surface; (c) translating the revolving surface relative to the exposed surface laterally; (d) forming the layer of particulate material from a third particulate material that does not adhere to the revolving surface; and (e) generating the 3D object from at least a portion of the layer of particulate material.

The revolving surface can be separated from the exposed surface by a gap. The gap can be an atmospheric gap. The gap can comprise a gas. The translating can be during the forming. The revolving can be during the forming. The scraping can comprise scraping before, during, of after the forming. The scraping can comprise leveling. The third particulate material may translate to the exposed surface in a particulate material stream. The scraping may correlate to a density of the third particulate material in the particulate material stream. The scraping may correlate to fundamental length scale of a cross section of the particulate material stream. The scraping may comprise controlling a layer thickness formed on the revolving surface. The controlling can be during a time comprising before, during, or after the forming. The particulate material can comprise elemental metal, metal alloy, ceramics, or an allotrope of elemental carbon. The revolving can be around an axis that is substantially perpendicular to the direction of the translating. The revolving surface can comprise a curvature. The revolving surface can be at least a portion of a cylinder. The exposed surface can be of a platform or material bed. Generating can be forming. Generating can be manufacturing.

In another aspect, a system for generating a 3D object comprises: (a) a material (e.g., powder) dispenser configured to release a dispensed particulate material that comprises a first portion of particulate material and a second portion of particulate material, which material dispenser comprises an exit opening port; (b) a revolving surface that is configured to retain at least a portion of the dispensed particulate material to form a retained particulate material; (c) a scraping mechanism that is configured to scrape the retained particulate material on the revolving surface to form the first portion of particulate material; (d) an exposed surface that is separated from the revolving surface by a gap, wherein the revolving surface is configured to translate laterally relative to the exposed surface; and (e) a controller operatively coupled to the material dispenser, revolving surface, scraping mechanism, and exposed surface, and is programmed to direct the: (i) material dispenser to release the dispensed particulate material from the exit opening port, (ii) revolving surface to revolve and retain the at least a portion of the first particulate material to form the retained particulate material, (iii) scraping mechanism to scrape the retained particulate material on the revolving surface to form the first portion of particulate material, (iv) revolving surface to translate laterally relative to the exposed surface and form the layer of particulate material from the second portion of particulate material, which second portion of particulate material is not retained on the revolving surface, and (v) generating the 3D object from at least a portion of the layer of particulate material.

In another aspect, an apparatus for generating a 3D object comprises a controller that is programmed to direct: (a) a material dispenser to provide a dispensed particulate material from an exit opening port of the material dispenser, wherein the dispensed particulate material comprises a first portion of particulate material and a second portion of particulate material; (b) a revolving surface to: (i) retain at least a portion of the dispensed particulate material to forming a retained particulate material, (iii) rotate around an axis, and (ii) translate laterally relative to the exposed surface and form a layer of particulate material from the second portion of particulate material, which second portion of particulate material is not retained on the revolving surface, and (c) a scraping mechanism to scrape the retained particulate material to form the first portion of particulate material that is retained on the revolving surface, which scrape is during the revolve; (d) an energy beam to generate the 3D object from at least a portion of the layer of particulate material, wherein the controller is operatively coupled to the material dispenser, revolving surface, scraping mechanism, exposed surface, and energy beam.

The controller may comprise a processor. Provide a dispensed particulate material may cause the dispensed particulate material to exit the opening port. Causing to exit may comprise causing a portion of a particulate material within the material dispenser to vibrate. Causing to exit may comprise causing a portion of the dispensed particulate material to vibrate (e.g., at the exit opening port). Causing to exit may comprise vibrating at least a portion of the exit opening port.). Causing to exit may comprise opening (e.g., a shutter at) the exit opening port. The scraping mechanism may be stationary or moving (e.g., during, before, and/or after forming the 3D object). The energy beam may be an electromagnetic beam or a charged particle beam. Generate may comprise transform. The axis may be (e.g., substantially) perpendicular to the direction of the lateral translation. Retain can be using electrostatic or magnetic attraction. Retain can be using friction. The rotating surface can be smooth or rough. The retained particulate material can be attracted to the rotating surface by a force. The force may be electrical or magnetic. The retained particulate material can be charged by a first type of polarity. The revolving surface may be charged by a second type of polarity that is opposite to the first type of polarity. The polarity may be electrical and/or magnetic polarity.

In another aspect, an apparatus for generating a 3D object that comprises: (a) a material dispenser that is configured to dispense a dispensed particulate material that comprises a first portion of particulate material and a second portion of particulate material, which material dispenser comprises an exit opening port; (b) a revolving surface that is configured to retain at least a portion of the dispensed particulate material to form a retained particulate material, wherein the revolving surface is disposed adjacent to the material dispenser; (c) a scraping mechanism that is configured to scrape the retained particulate material on the revolving surface to form the first portion of particulate material, wherein the scraping mechanism is disposed adjacent to the revolving surface; (d) an exposed surface that is separated from the revolving surface by a gap, wherein the revolving surface is configured to translate laterally relative to the exposed surface; and (e) an energy source that generates an energy beam, which energy beam is configured to form at least a portion of the 3D object from at least a portion of the second portion of particulate material that is disposed adjacent to the exposed surface, which second portion of particulate material does not adhere to the revolving surface, which energy source is disposed adjacent to the exposed surface.

The revolving surface can be spinning, rotating, orbiting, rolling, turning around, or going around (e.g., relative to an axis). The scraping can be leveling, shaving, grazing, peeling, or thinning. The scraping mechanism can comprise a 3D plane. The scraping mechanism can comprise an edge (e.g., a blade). The blade may be symmetric or asymmetric. The symmetric blade may comprise a plane of symmetry. The plane of symmetry can be (e.g., substantially) perpendicular to the rotating plane at a point of minimal proximity between the blade tip and the rotating surface. The plane of symmetry may be normal to the surface of the rotating surface (e.g. at point where the blade is closest to the rotating surface). The blade can be tarped. The scraping mechanism can comprise a planar surface. The scraping mechanism can be separated from the rotating surface by a gap. The gap can be adjustable before, during, and/or after the 3D object is formed.

Another aspect of the present disclosure provides systems, apparatuses, controllers, and/or non-transitory computer-readable medium (e.g., software) that implement any of the methods disclosed herein.

In another aspect, an apparatus for printing one or more 3D objects comprises a controller that is programmed to direct a mechanism used in a 3D printing methodology to implement (e.g., effectuate) any of the method disclosed herein, wherein the controller is operatively coupled to the mechanism.

Another aspect of the present disclosure provides a non-transitory computer-readable medium comprising machine-executable code that, upon execution by one or more computer processors, implements any of the methods disclosed herein.

In another aspect, a computer software product, comprising a non-transitory computer-readable medium in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled to the mechanism.

Another aspect of the present disclosure provides a computer system comprising one or more computer processors and a non-transitory computer-readable medium coupled thereto. The non-transitory computer-readable medium comprises machine-executable code that, upon execution by the one or more computer processors, implements any of the methods disclosed herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings or figures (also “FIG.” and “FIGS.” herein), of which:

FIG. 1 schematically illustrates a three-dimensional (3D) printing system;

FIG. 2 schematically illustrates a 3D printing system;

FIG. 3A schematically illustrates horizontal cross sections of a printed layer; FIGS. 3B-3C schematically illustrate vertical cross-sections of material profiles;

FIG. 4 is a schematic cross-sectional side view of a 3D printing system;

FIG. 5A schematically illustrates a vertical cross section of a charged particle optical device; FIG. 5B schematically illustrates field lines formed by the charged particle optical device;

FIGS. 6A-6B schematically illustrate various vertical cross sections of trajectories of particles traveling through charged particle optical devices;

FIG. 7A schematically illustrates a vertical cross section of a charged particle optical device; FIG. 7B schematically illustrates a vertical cross section of particle trajectories traveling through a charged particle optical device;

FIG. 8 schematically illustrates a 3D printing system and its components;

FIGS. 9A-9B schematically illustrate vertical cross sections of various mechanisms for dispensing material;

FIGS. 10A-10D schematically illustrate vertical cross sections of various mechanisms for dispensing material;

FIG. 11 schematically illustrates a vertical cross section of a mechanism for dispensing material;

FIG. 12 schematically illustrates a computer control system that is programmed or otherwise configured to facilitate the formation of a 3D object;

FIGS. 13A-13D schematically illustrate vertical cross sections of various mechanisms for dispensing material;

FIGS. 14A-14D schematically illustrate vertical cross sections of various mechanisms for dispensing material;

FIG. 15 schematically illustrates a vertical cross section of a mechanism for dispensing material;

FIG. 16 schematically illustrates a vertical side cross section of a mechanism for dispensing material;

FIG. 17 schematically illustrates a vertical cross section of a 3D printing system and its components;

FIG. 18 schematically illustrates a vertical cross section of a 3D printing system and its components;

FIG. 19 shows schematics of various vertical cross sectional views of various 3D objects or portions thereof;

FIG. 20 schematically illustrates a 3D object; and

FIG. 21 shows a top view of a 3D object.

The figures and components therein may not be drawn to scale. Various components of the figures described herein may not be drawn to scale.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed.

Terms such as “a,” “an” and “the” are not intended to refer to only a singular entity, but include the general class of which a specific example may be used for illustration. The terminology herein is used to describe specific embodiments of the invention, but their usage does not delimit the invention. When ranges are mentioned, the ranges are meant to be inclusive, unless otherwise specified. For example, a range between value 1 and value 2 is meant to be inclusive and include value 1 and value 2. The inclusive range will span any value from about value 1 to about value 2.

The term “adjacent” or “adjacent to,” as used herein, includes ‘next to’, ‘adjoining’, ‘in contact with,’ and ‘in proximity to.’ The term “adjacent to” may be ‘above’ or ‘below.’

In another aspect provided herein are apparatuses, systems, software, and methods for Particulate Material Printing (e.g., Powder Printing) integrated with three-dimensional (3D) printing. These comprise transforming a deposited pre-transformed material (e.g., a particulate material such as, for example, powder) to a transformed material that subsequently hardens and forms a hardened 3D object (herein “3D object”). Harden may comprise solidify. Transform may comprise melt or sinter. The apparatuses, systems and/or methods described herein may be utilized for at least one of these purposes: 1) a non-contact powder application of a leveled particulate material layer; 2) multiple material printing (e.g., forming functionally graded material); and 3) material selective printing that may utilize a selective property of the material (e.g. degree of energy absorption, or melting point), which may incorporate using either a heat source that is selective (e.g., energy beam) or a non-selective (e.g., lamp or radiator). The methodologies described herein can enable printing two or more materials in a single layer of a 3D object. Such methodology may enable printing functionally graded materials.

Pre-transformed material, as understood herein, is a material before it has been transformed during the 3D printing process. The transformation can be effectuated by utilizing an energy beam and/or flux. The pre-transformed material may be a material that was, or was not, transformed prior to its use in a 3D printing process. The pre-transformed material may be a starting material for the 3D printing process.

The methods may comprise printing a particulate material (e.g., in a certain pattern), transforming the printed particulate material to a transformed material that subsequently hardens to form at least a portion of the generated 3D object. The pre-transformed material (e.g., particulate material) may be disposed onto a target surface (e.g., a building platform, or an exposed surface of a material bed). The particulate material may be printed using masking (e.g., rastering), material plotting (e.g., powder plotting), or material printing (e.g., powder printing). The building platform may comprise a substrate, base, or a bottom of an enclosure.

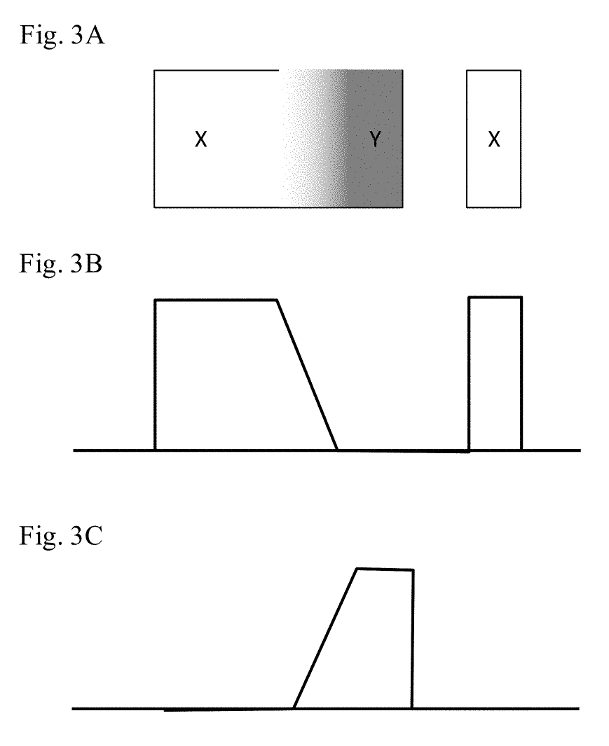

In another aspect provided herein are methods, systems, software, and apparatuses for pre-transformed material printing using a mask. The method comprises using and/or producing a mask. The mask can be produced using a 3D printing methodology. For example, a (e.g., organic) polymer, or resin based 3D printing methodology. The mask may be produced using a mask producing methodology used in the semiconductor industry, metal casing industry, or printing industry. The mask may be disposed on the target surface and the empty spaces of the mask may be filled by the disposed pre-transformed material. The pre-transformed material may be a particulate material. In some embodiments, the pre-transformed material may be liquid. The mask may subsequently be removed, and the pre-transformed particulate material may be transformed and subsequently hardened to produce a hardened layer that forms at least a portion of the 3D object. The newly deposited pre-transformed material can be of a different material type, or can be of the same material type as (i) the pre-transformed material in the material bed (e.g., powder bed) and/or (ii) the hardened material (e.g., in a previously made layer of the 3D object). Usage of a plurality of masks can allow deposition of several different material types within the same layer of a 3D object. The mask can be an analogue, digital, or binary mask. The binary mask may comprise positions that allow material deposition, and positions that exclude material deposition. The binary mask may include portions that facilitate (e.g., substantially) zero or (e.g., substantially) one material concentration value. The gradient mask may include positions of a gradient of material concentration. The gradient mask may facilitate deposition of varied material concentration at certain positions. FIG. 3A shows an example of a horizontal cross-section of a layer of (e.g., hardened or pre-transformed) material comprising materials X and Y. FIG. 3B shows and example of a vertical cross section (e.g., a profile) of a material X within the layer of (e.g., hardened or pre-transformed) material depicted in FIG. 3A. FIG. 3C shows and example of a vertical cross-section of (e.g., hardened or pre-transformed) material Y within the layer depicted in FIG. 3A. Appropriate masks can be devised to separately materials X and Y within the same layer to form the layer in FIG. 3A.

In another aspect provided herein are methods, systems, software, and apparatuses for plotting a pre-transformed material (e.g., powder) onto a target surface. These may utilize a material dispensing mechanism (e.g., funnel) to dispense a controlled amount of pre-transformed material at a certain location on the target surface (e.g., an exposed surface of a powder bed). The material dispensing mechanism can be a material dispenser (also referred to herein as “material feeder”). The material plotter may plot the pre-transformed material (e.g., powder) without contacting the target surface. The planarity of the top surface of the newly printed pattern may be monitored using at least one sensor, software, and/or computer. An exit opening (e.g., nozzle, or hole) in the material dispensing mechanism may include an array of openings. The pre-transformed material may flow down using a force comprising gravity, electrostatic, electric, magnetic, and/or pressure. The material dispenser may be a hopper.

In another aspect provided herein are methods, systems, software, and apparatuses for printing a pre-transformed material onto a target surface. These may utilize an item (e.g., roller or drum) comprising a source surface (e.g., a photoconductive surface, and/or a photoreceptive surface), whose interior is chargeable and/or magnetizable (e.g., metallic). An energy beam (e.g., a laser or an electron gun) may alter the charge (e.g., electric or magnetic charge) of the source surface according to a pattern (e.g., predetermined pattern). The pattern may be in accordance with a model design of the 3D object. The pattern may be derived from a design of the 3D object. The design of the 3D object may derive from the requested and/or modeled 3D object. The pattern may derive from a section of the design and/or model of the 3D object. The pattern may comprise a distortion of the model and/or design of the 3D object. The pattern may comprise a distortion of a cross-section of the model and/or design of the 3D object.

The pattern may be at least a portion of the (e.g., source) surface. For example, the pattern may (e.g., substantially) cover the entire (e.g., source) surface. At times, the pattern may not relate to a design of the 3D object. For example, the pattern may relate to one or more height variation at the exposed surface of the material bed.

A chargeable pre-transformed material (e.g., metal powder) may selectively adhere to specific location on the source surface, depending on its charge relative to the charge at the specific locations. The pattern on the source surface will subsequently translate to a pattern on the target surface, as the pre-transformed material (e.g., particulate material such as, for example, powder) relocates (e.g., deposits) from the source surface to the target surface (e.g., via gravitational fall, or an electrostatic lens).

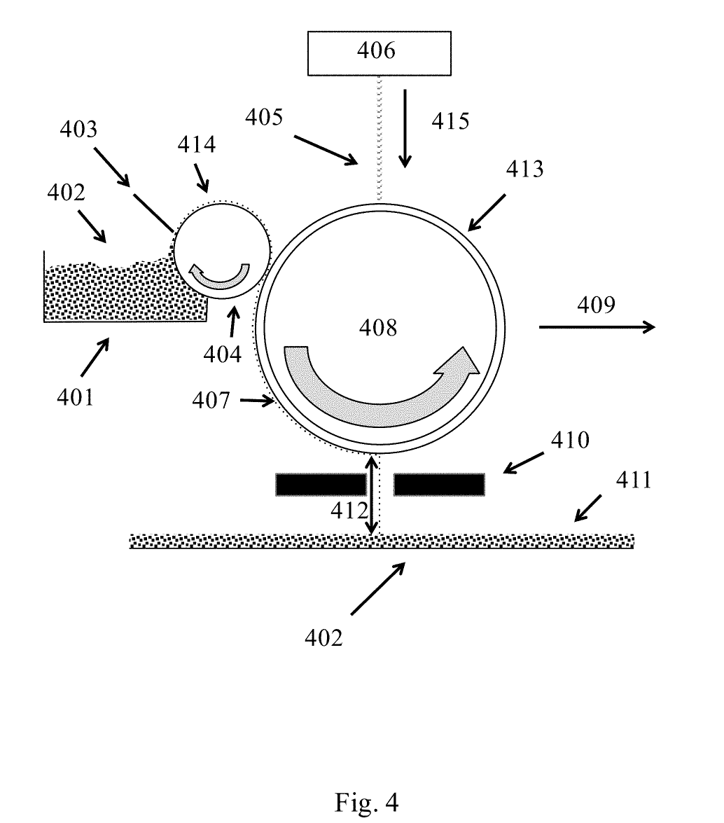

In one embodiment, the charged particulate material of a first polarity (e.g., negative) may contact an item comprising both a source surface (e.g., a photoconductive polymer surface) having the first polarity (e.g., negative), and an interior having the opposite polarity (e.g., positive). For example, the photoconductive polymer surface may comprise conductive polyurethane. The contact may be direct or indirect contact (e.g., though an intermediate surface). FIG. 4 shows an example of an indirect contact between the particulate material within a particulate material reservoir having a top opening 402 and the source surface 407, namely though an intermediate surface 404. The intermediate surface may be a part of a developer. The developer may comprise a reservoir or a material dispenser, and the intermediate surface. The intermediate surface may be situated on a chargeable item (e.g., cylinder) comprising a chargeable (e.g., electric or magnetic) core. The source surface and/or the intermediate surface may encase a metallic core, chargeable core, magnetic core, or any combination thereof. The chargeable item may revolve around the core (e.g., fixed magnetic core). The developer may comprise a charging device to charge the pre-transformed particulate material. An energy beam may react with the photoconductive polymer surface (e.g., coating) of the item to quench its charge at specific respective locations of interaction (e.g., selectively discharge regions on the photoconductive surface), and thus reveal the charge of the interior of the item (e.g., cylinder or drum). The item may be a 3D plane (e.g., planar), the item may comprise a rotational symmetry in at least one axis (e.g., long axis). FIG. 4 shows an example of an energy beam projected from an energy source 406, which energy beam travels in the direction 415, and interacting with the source surface 413. This energy beam may cause the source surface to reveal a charge of an interior of the item (e.g., 408) at specification locations (e.g., where the energy beam interacts with the source surface). In this manner, the energy beam may generate a charged pattern on the surface of the item (e.g., the source surface). An item can be a piece. An item can be a planar object. An item can be a box. An item can be a ball. An item can be a roller. An item can be a drum (e.g., a rolling drum). An item can be a cylinder. An item can have any geometrical cross-section such as, for example, a circle, ellipse, a square, rectangle, diamond, or star. The charged pre-transformed material (e.g., powder) having the first polarity may adhere to the laser-generated pattern on the source surface having the opposite polarity. The patterned pre-transformed material may detach from the source surface and transfer to the target surface by contacting with the target surface, which target surface may comprise an enhanced opposite polarity to the first polarity. The patterned pre-transformed material may detach from the source surface and transfer to the target surface by an aid (e.g., thought) a charged particle optical device (herein abbreviated as “CPOD.” E.g., an electrostatic column) that either preserves or controllably distorts the pattern of the pre-transformed material on the source surface. In some embodiments, the charged pre-transformed material (e.g., powder) of a first polarity may contact an intermediate surface of an opposite (e.g., second) polarity (e.g., positive), which transfers a layer of pre-transformed material to the source surface. The intensity of the charge (e.g., positive and/or negative) of the pre-transformed material, the target surface, the intermediate surface, and/or the item interior (e.g., core) may be substantially identical or varied. For example, a charge of the interior of the item (e.g., drum) may be stronger than a charge of the same polarity type on the intermediate surface. For example, a charge at the target surface may be stronger than a charge of the same polarity type on the source surface.

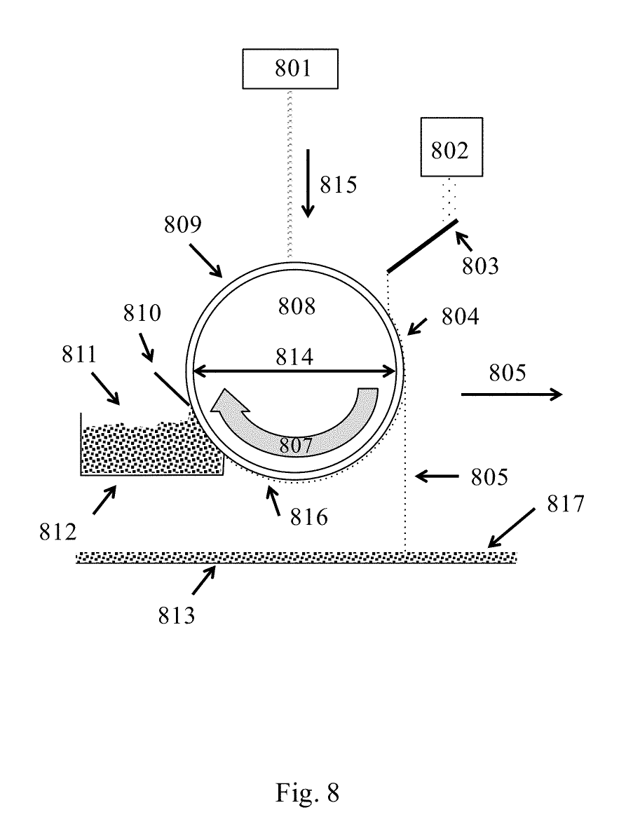

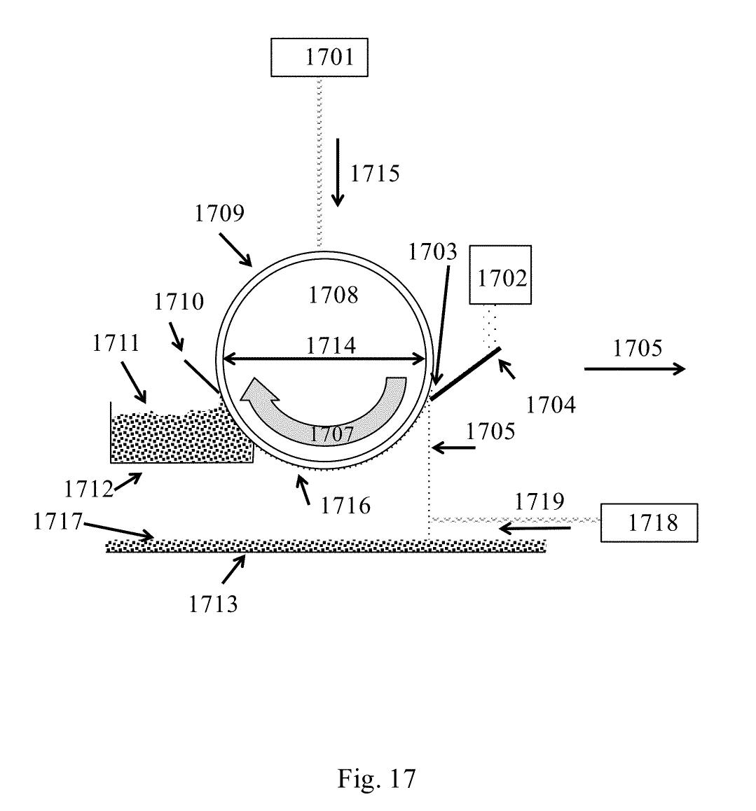

In another aspect provided herein are methods, systems, software, and apparatuses for printing a particulate material onto a target surface. The method may comprise a rotating item (e.g., a drum) comprising both a source surface (e.g., that comprises a photoconductive polymer) having one polarity (e.g., negative), and an interior of an opposite polarity (e.g., positive). An energy beam may controllably interact (e.g., react) with the source surface (e.g., coating) to quench the charge of the source surface at the position of interaction, and thus reveal the charge of the interior at that position. Following the interaction with the energy beam, a pre-transformed material having the opposite polarity (e.g., electrical or magnetic) may be dispensed from a material dispensing mechanism onto the source surface at a certain position. The pre-transformed material may be deposited on the source surface, or just under the source surface. Having an opposite polarity, the dispensed pre-transformed particulate material may adhere to positions on the source surface at which the energy beam did not interact with the source surface. In some embodiments, the dispensed pre-transformed material with the opposite polarity may be attracted (e.g., pulled) to the positions on the source surface at which the energy beam did not interact with the source surface. These positions may be position that do not include the latent pattern (i.e., latent image). FIG. 17 shows an example of a pre-transformed material that is dispensed from a material dispenser which includes parts 1702 and 1704, and dispenses pre-transformed material that is attracted at position 1703 to the revolving source surface 1709, depending on the charge of the source surface at that particular position. The pre-transformed material that was not attracted to the source surface at position 1703, may continue to fall to the target surface (e.g., 1717). The dispensed pre-transformed material may not adhere to positions on the source surface at which the energy beam did interact, and thus may continue to fall 1705 towards the target surface 1717. The pre-transformed material that will reach the target surface may correspond to a negative of (e.g., a complementary pattern to) the latent pattern that is generated on the source surface. The source surface comprising the charged pattern may act as an on/off switch for a free-fall of the dispensed pre-transformed material. FIG. 8 shows an example of a schematic material dispensing mechanism (including parts 802 and 803) that dispenses a pre-transformed material onto a selectively charged source surface 809 comprising a charged pattern (e.g., latent image) that can be generated with the assistance of an energy beam that is projected from an energy source 801, which energy beam travels in the direction 815 and interacts with the source surface 809 at specific positions to generate the charged pattern (e.g., a latent pattern). The (charged) pre-transformed material may come in contact with the charged pattern on the source surface, and may adhere to the source surface depending on the charge at the position of interaction between the pre-transformed material and the source surface. For example, the pre-transformed material may adhere to positions on the surface that are different from the position included in the charged (e.g., latent) pattern (e.g., to form a negative image thereof). In the example of FIG. 8, the material that did not adhere to the source surface continues to fall 805 towards the target surface 817, and generate a pre-transformed material pattern (i.e., real pattern) similar to the latent pattern (e.g., on the source surface). The pre-transformed material that did adhere to the source surface 816 can be removed from the surface (e.g., by a scraper or wiper 810).

The source surface and/or the energy beam (and/or energy source) may travel laterally relative to (e.g., along) the target surface. The target surface may travel laterally relative to (e.g., along) the source surface and/or the energy beam (and/or energy source). The pre-transformed material printer (e.g., powder printer) may generate a patterned layer of the relocated pre-transformed material on the target surface. A scraper (e.g., wiper) can remove the material off the source surface before reaching the patterning energy beam (e.g., emitted from 801) again. The scraper can be mechanical such as a blade, or a brush. The scraper may be magnetic or electronic (e.g., an energy beam). The electronic scraper may alter the charge along the source surface segment to allow pre-transformed material removal before reaching the patterning energy beam again. The released pre-transformed material from the source surface can be reused (recycled) in the printing process. The pre-transformed material can be of the same, or of a different, material type than the one in the material bed. The pre-transformed material printer may print the same material type in each lateral scan of the target surface, or may print a different material type in at least one scan of the target surface.

In some instances, the pre-transformed material printed on the target surface (e.g., exposed surface of the powder bed) may be transformed via heat. The heat can be generated by a single energy beam, an overlapping array of energy beams (e.g., LED array), a lamp, a radiator, any radiative heat source, or any combination thereof.

The integrated printer can be used as a non-contact recoater (e.g., layer dispensing mechanism), be utilized for multi material printing (e.g., with selective transformation). The selective transformation (e.g., fusing)) can be based on: (i) absorption contrast of the various pre-transformed materials deposited in a single layer (e.g., single powder layer deposited on the exposed surface of the powder bed), (ii) difference in their respective melting points, or (iii) any combination thereof. Fusing may comprise completely melting or sintering.

In a mixture of material types, one material may be used as a support (e.g., supportive powder), insulator, heat sink, or as any combination thereof.

In another aspect are methods, systems, software, and apparatuses for transfer of a solid material, comprising: transporting a charged material to a target surface. These may utilize a Charged Particle Optical Device (abbreviated herein as “CPOD”), wherein the charged pre-transformed material comprises one or more particulates (e.g., solids).

A charged particulate material may be transported from one end to another end of a CPOD (e.g., an electrostatic column). For example, from a source surface to a target surface. For example, from a material dispensing exit opening port to a target surface. The method can be used to deposit particulate material on a target surface. This deposition can be used to print a 3D object. The CPOD may accelerate the particulate material and cause it to deform (e.g., plastically deform). The particulate material may comprise a solid.

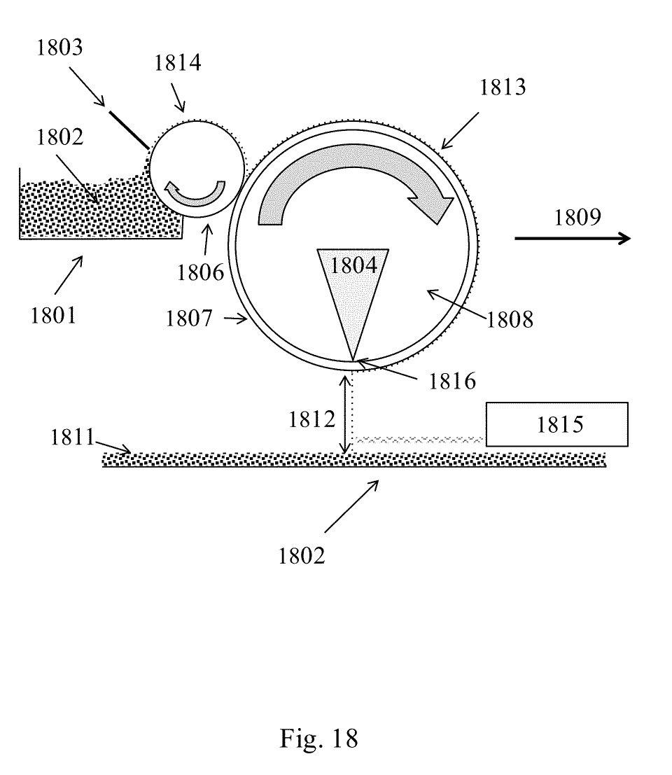

The source of the particle(s) can be a source surface (e.g., of a rotating drum). One or more material releasing electrodes may release (e.g., attract or repel) the pre-transformed particulate material from the source surface. The material releasing electrode(s) may be situated adjacent to the source surface. The material releasing electrodes may be situated within (e.g., FIG. 18, 1804) the item (e.g., drum, or cylinder; 1808) that comprises the source surface (e.g., 1807). The material releasing electrodes may be situated outside (e.g., FIG. 4, 410) the item (e.g., 408) that comprises the source surface (e.g., 413). The electrode(s) may comprise a blade, and edge, a point, or a pin. The blade, or edge, may be aligned along the long axis of the item (e.g., cylinder). The blade, or edge, may be disposed adjacent to the position where the material is to be released (e.g., 1816). The tip (e.g., of the blade or pin) may face the target surface (e.g., exposed surface of the material bed, 1811). The material releasing electrodes may form a constant field or a pulsing field. The field may be generated by a direct current or an alternating current. A pulsing current may generate the field. The electrodes may produce an electric arc (i.e., an arc discharge). The material may be released from the source surface by arc discharge. The charged CPOD may comprise an electrostatic column. The tip (e.g., of the pin or blade) may point to the (e.g., vertical) center of the electrostatic column (e.g., 716). The tip may point to the (e.g., vertical) center of the CPOD. A 3D object may be printed by combining the material printing method with a CPOD. For example, by imaging the particles from the source surface (e.g., 711) to the target surface (e.g., 712. E.g., an exposed surface of a powder bed) and using the imaged pre-transformed material to print a 3D object via additive 3D printing methodology (e.g., transforming the pre-transformed particulate material to form transformed material that subsequently hardens to form at least a portion of the 3D object). For example, by imaging the particulate material from the source surface to the target surface and transforming the pre-transformed material (e.g., that reaches the target surface) and subsequently forming at least a portion of the 3D object.

In some examples, the source surface may comprise a pattern. The pattern may be a pattern of charge variations. The pattern may be formed by charge variations in specific positions on the source surface. The charge variations can be brought about by an interaction of an energy (e.g., energy beam) with the source surface (e.g., photoconductive surface) at specific locations. Such pattern is named herein “charge-pattern,” “a pattern of charges” “a pattern of charge variations,” “charge varied pattern,” “latent pattern,” or “latent image.” The pattern may be a pattern of pre-transformed material. The pattern may be formed by variations in pre-transformed material concentration at specific positions on the source surface. The variations in pre-transformed material concentration can be binary variation (e.g., Yes/No pre-transformed material; pre-transformed material present or not). The concentration variations of the pre-transformed material can be brought about by an interaction of the charged pre-transformed material with the source surface that comprises the charge-pattern. The pre-transformed material pattern on the source surface may be formed according to the interaction of a particulate material with a specific position on the source surface, for example, based on their charge related interaction. The charge related interaction can include electrical repulsion/attraction, or magnetic repulsion/attraction. A pattern formed by the pre-transformed material is referred to herein as “material-pattern,” “pattern of material,” “pattern of material concentration variations,” “material concentration varied pattern,” “real pattern,” or “real image.”

In some embodiments, the target surface may be charged with the same polarity type as the polarity type of the charged design at the source surface. The amplitude of the charge at the target surface may be (e.g., much, substantially, or considreably) greater that the amplitude of the charged design. The material may be attracted more to the target surface than to the charged design (e.g., latent image) on the source surface, for example, due to the magnitude of charge at the target surface. In some embodiments, the target surface may be charged with an opposite polarity type as compared to the polarity type of the charged design at the source surface.

In some embodiments, the source surface that comprises the charged pre-transformed material pattern may translate (e.g., laterally, FIG. 8, 805) and/or rotate (e.g., FIG. 8, 807). An area of particles situated on the source surface may be released from it as the source surface translates and/or rotates. The attraction force between the particle and the position at the source surface from which it was released, may decrease as the source surface continues to translate. The rotation and translation movements can be synchronized to cancel out any offset of the particle during its decent to the target surface (e.g., within the CPOD). The pattern formed at the source surface may ensure a desired imaging pattern on the target surface.

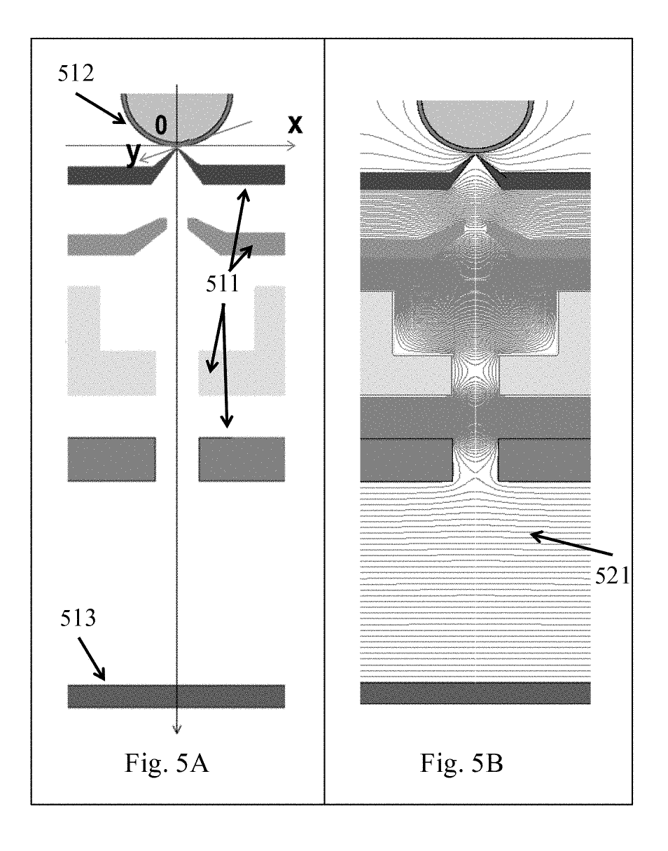

In another aspect are methods, systems, software, and apparatuses that assist in the transport or relocation of one or more charged pre-transformed materials. Relocation may comprise deposition. Transfer may comprise deposition. The transport may comprise transfer. The transport may comprise deposition. The deposition may comprise surface deposition. The surface may comprise a solid surface, semi-solid, or fluid surface. The surface may comprise an exposed surface of a material bed. The surface may comprise a flat, planar, or non-planar (e.g., curved) surface. The surface may be a 3D plane. The 3D plane may be planar, curved, or assume an amorphous 3D shape. The 3D plane may comprise a curvature. The 3D plane may be curved. The 3D plane may be planar (e.g., and flat). The 3D plane may have a shape of a curving scarf. The term “3D plane” is understood herein to be a generic (e.g., curved) 3D surface. For example, the 3D plane may be a curved 3D surface. The 3D plane may be from a rigid or flexible material (e.g., any material as disclosed herein). The surface may be a surface of a plane or of a wire. The surface may be a surface of an object. The object may comprise a 3D printed object. The methods, systems, and/or apparatuses may facilitate the transport of one or more charged materials (e.g., particles) to a target by utilizing a charged particle optical device (CPOD). The target may include a target surface. In some instances, the material may be transported from one end of the CPOD, to its other end. The transport may be though the CPOD. In some instances, the CPOD comprises a charged particle optical column. The charged particle optical column may be an electrostatic column. The charged particle optical column may be a magnetic column. The CPOD may comprise one or more electrodes. The one or more electrodes may form various fields (e.g., FIG. 5B, 521). The various fields may vary in their magnitude. The charged particle may respond to the fields generated by the one or more electrodes. The varied fields may direct a charged particle though the CPOD. The varied fields may direct a charged particle from one end of the CPOD to its other end. The varied fields may direct a charged particle from the source surface to the target surface. FIG. 5A shows an example of various electrodes 511 that form a CPOD, which electrodes are disposed between a source surface (e.g., 512) and a target surface (e.g., 513). FIG. 5B shows an example of various field lines (e.g., 521) generated by the CPOD that is depicted in FIG. 5A.

In some instances, the charged pre-transformed material may be accelerated though the CPOD. The charged material may be accelerated to at least about a subsonic, transonic, supersonic, hypersonic, high hypersonic, or re-entry speed. The charged material may be accelerated to at most about a subsonic, transonic, supersonic, hypersonic, high-hypersonic, or re-entry speed. The charged material may be accelerated to a speed that is between any of the aforementioned speed (e.g., to a speed that is from transonic to hypersonic, from supersonic to high hypersonic, or from subsonic to re-entry). The charged material may be accelerated to a Mach number of at least about 0.001 Mach, 0.03 Mach, 0.005 Mach, 0.007 Mach, 0.01 Mach, 0.03 Mach, 0.05 Mach, 0.07 Mach, 0.1 Mach, 0.3 Mach, 0.5 Mach, 0.7 Mach, 1 Mach, 2 Mach, 3 Mach, 4 Mach, 5 Mach, 6 Mach, 7 Mach, 8 Mach, 9 Mach, 10 Mach, 15 Mach, 20 Mach, 25 Mach, or 30 Mach. The charged material may be accelerated to a Mach number of at most about 30 Mach, 25 Mach, 20 Mach, 15 Mach, 10 Mach, 9 Mach, 8 Mach, 7 Mach, 6 Mach, 5 Mach, 4 Mach, 3 Mach, 2 Mach, 1 Mach, 0.7 Mach, 0.5 Mach, 0.3 Mach, 0.1 Mach, 0.07 Mach, 0.05 Mach, 0.03 Mach, 0.01 Mach, 0.007 Mach, 0.005 Mach, 0.003 Mach, or 0.001 Mach. The charged material may be accelerated to any value between the aforementioned Mach numbers (e.g., from about 1 Mach to about 30 Mach, from 1 Mach to 8 Mach, or from 7 Mach to 30 Mach, from about 0.01 Mach to about 0.7 Mach, from about 0.005 Mach to about 0.01 Mach, from about 0.05 Mach to about 0.9 Mach, from about 0.007 Mach to about 0.5 Mach, or from about 0.001 Mach to about 1 Mach). Mach as used herein may refer to Mach number that represents the ratio of flow velocity past a boundary to the local speed of sound. The charged material may be deformed prior to reaching the target surface. The charged material may be deformed at the target surface. The deformation may comprise elastic or plastic deformation. In some instances, the deformation may be plastic deformation.

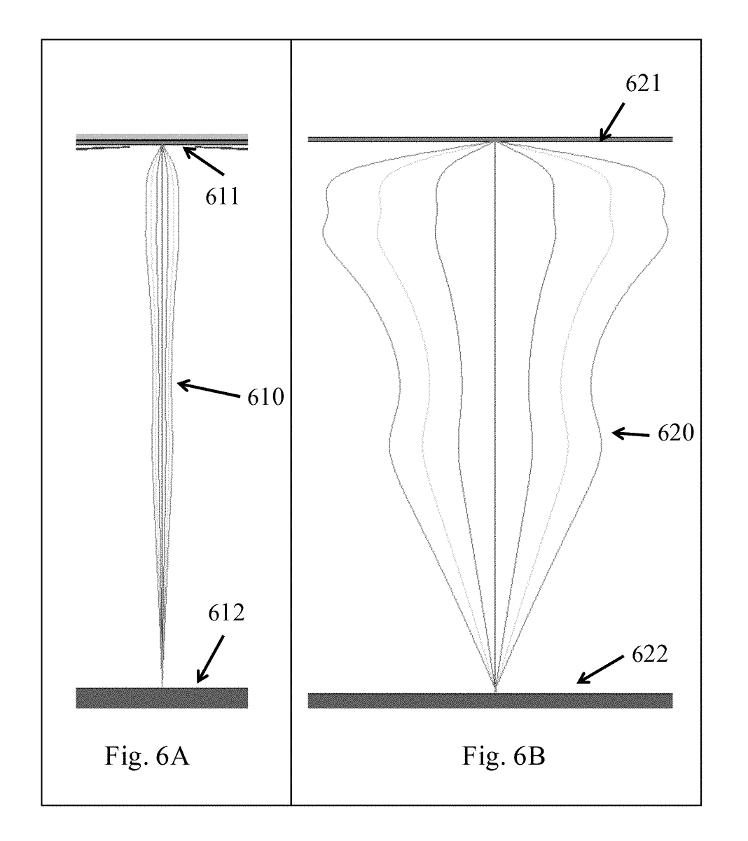

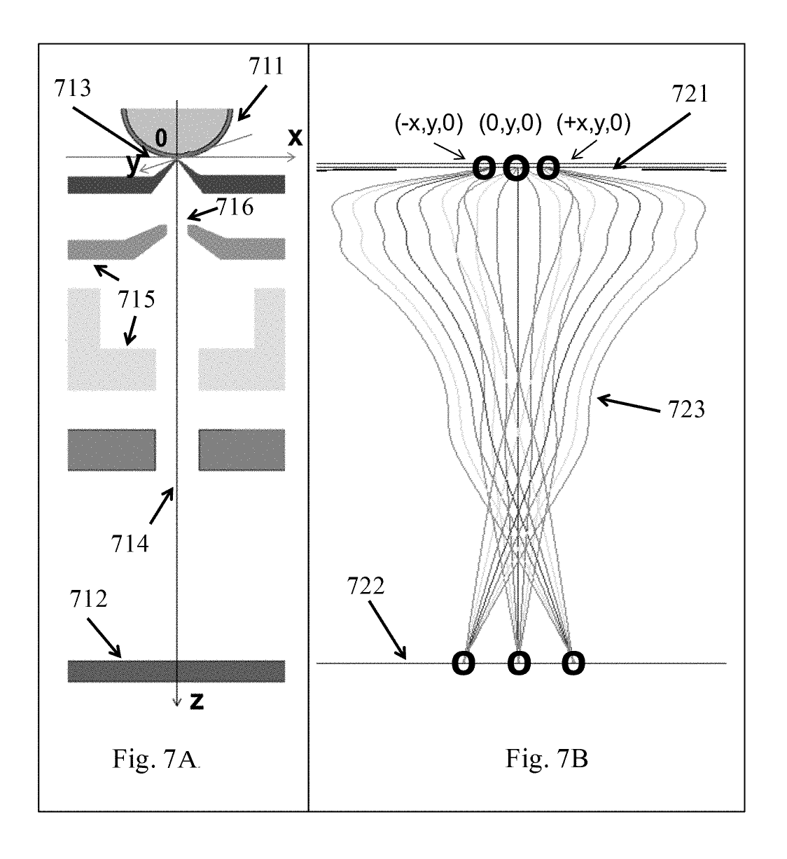

The CPOD may comprise one or more lenses (at least one lens). The lens may be an aperture. The lens may be an electrostatic or magnetic lens. The lenses may induce, exhibit, form, and/or cast an electric field. The lenses may induce a voltage. The lenses may induce, exhibit, form, and/or cast a magnetic field. FIG. 5A schematically shows an example of a CPOD comprising several lenses (e.g., 511). The CPOD may comprise a system of lenses. The lens may assist the transport, transfer, and/or relocation of one or more charged particles. In some instances, the CPOD transports the charged particle(s). Sometimes, the charged particle(s) are transported though the CPOD. For example, through the central unobstructed space within the CPOD. FIG. 7A shows an example of an unobstructed space in which the material travels within the CPOD, as shown in the example of the trajectory 714. The unobstructed space may be a space that lacks physical obstructions. The unobstructed space may comprise an atmosphere comprising one or more gasses. The unobstructed space may comprise a gas. The unobstructed space may comprise an ambient pressure, a positive pressure, or a negative pressure (i.e., vacuum). The particles may be solid, semi-solid, or liquid particles. The liquid particles may be vesicles or droplets. The particles may be solid, but become liquid during their CPOD assisted transport and/or acceleration (e.g., though a phase change such as (e.g., complete) melting). The particles may comprise powder particles. The powder material may comprise powder particles. The lens may comprise an electrostatic or magnetic lens. The lens may direct the movement of one or more charged particles. The lenses may exhibit (or form) an electric and/or magnetic field. The lens may include cylindrical, quadropole, multipole, or Einzel lens. The lens(es) may induce movement, and/or acceleration of the charged particle. The lens(es) may induce a change in the energy, and/or trajectory of the charged particle (e.g., 723). FIGS. 6A and 6B show two examples of different trajectories of particular material (e.g., 610 and 620 respectively) that travels in different fields (e.g., generated by different CPOD lenses) from a source surface (e.g., 611 and 621 respectively) to a target surface (e.g., 612 and 622 respectively). The lens(es) may preserve the energy and/or trajectory of the charged particle. The lens(es) may deter movement and/or acceleration of the charged particle. The lens(es) may induce alteration of the electric and/or magnetic field adjacent to the lens. The lens may comprise a doughnut shaped lens. The lens may comprise a curvature. The lens may comprise a non-curved section. The lens may be non-curved. The lens may be curved. The lens may comprise a plane (e.g., 3D plane). The lens may comprise one (e.g., 410), two, or more electrodes (e.g., 511). The electrodes may form a constant field or a pulsing field. The field may be generated by a direct current or an alternating current. A pulsing current may generate the field. The electrodes may produce an electric arc (i.e., an arc discharge). The electrodes may produce charged plasma in the surrounding gas. The trajectory may comprise a spiral, linear, or curved trajectory (e.g., 620). The trajectories of the traveling particles may comprise converging and/or diverging trajectories.

In some instances, the lens may be opaque to electric and/or magnetic field. In some instances, the lens may be non-responsive to electric and/or magnetic field. The lens may be a mechanical lens. For example, the mechanical lens may comprise one or more slanted surfaces or slanted surface portions. The mechanical lens may comprise a funnel. The mechanical lens may comprise one or more parallel planes or plane portions. The mechanical lens may direct the flow of the material to the target surfaced. The mechanical lens may comprise an aperture. The mechanical lens may comprise a slit through which particles may flow (e.g., fall) though. The mechanical lens may comprise a directive path. The mechanical lens may comprise a restrictive opening. The restrictive opening may prevent diverging particles from reaching the target surface. The restrictive opening may comprise an aperture.

The CPOD may assist in imaging an arrangement of charged material (e.g., solid particles) that is disposed on a first surface, onto a second surface. Imaging may comprise deposition. The first surface may be a source surface. The second surface may be a target surface. FIG. 7B shows an example of imaging trajectory (e.g., 723) from a source surface 721 to a target surface 722 through a CPOD. The arrangement of the particles may comprise a path or a pattern. The CPOD may comprise one or more material releasing electrodes (e.g., FIG. 7A, 715) that attract the charged (e.g., particulate) material from the source surface. The CPOD may comprise one or more material releasing electrodes that cause repulsion of the charged material from the source surface. In some embodiments, the material (e.g., powder) releasing electrodes release, extract, separate, disconnect, detach, split, and/or remove the charged material that is adhered to the source surface. When the material is disconnected from the source surface, it may be subject to the forces induced by the CPOD (i.e., magnetic and/or electrostatic forces) and be imaged (e.g., by translating though the trajectories) on the target surface. In some embodiments, the at least one material releasing electrode is integrated in the CPOD. The electrode may comprise a magnet. The electrode may comprise one or more openings for at least one gas to flow there though.

The CPOD may assist in transferring a latent image formed by the arrangement of the particulate material disposed on the first (e.g., source) surface, onto a second (e.g., target) surface, thus forming a real image created by an arrangement of the transferred material on the target surface. The process of image transferring from one surface to another is referred to herein as “imaging.” The process of image transferring of the latent image to the real image is referred to herein as “imaging.” In some embodiments, the imaging may comprise an image on the target surface that is (e.g., substantially) identical to image on the source surface. In some embodiments, the imaging may comprise an image on the target surface that is an inverse of image on the source surface. The image may comprise a real image (e.g., on the target surface) that is a focused or diffused latent image (e.g., on the source surface). The imaging may include a transposition. The imaging may include forming a real image that is a magnification or a reduction of the latent (e.g., original) image. The imaging may include producing a real image that is sharpened or a blurred relative to the latent image. The imaging may include producing a real image that is a shifted latent image. The shift may be a shift in the X and/or Y planar directions. The real image may include a minimized or magnified latent image. In some examples, the CPOD is translating (e.g., laterally) with respect to the target surface. In some embodiments, the source surface, the target surface, or both may be translating. Translating may comprise moving horizontally, vertically, or in an angle. The angle may comprise a planar or a compound angle. In some embodiments, the movement (e.g., translation) of at least two of the CPOD, source surface, and target surface may be synchronized. The synchronization may afford a non-blurred (e.g., focused or sharp) imaging of the arrangement of the charge material of the source surface onto the target surface. The synchronization may cancel out any blurring or position inaccuracies that may have occur doing the CPOD assisted imaging of the charge material, had there been no translation. The movement can be synchronized. The synchronization may comprise relative movement of one surface with respect to another in (e.g., substantially) constant velocity. The synchronization may comprise (e.g., substantially) no relative movement between the source and target surface.

In some embodiments, at least one surface may be situated adjacent to one end of the CPOD. The surface may be a target surface. The surface may include a solid surface, a liquid surface, or a particulate material surface. The surface may include an exposed surface of a material bed. The solid surface may comprise a 3D plane or a wire. The 3D plane or wire may be formed by a 3D printing methodology. For example, the planar object or wire and their generation methodologies as disclosed in provisional application No. 62/168,689 filed on May 29, 2015, titled “SYSTEMS, APPARATUSES AND METHODS FOR FORMING A SUSPENDED OBJECT,” and in Patent Application serial number PCT/US16/34454, filed on May 26, 2016, titled “THREE-DIMENSIONAL OBJECTS FORMED BY THREE-DIMENSIONAL PRINTING,” each of which is incorporated herein by reference in its entirety.

In some embodiments, a source surface (e.g., a first surface) may be situated adjacent to a first end of the CPOD (e.g., entrance of the CPOD), and a target surface (e.g., a second surface) may be situated adjacent to the second end of the CPOD. The first end may be the entrance opening to the CPOD, and the second end may be the exit opening of the CPOD. FIG. 7A shows an example of a trajectory of a particulate material (e.g., 714) that enters a CPOD from a source surface (e.g., 711) and exits the CPOD to a target surface (e.g., 712). The source surface may include a photoconductive surface. The source surface may incorporate a flat or a curved surface. The source surface may include a moving surface. The source surface may be the curved surface of a cylinder, a drum, or a barrel. The flat surface may be a planar surface (e.g., a surface of box), or a belt (e.g., conveyor belt).

In some methods, systems, software and/or apparatuses disclosed herein, the CPOD may be utilized to transport particulate material that may be used for 3D printing. The methods, systems and/or apparatuses disclosed herein, may utilize and/or incorporate the CPOD to level an exposed surface of a material bed, for example, to form a planar exposed surface of the material bed. A recoater may comprise a CPOD. A material dispensing system may comprise a CPOD. The CPOD may be a part of a layer dispensing mechanism (e.g., a recoater). The CPOD may be a part of a leveling member. The leveling member may level an exposed (e.g., top) surface of a material bed. The leveling may exclude contacting the material bed. The top surface of the material bed may comprise imperfections. For example, the top surface may comprise height variations. The top surface may be flat or non-flat. The top surface may include at least one protruding 3D object. The methods, systems, and/or apparatuses disclosed herein may utilize and/or incorporate the CPOD to transport one, two or more material types. The methods, systems, software, and/or apparatuses may utilize and/or incorporate a non-contact layer dispensing mechanism (e.g., a recoater).

The particulate material may be a solid material. The particulate material may comprise one or more particles or clusters. The particles or clusters may be solid, semi-solid, and/or liquid. The solid particles or cluster may contain two or more molecules. The solid particles or clusters may contain two or more non-molecular atoms. Non-molecular atoms, as understood herein, are atoms that are not covalently bound to constitute at least a part of a molecule. For example, non-molecular atoms may be two or more metal atoms that are included within a metallic powder particle. The metal may include elemental metal or metal alloy. The charged material may be of a certain type of polarity. The polarity may be electric polarity. The polarity may be magnetic polarity. The charged material may be positively or negatively charged. The type of polarity may be a positive or negative polarity (e.g., plus or minus). The material may comprise a chargeable material. The material may comprise a magnetic material. The material may comprise a magnetizable material.

The material may comprise charged, non-charged, pre-transformed, particulate, transformed, or hardened material. The material may comprise elemental metal, metal alloy, ceramics, or an allotrope of elemental carbon. The allotrope of elemental carbon may comprise amorphous carbon, graphite, graphene, diamond, or fullerene. The fullerene may be selected from the group consisting of a spherical, elliptical, linear, and tubular fullerene. The fullerene may comprise a buckyball or a carbon nanotube. The ceramic material may comprise cement. The ceramic material may comprise alumina or zirconia. The material may comprise sand, glass, or stone. In some embodiments, the material may comprise an organic material, for example, a polymer or a resin. The organic material may comprise a hydrocarbon. The polymer may comprise styrene. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon based polymer or a resin. The material may comprise an organosilicon-based material. The material may comprise silicon and hydrogen atoms. The material may comprise silicon and carbon atoms. In some embodiments, the material may exclude a silicon-based material. The solid material may comprise powder material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) or wires.

The CPOD may transfer the charged material to a material bed, for example, to an exposed (i.e., top) surface of a material bed. The transferred particle can be utilized to build a 3D object using a 3D printing methodology.

Three-dimensional printing (also “3D printing”) generally refers to a process for generating a 3D object. For example, 3D printing may refer to sequential addition of material layer or joining of material layers (or parts of material layers) to form a 3D structure, in a controlled manner. The controlled manner may include automated control. In the 3D printing process, the deposited material can be transformed (e.g., fused, sintered, melted, bound or otherwise connected) to subsequently harden and form at least a part of the 3D object. Fusion, sintering, melting, binding, or otherwise connecting the material is collectively referred to herein as transforming the particulate material. Fusing the material may include melting or sintering the material. Binding can comprise chemical bonding. Chemical bonding can comprise covalent bonding. Examples of 3D printing include additive printing (e.g., layer by layer printing, or additive manufacturing). 3D printing may include layered manufacturing. 3D printing may include rapid prototyping. 3D printing may include solid freeform fabrication. 3D printing may include direct material deposition. The 3D printing may further comprise subtractive printing.

Particulate material may comprise solid, semi-solid, or liquid particles. Solid particulate material may comprise powder. Liquid particulate material may comprise droplets or vesicles. The term “powder,” as used herein, generally refers to a solid having fine particles. Powders may be granular materials. The particulate material may comprise particles that are micro particles. The particulate material may comprise particles that are nanoparticles. A fundamental length scale is the diameter, spherical equivalent diameter, length, width, or diameter of a bounding sphere, and is abbreviated herein as “FLS.” In some examples, a particulate material comprising particles having an average FLS of at least about 5 nanometers (nm), 10 nm, 20 nm, 30 nm, 40 nm, 50 nm, 100 nm, 200 nm, 300 nm, 400 nm, 500 nm, 1 μm, 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, or 100 μm. The particulate material may comprise particles may have an average FLS of at most about 100 μm, 80 μm, 75 μm, 70 μm, 65 μm, 60 μm, 55 μm, 50 μm, 45 μm, 40 μm, 35 μm, 30 μm, 25 μm, 20 μm, 15 μm, 10 μm, 5 μm, 1 μm, 500 nm, 400 nm, 300 nm, 200 nm, 100 nm, 50 nm, 40 nm, 30 nm, 20 nm, 10 nm, or 5 nm. In some cases, the particulate material may have an average FLS between any of the values of the average particle FLS listed above (e.g., from about 5 nm to about 100 μm, from about 1 μm to about 100 μm, from about 15 μm to about 45 μm, from about 5 μm to about 80 μm, from about 20 μm to about 80 μm, or from about 500 nm to about 50 μm). The inventions disclosed herein are not limited to powder material, but may use any particulate material in place of the powder material, or in addition to the powder material. The particulate material may be solid (e.g., powder), semi-solid (e.g., gel), or liquid (e.g., vesicles comprising liquid).

The particulate material can be composed of individual particles. The individual particles can be spherical, oval, prismatic, cubic, or irregularly shaped. The particles can have a FLS. The particulate material can be composed of a homogenously shaped particle mixture such that all of the particles have substantially the same shape and FLS magnitude within at most 1%, 5%, 8%, 10%, 15%, 20%, 25%, 30%, 35%, 40%, 50%, 60%, or 70%, distribution of FLS. In some cases, the particulate material can be a heterogeneous mixture such that the particles have variable shape and/or FLS magnitude.

Three-dimensional printing methodologies can comprise extrusion, wire, granular, laminated, light polymerization, or power bed and inkjet head 3D printing. Extrusion 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP), or laminated object manufacturing (LOM).

Three-dimensional printing methodologies may differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. Three-dimensional printing methodologies can differ from vapor deposition methods such as chemical vapor deposition, physical vapor deposition, or electrochemical deposition. In some instances, 3D printing may further include vapor deposition methods.

The methods, apparatuses, software, and systems of the present disclosure can be used to form 3D objects for various uses and applications. Such uses and applications include, without limitation, electronics, components of electronics (e.g., casings), machines, parts of machines, tools, implants, prosthetics, fashion items, clothing, shoes, or jewelry. The implants may be directed (e.g., integrated) to a hard, a soft tissue, or a combination of hard and soft tissues. The implants may form adhesion with hard and/or soft tissue. The machines may include a motor or motor part. The machines may include a vehicle. The machines may comprise aerospace related machines. The machines may comprise airborne machines. The vehicle may include an airplane, drone, car, train, bicycle, boat, or shuttle (e.g., space shuttle). The machine may include a satellite or a missile. The uses and applications may include 3D objects relating to the industries and/or products listed herein.

The FLS of the printed 3D object can be at least about 50 micrometers (μm), 80 μm, 100 μm, 120 μm, 150 μm, 170 μm, 200 μm, 230 μm, 250 μm, 270 μm, 300 μm, 400 μm, 500 μm, 600 μm, 700 μm, 800 μm, 1 millimeter (mm), 1.5 mm, 2 mm, 5 mm, 1 centimeter (cm), 1.5 cm, 2 cm, 10 cm, 20 cm, 30 cm, 40 cm, 50 cm, 60 cm, 70 cm, 80 cm, 90 cm, 1 m, 2 m, 3 m, 4 m, 5 m, 10 m, 50 m, 80 m, or 100 m. The FLS of the printed 3D object can be at most about 1000 m, 500 m, 100 m, 80 m, 50 m, 10 m, 5 m, 4 m, 3 m, 2 m, 1 m, 90 cm, 80 cm, 60 cm, 50 cm, 40 cm, 30 cm, 20 cm, 10 cm, or 5 cm. In some cases, the FLS of the printed 3D object may be in between any of the afore-mentioned FLSs (e.g., from about 50 μm to about 1000 m, from about 120 μm to about 1000 m, from about 120 μm to about 10 m, from about 200 μm to about 1 m, or from about 150 μm to about 10 m).

In some examples, the particulate material comprises a material wherein its constituents (e.g., atoms or molecules) readily lose their outer shell electrons, resulting in a free flowing cloud of electrons within their otherwise solid arrangement. In some examples the material is characterized in having high electrical conductivity, low electrical resistivity, high thermal conductivity, or high density. The high electrical conductivity can be at least about 1*10⁵ Siemens per meter (S/m), 5*10⁵ S/m, 1*10⁶ S/m, 5*10⁶ S/m, 1*10⁷ S/m, 5*10⁷ S/m, or 1*10⁸ S/m. The symbol “*” designates the mathematical operation “times,” or “multiplied by.” The high electrical conductivity can be any value between the aforementioned electrical conductivity values (e.g., from about 1*10⁵ S/m to about 1*10⁸ S/m). The low electrical resistivity may be at most about 1*10⁻⁵ ohm times meter (Ω*m), 5*10⁻⁶ Ω*m, 1*10⁻⁶ Ω*m, 5*10⁻⁷ Ω*m, 1*10⁻⁷ Ω*m, 5*10⁻⁸, or 1*10⁻⁸ Ω*m. The low electrical resistivity can be any value between the aforementioned electrical resistivity values (e.g., from about 1×10⁻⁵ Ω*m to about 1×10⁻⁸ Ω*m). The high thermal conductivity may be at least about 20 Watts per meters times degrees Kelvin (W/mK), 50 W/mK, 100 W/mK, 150 W/mK, 200 W/mK, 205 W/mK, 300 W/mK, 350 W/mK, 400 W/mK, 450 W/mK, 500 W/mK, 550 W/mK, 600 W/mK, 700 W/mK, 800 W/mK, 900 W/mK, or 1000 W/mK. The high thermal conductivity can be any value between the aforementioned thermal conductivity values (e.g., from about 20 W/mK to about 1000 W/mK). The high density may be at least about 1.5 grams per cubic centimeter (g/cm³), 2 g/cm³, 3 g/cm³, 4 g/cm³, 5 g/cm³, 6 g/cm³, 7 g/cm³, 8 g/cm³, 9 g/cm³, 10 g/cm³, 11 g/cm³, 12 g/cm³, 13 g/cm³, 14 g/cm³, 15 g/cm³, 16 g/cm³, 17 g/cm³, 18 g/cm³, 19 g/cm³, 20 g/cm³, or 25 g/cm³. The high density can be any value between the aforementioned density values (e.g., from about 1 g/cm³ to about 25 g/cm³). The thermal conductivity, electrical resistivity, electrical conductivity, and/or density can be measured at ambient temperature (e.g., at R.T., or 20° C.).

A metallic material (e.g., elemental metal or metal alloy) can comprise small amounts of non-metallic materials, such as for example, oxygen, sulfur, or nitrogen. In some cases, the metallic material can comprise the non-metallic material in a trace amount. A trace amount can be at most about 100000 parts per million (ppm), 10000 ppm, 1000 ppm, 500 ppm, 400 ppm, 200 ppm, 100 ppm, 50 ppm, 10 ppm, 5 ppm, or 1 ppm (on the basis of weight, w/w) of non-metallic material. A trace amount can comprise at least about 10 ppt, 100 ppt, 1 ppb, 5 ppb, 10 ppb, 50 ppb, 100 ppb, 200 ppb, 400 ppb, 500 ppb, 1000 ppb, 1 ppm, 10 ppm, 100 ppm, 500 ppm, 1000 ppm, or 10000 ppm (on the basis of weight, w/w) of non-metallic material. A trace amount can be any value between the afore-mentioned trace amounts (e.g., from about 10 parts per trillion (ppt) to about 100000 ppm, from about 1 ppb to about 100000 ppm, from about 1 ppm to about 10000 ppm, or from about 1 ppb to about 1000 ppm).

The CPOD can provide at least a portion of a layer of pre-transformed material to the top surface of a material bed. The Layer (or a portion thereof) can be provided additively or sequentially. At least parts of the layer can be transformed to a transformed material that may subsequently form at least a fraction (also used herein “a portion,” or “a part”) of a hardened (e.g., solidified) 3D object. Subsequently may be upon cooling. At times a transformed portion of a material layer may comprise a cross section of a 3D object (e.g., a horizontal cross section). At times a transformed portion of a material layer may comprise a deviation from a cross section of a 3D object. The deviation may include vertical or horizontal deviation. A material layer (or a potion thereof) can have a thickness of at least about 0.1 micrometer (μm), 0.5 μm, 1.0 μm, 10 μm, 50 μm, 100 μm, 150 μm, 200 μm, 300 μm, 400 μm, 500 μm, 600 μm, 700 μm, 800 μm, 900 μm, or 1000 μm. A material layer (or a potion thereof) can have a thickness of at most about 1000 μm, 900 μm, 800 μm, 700 μm, 60 μm, 500 μm, 450 μm, 400 μm, 350 μm, 300 μm, 250 μm, 200 μm, 150 μm, 100 μm, 75 μm, 50 μm, 40 μm, 30 μm, 20 μm, 10 μm, 5 μm, 1 μm, or 0.5 μm. A material layer (or a potion thereof) may have any value in between the aforementioned layer thickness values (e.g., from about 1000 μm to about 0.1 μm, 800 μm to about 1 μm, 600 μm to about 20 μm, 300 μm to about 30 μm, or 1000 μm to about 10 μm). The material composition of at least one layer within the material bed may differ from the material composition within at least one other layer in the material bed. The difference (e.g., variation) may comprise difference in crystal and/or grain structure. The variation may comprise variation in grain orientation, variation in material density, variation in the degree of compound segregation to grain boundaries, variation in the degree of element segregation to grain boundaries, variation in material phase, variation in metallurgical phase, variation in material porosity, variation in crystal phase, and variation in crystal structure. The microstructure of the printed 3D object may comprise planar structure, cellular structure, columnar dendritic structure, or equiaxed dendritic structure.

The material particles within at least one layer in the material bed may differ in their FLS from the FLS of the material particles within at least one other layer in the material bed. A layer (e.g., in the material bed or the 3D object) may comprise two or more material types at any combination. For example, two or more elemental metals, two or more metal alloys, two or more ceramics, two or more allotropes of elemental carbon. For example, an elemental metal and a metal alloy, an elemental metal and a ceramic, an elemental metal and an allotrope of elemental carbon, a metal alloy and a ceramic, a metal alloy and an allotrope of elemental carbon, a ceramic and an allotrope of elemental carbon. All the layers deposited during the 3D printing process may be of the same material composition. In some instances, a metal alloy is formed in situ during the process of transforming the particulate pre-transformed material. In some cases, the layers of different compositions can be deposited (e.g., imaged) at a predetermined pattern. For example, each layer can have material composition that increases or decreases in terms of a certain (i) element, or (ii) material type. In some examples, each even layer may have one composition, and each odd layer may have another composition. The varied compositions of the layers may follow a mathematical series algorithm. In some cases, at least one area within a layer has a different material composition than another area within that layer. In some examples, each even numbered layer may have one type of electrical polarity, and each odd numbered layer may have a type of electrical polarity that is opposite to the one type of electrical polarity. In some instances, the opposite electrical polarities substantially cancel out the electrical charge in the material bed. In some instances, the opposite electrical polarities reduce the accumulated electrical charge in the material bed. In some instances, the material bed is electrically grounded. In some instances, the material bed is charged. In some examples, each even numbered layer may have one type of magnetic polarity, and each odd numbered layer may have a type of magnetic polarity that is opposite to the one type of magnetic polarity. In some instances, the opposite magnetic polarities substantially cancel out the magnetic charge in the material bed. In some instances, the opposite magnetic polarities reduce the accumulated magnetic charge in the material bed.

In some instances, adjacent components in the material bed are separated from one another by one or more intervening layers. In an example, a first layer is adjacent to a second layer when the first layer is in direct contact with the second layer. In another example, a first layer is adjacent to a second layer when the first layer is separated from the second layer by at least one layer (e.g., a third layer). The intervening layer may be of any layer size disclosed herein.

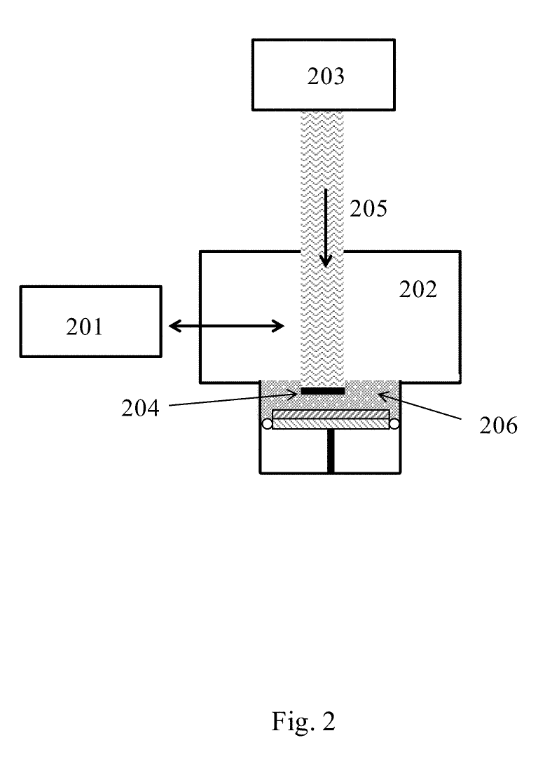

In some instances, a particulate material may be disposed on (e.g., transported to, imaged onto) the target surface in a pattern. In some instances, two or more particulate material types may be disposed on the target surface in different patterns. The different patterns may be substantially complementary. Utilizing the CPOD and/or a mask may form the different patterns. The mask may be a 3D mask. The mask may be a mask formed by a 3D printing methodology. Appropriate masks can be devised to separately print material X and Y within the same layer to form the layer in FIG. 3A. The mask may comprise an organic material (e.g., a resin or an organic polymer). The mask may be formed by a 3D printing methodology that differs in at least one aspect from the 3D printing methodology used to print the object. For example, the mask may be plastic, while the 3D object may be formed by a material selected from the list consisting of an elemental metal, metal alloy, ceramic, and elemental carbon. The mask may be formed by a first 3D printing methodology, while the object may be formed by another 3D printing methodology. The mask may be formed by one energy beam, while the 3D object may be formed by another energy beam. The mask may be formed in a first material bed, while the object may be formed in a second material bed. FIG. 2 shows an example of a 3D system in which a mask is printed in a module 201, and is being inserted (or retracted) into an enclosure 202 in which a 3D object 204 is being printed within a material bed, by utilizing the energy source 203, that emits energy 205.

The present disclosure provides systems, apparatuses, software, and/or methods for 3D printing of a 3D object from a material (e.g., particulate material). The object can be pre-ordered, pre-designed, pre-modeled, designed in real-time, or re-designed in rea-time. Real time may be during the process of 3D printing. The 3D printing method can be an additive method in which a first layer is printed, and thereafter a volume of a material is added to the first layer as separate sequential layer (or parts thereof). Each additional sequential layer (or part thereof) can be added to the previous layer by transforming (e.g., fusing) a fraction of the pre-transformed material. The transformed material may subsequently harden to form at least a portion of the 3D object. The hardening can be actively induced (e.g., by active cooling) or can occur without intervention.

The pre-transformed material can be chosen such that the material type is the desired or otherwise predetermined material type for the desired 3D object. In some cases, a layer of the 3D object comprises a single type of material. In some examples, a layer of the 3D object may comprise a single elemental metal type, or a single metal alloy type. In some examples, a layer within the 3D object may comprise several types of material (e.g., an elemental metal and an alloy, an alloy and a ceramic, an alloy and an allotrope of elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member (e.g., an allotrope) of elemental carbon (e.g., graphite). In some cases, a layer of the 3D object comprises more than one type of material. In some cases, a layer of the 3D object comprises more than one member of a material type.

The elemental metal can be an alkali metal, an alkaline earth metal, a transition metal, a rare earth element metal, or another metal. The alkali metal can be Lithium, Sodium, Potassium, Rubidium, Cesium, or Francium. The alkali earth metal can be Beryllium, Magnesium, Calcium, Strontium, Barium, or Radium. The transition metal can be Scandium, Titanium, Vanadium, Chromium, Manganese, Iron, Cobalt, Nickel, Copper, Zinc, Yttrium, Zirconium, Platinum, Gold, Rutherfordium, Dubnium, Seaborgium, Bohrium, Hassium, Meitnerium, Ununbium, Niobium, Iridium, Molybdenum, Technetium, Ruthenium, Rhodium, Palladium, Silver, Cadmium, Hafnium, Tantalum, Tungsten, Rhenium, or Osmium. The transition metal can be mercury. The rare earth metal can be a lantanide, or an actinide. The lantinide metal can be Lanthanum, Cerium, Praseodymium, Neodymium, Promethium, Samarium, Europium, Gadolinium, Terbium, Dysprosium, Holmium, Erbium, Thulium, Ytterbium, or Lutetium. The actinide metal can be Actinium, Thorium, Protactinium, Uranium, Neptunium, Plutonium, Americium, Curium, Berkelium, Californium, Einsteinium, Fermium, Mendelevium, Nobelium, or Lawrencium. The other metal can be Aluminum, Gallium, Indium, Tin, Thallium, Lead, or Bismuth.

The metal alloy can be an iron based alloy, nickel based alloy, cobalt based allow, chrome based alloy, cobalt chrome based alloy, titanium based alloy, magnesium based alloy, copper based alloy, or any combination thereof. The alloy may comprise an oxidation or corrosion resistant alloy. The alloy may comprise a super alloy (e.g., Inconel). The super alloy may comprise Inconel 600, 617, 625, 690, 718, or X-750.

The material (e.g., alloy or elemental) may comprise a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may be used for products comprising devices, machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, i-pad), air conditioning, generators, furniture, musical equipment, art, jewelry, cooking equipment, or sport gear. The devices may comprise medical devices (e.g., for human & veterinary). The material may be used for products comprising those used for human or veterinary applications comprising implants, and/or prosthetics. The material may be used for products comprising those used for applications in the fields comprising human or veterinary surgery, implants (e.g., dental), or prosthetics.

The alloy may include a superalloy. The alloy may include a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy may comprise Hastelloy, Inconel, Waspaloy, Rene alloy (e.g., Rene-80, Rene-77, Rene-220, or Rene-41), Haynes alloy, Incoloy, MP98T, TMS alloy, MTEK (e.g., MTEK grade MAR-M-247, MAR-M-509, MAR-M-R41, or MAR-M-X-45), or CMSX (e.g., CMSX-3, or CMSX-4). The alloy can be a single crystal alloy.

In some instances, the iron alloy comprises Elinvar, Fernico, Ferroalloys, Invar, Iron hydride, Kovar, Spiegeleisen, Staballoy (stainless steel), or Steel. In some instances the metal alloy is steel. The Ferroalloy may comprise Ferroboron, Ferrocerium, Ferrochrome, Ferromagnesium, Ferromanganese, Ferromolybdenum, Ferronickel, Ferrophosphorus, Ferrosilicon, Ferrotitanium, Ferrouranium, or Ferrovanadium. The iron alloy may include cast iron, or pig iron. The steel may include Bulat steel, Chromoly, Crucible steel, Damascus steel, Hadfield steel, High speed steel, HSLA steel, Maraging steel, Reynolds 531, Silicon steel, Spring steel, Stainless steel, Tool steel, Weathering steel, or Wootz steel. The high-speed steel may include Mushet steel. The stainless steel may include AL-6XN, Alloy 20, celestrium, marine grade stainless, Martensitic stainless steel, surgical stainless steel, or Zeron 100. The tool steel may include Silver steel. The steel may comprise stainless steel, Nickel steel, Nickel-chromium steel, Molybdenum steel, Chromium steel, Chromium-vanadium steel, Tungsten steel, Nickel-chromium-molybdenum steel, or Silicon-manganese steel. The steel may be comprised of any Society of Automotive Engineers (SAE) grade such as 440F, 410, 312, 430, 440A, 440B, 440C, 304, 305, 304L, 304L, 301, 304LN, 301LN, 2304, 316, 316L, 316LN, 316, 316LN, 316L, 316L, 316, 317L, 2205, 409, 904L, 321, 254SMO, 316Ti, 321H, or 304H. The steel may comprise stainless steel of at least one crystalline structure selected from the group consisting of austenitic, superaustenitic, ferritic, martensitic, duplex, and precipitation-hardening martensitic. Duplex stainless steel may be lean duplex, standard duplex, super duplex, or hyper duplex. The stainless steel may comprise surgical grade stainless steel (e.g., austenitic 316, martensitic 420, or martensitic 440). The austenitic 316 stainless steel may include 316L, or 316LVM. The steel may include 17-4 Precipitation Hardening steel (also known as type 630, a chromium-copper precipitation hardening stainless steel, 17-4PH steel).

The titanium-based alloys may include alpha alloys, near alpha alloys, alpha and beta alloys, or beta alloys. The titanium alloy may comprise grade 1, 2, 2H, 3, 4, 5, 6, 7, 7H, 8, 9, 10, 11, 12, 13, 14, 15, 16, 16H, 17, 18, 19, 20, 21, 2, 23, 24, 25, 26, 26H, 27, 28, 29, 30, 31, 32, 33, 34, 35, 36, 37, 38, or higher. In some instances the titanium base alloy includes Ti-6Al-4V or Ti-6Al-7Nb.

The Nickel alloy may include Alnico, Alumel, Chromel, Cupronickel, Ferronickel, German silver, Hastelloy, Inconel, Monel metal, Nichrome, Nickel-carbon, Nicrosil, Nisil, Nitinol, or Magnetically “soft” alloys. The magnetically “soft” alloys may comprise Mu-metal, Permalloy, Supermalloy, or Brass. The brass may include Nickel hydride, Stainless or Coin silver. The cobalt alloy may include Megallium, Stellite (e. g. Talonite), Ultimet, or Vitallium. The chromium alloy may include chromium hydroxide, or Nichrome.

The aluminum alloy may include AA-8000, Al—Li (aluminum-lithium), Alnico, Duralumin, Hiduminium, Kryron Magnalium, Nambe, Scandium-aluminum, or Y alloy. The magnesium alloy may be Elektron, Magnox, or T-Mg—Al—Zn (Bergman phase) alloy.

The copper alloy may comprise Arsenical copper, Beryllium copper, Billon, Brass, Bronze, Constantan, Copper hydride, Copper-tungsten, Corinthian bronze, Cunife, Cupronickel, Cymbal alloys, Devarda's alloy, Electrum, Hepatizon, Heusler alloy, Manganin, Molybdochalkos, Nickel silver, Nordic gold, Shakudo, or Tumbaga. The Brass may include Calamine brass, Chinese silver, Dutch metal, Gilding metal, Muntz metal, Pinchbeck, Prince's metal, or Tombac. The Bronze may include Aluminum bronze, Arsenical bronze, Bell metal, Florentine bronze, Guanin, Gunmetal, Glucydur, Phosphor bronze, Ormolu, or Speculum metal.

The particulate material within the material bed can be configured to provide support to the 3D object as it is formed in the material bed by the 3D printing process. For example, the supportive particulate material may be of the same type of particulate material from which the 3D object is generated, of a different type, or any combination thereof. In some instances, a low flowability particulate material can be capable of supporting a 3D object better than a high flowability particulate material. A low flowability particulate material can be achieved inter alia with a particulate material composed of relatively small particles, with particles of non-uniform size or with particles that attract each other. The particulate material may be of low, medium, or high flowability. The particulate material may have compressibility of at least about 1%, 2%, 3%, 4%, 5%, 6%, 7%, 8%, 9%, or 10% in response to an applied force of 15 kilo Pascals (kPa). The particulate material may have a compressibility of at most about 9%, 8%, 7%, 6%, 5%, 4.5%, 4.0%, 3.5%, 3.0%, 2.5%, 2.0%, 1.5%, 1.0%, or 0.5% in response to an applied force of 15 kilo Pascals (kPa). The particulate material may have basic flow energy of at least about 100 milli-Joule (mJ), 200 mJ, 300 mJ, 400 mJ, 450 mJ, 500 mJ, 550 mJ, 600 mJ, 650 mJ, 700 mJ, 750 mJ, 800 mJ, or 900 mJ. The particulate material may have basic flow energy of at most about 200 mJ, 300 mJ, 400 mJ, 450 mJ, 500 mJ, 550 mJ, 600 mJ, 650 mJ, 700 mJ, 750 mJ, 800 mJ, 900 mJ, or 1000 mJ. The particulate material may have basic flow energy in between the above listed values of basic flow energy (e.g., from about 100 mj to about 1000 mJ, from about 100 mj to about 600 mJ, or from about 500 mj to about 1000 mJ). The particulate material may have a specific energy of at least about 1.0 milli-Joule per gram (mJ/g), 1.5 mJ/g, 2.0 mJ/g, 2.5 mJ/g, 3.0 mJ/g, 3.5 mJ/g, 4.0 mJ/g, 4.5 mJ/g, or 5.0 mJ/g. The particulate material may have a specific energy of at most 5.0 mJ/g, 4.5 mJ/g, 4.0 mJ/g, 3.5 mJ/g, 3.0 mJ/g, 2.5 mJ/g, 2.0 mJ/g, 1.5 mJ/g, or 1.0 mJ/g. The particulate material may have a specific energy in between any of the above values of specific energy (e.g., from about 1.0 mJ/g to about 5.0 mJ/g, from about 3.0 mJ/g to about 5 mJ/g, or from about 1.0 mJ/g to about 3.5 mJ/g).

The 3D object can have one or more auxiliary features. The auxiliary feature(s) can be supported by the material bed. The term “auxiliary features,” as used herein, generally refers to features that are part of a printed 3D object, but are not part of the desired, intended, designed, ordered, modeled, or final 3D object. Auxiliary features (e.g., auxiliary supports) may provide structural support during and/or subsequent to the formation of the 3D object. Auxiliary features may enable the removal or energy from the 3D object that is being formed. Examples of auxiliary features comprise heat fins, anchors, handles, supports, pillars, columns, frame, footing, scaffold, flange, projection, protrusion, mold (a.k.a. mould), or other stabilization features. In some instances, the auxiliary support is a scaffold that encloses the 3D object or part thereof. The scaffold may comprise lightly sintered or lightly fused particulate material. The 3D object can have auxiliary features that can be supported by the material bed and not touch the base, substrate, container accommodating the material bed, or the bottom of the enclosure. The 3D part (3D object) in a complete or partially formed state can be completely supported by the material bed (e.g., without touching the substrate, base, container accommodating the material bed, or enclosure). The particulate material The 3D object in a complete or partially formed state can be completely supported by the material bed (e.g., without touching anything except the material bed). The 3D object in a complete or partially formed state can be suspended in the material bed without resting on any additional support structures. In some cases, the 3D object in a complete or partially formed (i.e., nascent) state can float in the material bed.

During, before and/or after the 3D printing, the particulate material in the material bed may be flowable (e.g., before, during and/or after the 3D printing). During, before and/or after the 3D printing, the particulate material in the material bed may be held together (e.g., only) by a gravitational force. During, before and/or after the 3D printing, the particulate material in the material bed may nor form a connected (e.g., sintered) structure of at least about 1 μm, 2 μm, 5 μm, 10 μm, or 20 μm. In some embodiments, during, before and/or after the 3D printing, the particulate material in the material bed may not be held by a compressing force other than gravity. Examples of compressing force other than gravity may comprise a pressure gradient. Pressure gradient can be effectuated by mechanically compressing the material bed, applying more pressure (e.g., positive gas pressure) at top of the material bed as compared to its bottom, or applying less pressure (e.g., negative pressure) at the bottom of the material bed as compared to its bottom. Such pressure gradient may compress the particulate material in the material bed and deter movement within the material bed. In some embodiments, during before and/or after the 3D printing, the average temperature of the material bed may be the target temperature (e.g., as disclosed herein). The target temperature may be an ambient temperature. The average temperature may be about standard room temperature. For example, the target temperature may be at most 200° C., 300° C., or 400° C. The target temperature may be a temperature below the transforming (e.g., sintering) temperature of the particulate material.

In another aspect provided herein is a method for forming a 3D object, comprising: (a) generating a pattern of a particulate material on a source surface; (b) transporting at least a portion of the particulate material onto a target surface; and (c) forming at least a portion of the 3D object from the at least a portion of the particulate material. In another aspect provided herein is a method for forming a 3D object, comprising: (a) generating a pattern of particulate material on a source surface, which pattern is in accordance with a model design of the 3D object; (b) depositing at least a portion of the particulate material on a target surface; and (c) forming the 3D object from the at least a portion of the particulate material on the target surface. The particulate material may comprise a charge. The particulate material may be charged. The methods may further comprise after operation (a) and before operation (b), using a CPOD to transport at least a portion of the particulate material from the source surface onto the target surface. The methods may further comprise after operation (a) and before operation (b), using an imaging device to image at least a portion of the material from the source surface onto a target surface. The imaging device may comprise a CPOD. The imaging device may comprise material releasing electrodes. The transportation of the at least a portion of the material may be directly from the source surface onto the target surface. Directly may be without an obstacle. Directly may be without a (e.g., mechanical) mediator. Directly comprises without additional (e.g., mechanical) mediation and/or obstruction. The transportation may be though a gap. The source surface and the target surface may be separated by the gap. The gap may comprise one or more gasses. The methods may further comprise after operation (a) and before operation (b), using one or more electrodes to transport at least a portion of the particulate material from the source surface onto a target surface. The methods may further comprise after operation (a) and before operation (b), using one or more material releasing electrodes to assist in releasing the at least a portion of the particulate material from the source surface.

The material releasing electrode(s) may comprise a material repelling electrodes. Material repelling may repel the at least a portion of the material from the source surface. The material repelling electrode may cause the at least a portion of the particulate material to detach from the source surface. The material releasing electrode(s) may comprise a material-attracting electrode. The material attracting electrode may attract the at least a portion of the particulate material from the source surface. The material attracting electrode may cause the at least a portion of the particulate material to detach from the source surface. The target surface may be an exposed surface of a material bed. The forming operation may comprise transforming the particulate material into a transformed material. The transformed material may subsequently harden into a hardened material as part of the 3D object. Forming may comprise a 3D manufacturing method. Forming may comprise an additive manufacturing method. The methods may further comprise in operation (c) emitting energy to form the transformed material. The energy may comprise radiative energy. The energy may comprise an energy beam. The transporting may comprise a CPOD that assists in transporting the at least a portion of the particulate material to the target surface. The CPOD may accelerate the at least a portion of the particulate material from the source surface onto the target surface. The particulate material may be heated prior to being accelerated. The particulate material can be heated while being accelerated. The material can be heated on the target surface. The material can be heated on the source surface. The target surface may include 3D plane or wire. The 3D plane or wire may be generated by a 3D printing methodology. The formation of the 3D object may include deforming the at least a portion of the particulate material into a deformed material. The deformation may include plastic deformation. The deformation may include deforming a shape of the particulate material. The deformation may include substantially permanent deformation. The deformation may include substantially altering the shape of the surface of a material particle of the particulate material. The deformation may include substantially altering the material phase of the particulate material (e.g., from solid to liquid). The deformation may include substantially altering the microstructure of the particulate material. Alteration of the microstructure may comprise altering the crystal structure, altering the amount of defects, types of defects, porosity, density, conductivity, or any combination thereof. Altering the crystal structure may comprise altering the relative percentage of certain crystal structures within the material. The deformation may include breaking of one or more bonds between the atoms in the particulate material. The deformation may include movement of one or more dislocations within the particulate material. The deformation may include slippage of one or more crystal planes of the particulate material. The deformation may include appearance of crystal slip bands within the particulate material. The slip bands may be detected by a microscopy method such as a microscopy method described herein. The 3D object may be formed within a material bed. The 3D object may be supported by a particulate material within the material bed. The 3D object may be devoid of auxiliary support, and/or be devoid of a mark of a previously exiting auxiliary support. The 3D object may comprise one or more auxiliary supports that are spaced apart by at least 2 millimeters. The 3D object may be suspended anchorlessly in the material bed. The target surface can comprise 3D plane or a wire. A portion of the material bed can serve as support for the 3D object. The energy beam may be an electromagnetic beam or a charged particle beam.

The source surface may comprise a photoconductive surface. The methods may further comprise prior to operation (a): (i) generating a charged pattern on the photoconductive surface using an energy source, wherein the charged pattern is of a first type of electrical polarity; and (ii) adhering the particulate material to the charged pattern, wherein the particulate material is of a second type of electrical polarity that is of a sign opposite to the first type of electrical polarity. The methods may further comprise prior to operation (a): charging the particulate material with a second type of electrical polarity to form the charged material, which second type is opposite to the first type. The source surface may be an exposed surface of a cylinder, a cuboid (i.e., box), a prism, a plate, rhombohedrum, or a conveyor belt. The prism can be a triangular, rectangular, pentagonal, hexagonal, heptagonal, optagonal, or icosahedral prism. The source surface may be an exposed surface of a cylinder. The cylinder may include a conductive core. The conductive core may be of the second type of electrical polarity. The charged pattern may incorporate quenching the charge of the photoconductive surface at a particulate position to reveal the charge of the conductive core. The source surface may translate relative to the exposed surface of the material bed. The source surface may rotate. The rotation may be around an axis that is (e.g., substantially) parallel to the target surface. The methods may further comprise before operation (ii), dispensing the charged material onto an intermediate surface. The intermediate surface may be of the first type of electrical polarity. The intermediate surface may be an exposed surface of a cylinder, a cuboid (i.e., box), a prism, a plate, rhombohedrum, or a conveyor belt. The intermediate surface may rotate in a first direction (e.g., clockwise), wherein the source surface may rotate in a second direction that is opposite to the one direction (e.g., counterclockwise). In some examples, the intermediate surface may rotate the same direction of the first surface (e.g., source surface). The rotations of the intermediate surface and first surface may be at the same speed or at different speeds.

The transportation of the particulate material from the first surface to the second surface may include imaging the pattern that is formed by the particulate material on the first (e.g., source) surface, onto the second (e.g., target) surface. The transportation may comprise guiding the particulate material. The transportation may comprise forming a pattern of the transported material on the target surface. The pattern (e.g., real image) may be a distorted pattern as compared to the pattern of the material on the source surface (e.g., latent image). The distortion may include enlarging, contracting, or preserving the material pattern on the first surface. The distortion may include using an imaging device. The imaging device may include the CPOD. The CPOD may comprise a pneumatic electrode. The CPOD may comprise positive or negative gas pressure. The CPOD may impart positive or negative gas pressure. The CPOD may reside in an environment of positive or negative gas pressure. The gas pressure may be any gas pressure described herein. The methods may exclude transporting the particulate material from the source surface onto a conveyor belt. At times, the methods may further comprise transporting the material from the first surface onto a conveyor belt. The method may include heating the material after it was released from the source surface and before it reached the target surface. At times, the method may exclude heating the particulate material after it was released from the first surface and before it reached the second surface. The method may further include transforming the pre-transformed particulate material after it was released from the source surface and before it reached the target surface. At times, the method may exclude transforming the particulate material after it was released from the first surface and before it reached the second surface. The transporting may include transforming the pre-transformed material. In some embodiments, the transporting may exclude transforming the pre-transformed material. The methods may include rendering the particulate material tacky (e.g., sticky) with an additional tacky material, before it reached the target surface. At times, the methods may exclude rendering the particular material tacky (e.g., sticky) with an additional tacky material before it reached the second surface. The transportation of the particulate material from the source surface to the target surface may be direct or indirect transportation. The indirect transportation may include additional operations, processes, or stations that the particulate material passes on its way from the source surface to the target surface. The direct transport may exclude transforming the pre-transformed particulate material. The direct transport may exclude usage of a conveyor. The direct transport may include transport tough an atmospheric gap. An atmospheric gap can comprise a physical gap (e.g., between the source surface and the target surface), wherein the gap includes one or more gasses. The gap may be any gap disclosed herein, for example, at least 0.5 mm between the first and the second surfaces.

The desired (e.g., requested) 3D object and the generated 3D object may deviate by at most about 1%, 3%, 5%, 10%, 15%, or 20%. The requested 3D object and the generated 3D object may deviate by any value between the afore-mentioned values (e.g., from about 1% to about 20%, from about 3% to about 15%, or from about 5% to about 10%). The percentage of deviation may be relative to the requested 3D object (e.g., a design of the desired 3D object). The percentage of deviation may be weight by weight, volume by volume, circumference by circumference, surface area by surface area. The requested 3D object and the generated 3D object may deviate by at most the sum of 25 micrometers and 1/1000 times the FLS of a requested 3D object. The requested 3D object and the generated 3D object may deviate by at most about the sum of 25 micrometers and 1/2500 times the fundamental length scale of a requested 3D object.

In some embodiments, the generated 3D object may be generated with the accuracy of at least about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object (e.g., the desired 3D object). The generated 3D object may be generated with the accuracy of at most about 5 μm, 10 μm, 15 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm, 100 μm, 150 μm, 200 μm, 250 μm, 300 μm, 400 μm, 500 μm, 600 μm, 700 μm, 800 μm, 900 μm, 1000 μm, 1100 μm, or 1500 μm as compared to a model of the 3D object. As compared to a model of the 3D object, the generated 3D object may be generated with the accuracy of any accuracy value between the aforementioned values (e.g., from about 5 μm to about 100 μm, from about 15 μm to about 35 μm, from about 100 μm to about 1500 μm, from about 5 μm to about 1500 μm, or from about 400 μm to about 600 μm).

The methods may further comprise after operation (c), removing any residual particulate material from the source (and/or intermediate) surface. The removal may include neutralizing or reversing the charge of the source surface. This may cause the material not to be attracted to the source (and/or intermediate) surface, detach itself from the source surface, and/or relocate (e.g., displace, or fall) into a reservoir. The removal may include physical removal. The physical removal may comprise a scrape that scrapes the material from the source (and/or intermediate) surface. The scrape may include a blade or brush. Scrape may be stationary. The scrape may rotate.

The methods may further comprise leveling the particulate material that adheres to the source (and/or intermediate) surface. The leveling may ensure a substantially leveled surface of material that is adhered to the source (and/or intermediate) surface. The leveling may be a scraper that is positioned at a distance from the source (and/or intermediate) surface. The distance may be a predetermined distance. The distance may be adjustable (e.g., by a controller). In case the method comprises an intermediate surface, the method may further comprise leveling the material that adheres to the intermediate surface. The leveling may ensure a substantially leveled surface of particulate material that is adhered to the source (and/or intermediate) surface. The leveling may be a scraper that is positioned at a distance from the intermediate surface. The distance may be a predetermined distance. The distance may be adjustable (e.g., by a controller). FIG. 4 shows an example of a scraper (e.g., 403) that forms a leveled layer of particulate material (e.g., 414) on an intermediate surface (e.g., 404).

The material may be charged using a charging device. For example, the charging device may comprise a corona discharge, charged particle gun, static charge device (e.g., charging roller), or an electrical potential difference generating device. The charging device may charge the material bed. The charging device may charge the material within the material bed. The charging device may charge the exposed layer of the material bed. Alternatively or additionally, the structure supporting the material bed may be charged. For example, voltage can be applied to the structure supporting the material bed. The structure supporting the material bed may comprise a platform (e.g., a base or substrate), or bottom of the enclosure. The charged particle gun may include an ion gun. The static charge device may include a charged surface (e.g., of a 3D plane).

The methods may further comprise prior to operation (b), generating a mask. The mask may comprise a material such as, for example, disclosed herein. For example, the mask may comprise an organic polymer. The methods may further comprise disposing the mask on the target surface. The mask may comprise a raster. The raster may comprise rasterized holes.

In another aspect described herein is a method for forming a 3D object, comprising: (a) dispensing a charged material (e.g., particulate material) onto a source surface comprising a pattern having a variation in electrical charge, and (b) generating at least a portion of the 3D object from at least a portion of the non-attached material. The non-attached material may be a material that did not adhere to the pattern (e.g., on the source surface). A portion of the charged material may be attached to the source surface. The non-attached particulate material that does not attach to the source surface may be dispensed onto a target surface. The attachment of the particulate material onto the source surface may depend on a charge (e.g., electrical charge) at a position in the pattern (e.g., that is on the source surface). The attachment of the particulate material onto the source surface may depend on the magnitude of charge at a position in the pattern (e.g., that is on the source surface). The charge (e.g., type and/or magnitude) may be relative to the charge of the particulate material (e.g., powder particle). The attachment of the particulate material to the source surface may be selective. The selectivity may depend on the charge at various positions on the source surface. The various positions may be positions of the pattern, or positions that (e.g., substantially) exclude the pattern. The selectivity may depend on the charge (e.g., type and/or magnitude). The non-attached particulate material may be displaced (e.g., though falling) onto the target surface. The non-attached particulate material may form an image on the target surface that is (e.g., substantially) identical to the image of the pattern formed on the source surface. The dispensing may be effectuated by a material dispenser. The pattern on the source surface may act as an on/off switch for the relocation of the particulate material from the material dispenser onto the target surface. The different charges residing on the source surface may act as an on/off switch for the relocation of the material from the material dispenser onto the target surface.

In another aspect disclosed herein is a method for non-contact leveling of a material bed, comprising: (a) identifying height variations in an exposed surface of a material bed, wherein the material bed is utilized to forming a 3D object; and (b) adding pre-transformed (e.g., particulate) material to the exposed surface of the material bed to form a planar surface without contacting the exposed surface of the material bed. The addition of pre-transformed material in operation (b) may be according to the identification of height variations. The additional of pre-transformed material in operation (b) may be selective. The height variations may comprise variations in the planarity of the exposed surface. The height variations may include variations in the leveling of the exposed surface. The identification may include calculating the planarity of the exposed surface. The calculation may be according to an algorithm. The calculation may be according to pre-formed 3D structure. In some examples, the identification may include anticipating the planarity of the exposed surface, or formation of at least a porting of the desired 3D object. The identification may include measuring the planarity of the exposed surface. The measurement may comprise usage of a sensor. A controller may control the measurement. The controller may be operatively coupled to the sensor. The term “operatively coupled” or “operatively connected” refers to a first mechanism that is coupled (or connected) to a second mechanism to allow the intended operation of the second and/or first mechanism. The control may be real-time control or non-real-time (e.g., asynchronous) control. Real time may be during the printing of the 3D object, during printing of a layer of the 3D object, or during printing of a melt-pool of the 3D object. The control may be programmed. The control may comprise a feedback loop. The control may comprise a neural network algorithm. The height uniformity (e.g., deviation from average or ideal surface height) of the planar surface may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80, 70 μm, 60 μm, 50 μm, 40 μm, 30 μm, 20 μm, 10 μm, or 5 μm. The height uniformity of the planar surface may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity. The resolution of the 3D object may have any value of the height uniformity value mentioned herein. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dpi. The resolution of the 3D object may be any value between the aforementioned values (e.g., from 100 dpi to 4800 dpi, from 300 dpi to 2400 dpi, or from 600 dpi to 4800 dpi). At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 8%, or 70%. At times, the 3D object may have a material density of at most about 99.5%, 99%, 98%, 96%, 95%, 94%, 93%, 92%, 91%, 90%, 8%, or 70%.

The height uniformity may persist across a portion of the target surface that has a width or a length of at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm. The height uniformity may persist across a portion of the target surface that has a width or a length of most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm. The height uniformity may persist across a portion of the target surface that has a width or a length of or of any value between the afore-mentioned width or length values (e.g., from about 10 mm to about 10 μm, from about 10 mm to about 100 μm, or from about 5 mm to about 500 μm). The methods described herein can provide a surface uniformity across the target surface (e.g., top of a material bed) such that portions of the target surface that comprises the dispensed material, which are separated from one another by a distance of from about 1 mm to about 10 mm, have a height deviation from about 100 μm to about 5 μm. The methods described herein may achieve a deviation from a planar uniformity in at least one plane (e.g., horizontal plane) of at most about 20%, 10%, 5%, 2%, 1% or 0.5%, as compared to the average plane (e.g., horizontal plane) created at the target surface (e.g., top of a material bed).

In another aspect is a method for forming a 3D object that comprises: (a) generating a first pattern of a first particulate material on a source surface; (b) transporting at least a portion of the first particulate material onto a target surface; and (c) forming at least a portion of the 3D object from the at least a portion of the first particulate material, wherein a material bed comprises the target surface, wherein the material bed comprises a material that is different from the first particulate material (e.g., a different particulate material type).

The first particulate material may comprise a charge. The first particulate material may be charged. The method may further comprise after operation (a) and before operation (b), using a first CPOD to transport at least a portion of the first particulate material from the source surface to the target surface. The method may further comprise after operation (a) and before operation (b), using a first imaging device to image at least a portion of the first particulate material from the source surface to the target surface. The imaging device may comprise a first CPOD. The imaging device may comprise a first set of one or more material releasing electrodes. The transportation of the at least a portion of the particulate material may be directly from the source surface to the target surface. The transportation may be though a first gap. The source surface and the target surface may be separated by the first gap. The first gap may comprise any gap disclosed herein. The first gap may comprise one or more gasses. The method may further comprise after operation (a) and before operation (b), using a first (e.g., set of) one or more electrodes to transport at least a portion of the first particulate material from the source surface to the target surface. The method may further comprise after operation (a) and before operation (b), using a first (e.g., set of) one or more material releasing electrodes to assist in releasing the at least a portion of the first particulate material from the source surface.

The formation of at least a portion of the 3D object in operation (c) may comprise transforming and/or deforming the first particulate material. The transformation may comprise sintering or melting (e.g., complete melting). The deformation may include plastic deformation.

The method may further comprise in operation (a), generating a second pattern of a second particulate material on the source surface. The method may further comprise using the first (e.g., set of) one or more electrodes comprising material releasing (e.g., attracting) electrodes to assist in releasing at least a portion of the second particulate material from the source surface. The releasing may be effectuated by attracting the at least a portion of the second particulate material away from the source surface. The releasing may be effectuated by repelling the at least a portion of the second particulate material away from the source surface. The method may further comprise and in operation (c), transporting the at least a portion of the second particulate material onto the target surface.

The target surface may comprise a third (e.g., particulate) material. The third material may be disposed within the material bed. The third material may be (e.g., substantially) excluded from the target surface. The third material may be different from the first particulate material. The third material may be the same or different from the second particulate material. For example, the third material may be a different allotrope from the first and/or second particulate material. For example, the third material may be of a different material type than the first and/or second particulate material.

The method may further comprise in operation (a) in parallel or sequentially, generating a second pattern of a second particulate material on an additional source surface, in (b) in parallel or sequentially, using the first (e.g., set of) one or more electrodes comprising material releasing electrodes to assist in releasing at least a portion of the second particulate material from the additional source surface. The releasing may be effectuated by attracting the at least a portion of the second particulate material away from the additional source surface. The releasing may be effectuated by repelling the at least a portion of the second particulate material away from the additional source surface. The methods may further comprise and in (c) transporting the at least a portion of the second particulate material onto the target surface, in parallel or sequentially.

The methods may further comprise in operation (a) in parallel or sequentially, generating a second pattern of a second particulate material on the source surface. The methods may further comprise in parallel or sequentially, using a second (e.g., set of) one or more electrodes comprising material releasing electrodes to assist in releasing at least a portion of the second particulate material from the source surface. The release may be effectuated by attracting the at least a portion of the second particulate material away from the source surface. The release may be effectuated by repelling the at least a portion of the second particulate material away from the source surface. The methods may further comprise in parallel or sequentially, transporting the at least a portion of the second particulate material to the target surface.

The methods may further comprise in operation (a) in parallel or sequentially, generating a second pattern of a second particulate material on an additional source surface. The methods may further comprise in parallel or sequentially, using a second (e.g., set of) one or more electrodes comprising material releasing electrodes to assist in releasing at least a portion of the second particulate material from the additional source surface. The release may be effectuated by attracting the at least a portion of the second particulate material away from the additional source surface. The release may be effectuated by repelling the at least a portion of the second particulate material away from the additional source surface. The methods may further comprise in operation (c) in parallel or sequentially, transporting the at least a portion of the second particulate material onto the target surface.

The particulate material can be a powder material. The first particulate material may comprise a melting point that is different from the second particulate material. Different can be higher or lower. The first particulate material can have an energy absorption coefficient that is different from the second particulate material. During the transformation step, the first particulate material may transform, while the second particulate material may not transform. In some examples, the 3D object may comprise a functionally graded material.

The second particulate material may provide support for the 3D object (e.g., within the material bed, during and/or after the 3D printing). The particulate material that is different from the first particulate material in type and that resides in the material bed, may provide support for the 3D object (e.g., during and/or after the 3D printing). The first particulate material that does not form the 3D object may provide support for the 3D object (e.g., during and/or after the 3D printing).

The first charged pattern can be different than the second charged pattern. The first charged pattern can (e.g., substantially) complement the second charged pattern. The transformed material can substantially exclude the first particulate material.

A first source surface may comprise a first photoconductive surface. The first energy beam can generate a first charged pattern on the first photoconductive surface. The first energy beam can generate (e.g., sequentially or in parallel) a second charged pattern on the first photoconductive surface. The first particulate material may be charged with a polarity type (e.g., electrical polarity type) that is opposite to the polarity type of the first charged pattern. The second particulate material may be charged with a polarity type that is opposite to the polarity type of the second charged pattern. The first surface may comprise a first photoconductive surface.

A second source surface may comprise a second photoconductive surface. A first energy beam may generate a first charged pattern on the first photoconductive surface. The first energy beam may generate a second charged pattern on the second photoconductive surface. The first material may be charged by a polarity type that is opposite to the polarity type of the first charged pattern. The second material may be charged in a polarity type that is opposite to the polarity type of the second charged pattern.

In some instances, the first energy beam can generate a first charged pattern on the first photoconductive surface. The second energy beam may generate a second charged pattern on the second photoconductive surface. The first particulate material may be charged in a polarity type that is opposite to the polarity type of the first charged pattern. The second particulate material may be charged in a polarity type that is opposite to the polarity type of the second charged pattern. The charge may be electrical or magnetic charge.

The first and second particulate materials may be of (e.g., substantially) the same type of material. The first and second particulate materials may differ in the average FLS of their particle size. The first and second particulate materials may differ in their respective material microstructures (e.g., crystal structures). The first and the second materials may be different allotropes of the same material type (e.g., different elemental metals, different metal alloys, different ceramics, different elemental carbon types). The different types of material may be from different material categories (e.g., metal or ceramics). The different material types may include one type that is an elemental metal and the other type that is a metal alloy, one type that is a metal alloy and the other type that is a ceramics, one type that is a metal alloy and the other type that is an allotrope of elemental carbon, one type that is a metal alloy and the other type that is a polymer, one type that is a metal alloy and the other type that is a stone, one type that is a metal alloy and the other type that is a sand, or one type that is a metal alloy and the other type that is a cement. The ceramic may comprise cubic boron nitride, manmade diamond, silicon carbide, or aluminum oxide. A material dispensing mechanism may dispense the first and the second particulate material. Alternatively or additionally, a first material dispensing mechanism may dispense the first particulate material, and a second material dispensing mechanism may dispense the second particulate material.

The 3D object can have various surface roughness profiles, which may be suitable for various applications. The surface roughness may be the deviations in the direction of the normal vector of a real surface, from its ideal form. The surface roughness may be measured as the arithmetic average of the roughness profile (hereinafter “Ra”). The 3D object can have a Ra value of at least about 400 μm, 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The formed object can have a Ra value of at most about 400 μm, 300 μm, 200 μm, 100 μm, 75 μm, 50 μm, 45 μm, 40 μm, 35 μm, 30 μm, 25 μm, 20 μm, 15 μm, 10 μm, 7 μm, 5 μm, 3 μm, 1 μm, 500 nm, 400 nm, 300 nm, 200 nm, 100 nm, 50 nm, 40 nm, or 30 nm. The 3D object can have a Ra value between any of the aforementioned Ra values (e.g., from about 30 nm to about 50 μm, from about 5 μm to about 40 μm, from about 3 μm to about 30 μm, from about 100 to about 400 μm, from about 100 μm to about 300 μm, from about 10 nm to about 50 μm, or from about 15 nm to about 400 μm). The Ra values may be measured by a contact or by a non-contact method. The Ra values may be measured by microscopy method. The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The proximal probe microscopy may comprise atomic force, or scanning tunneling microscopy, or any other microscopy described herein. The roughness measurement may include using Lambert's emission law when evaluating the optical measurements. The Ra values may comprise measuring by a roughness tester and/or by a microscopy method (e.g., any microscopy method described herein). The measurements may be conducted at ambient temperatures (e.g., R.T.). The roughness measurement may comprise one or more sensors (e.g., optical sensors). The roughness measurement may comprise a metrological measurement device (e.g., using metrological sensor(s)). The roughness may be measured using an electromagnetic beam (e.g., visible or IR).

The 3D object may be composed of successive layers (e.g., successive cross sections) of hardened (e.g., solid) material that originated from a transformed material (e.g., fused (e.g., sintered, or melted), bound or otherwise connected particulate material), and (e.g., subsequently) hardened. The transformed particulate material may be connected to a hardened (e.g., solidified) material. The hardened material may reside within the same layer, or in another layer (e.g., a previous layer). In some examples, the hardened material comprises disconnected parts of the 3D object that are subsequently connected by newly transformed material.

A cross section (e.g., vertical cross section) of the generated (e.g., formed) 3D object may reveal a microstructure or a grain structure indicative of a layered deposition. Without wishing to be bound to theory, the microstructure or grain structure may arise due to the solidification of transformed particulate material that is typical to and/or indicative of the 3D printing method. For example, a cross section may reveal a microstructure resembling ripples and/or waves that are indicative of solidified melt pools that may be formed during the 3D printing process. The repetitive layered structure of the solidified melt pools may reveal the orientation at which the part was printed. The cross section may reveal a (e.g., substantially) repetitive microstructure or grain structure. The microstructure and/or grain structure may comprise (e.g., substantially) repetitive variations in material composition, grain orientation, material density, degree of compound segregation or of element segregation to grain boundaries, material phase, metallurgical phase, crystal phase, crystal structure, material porosity, or any combination thereof. The microstructure and/or grain structure may comprise (e.g., substantially) repetitive solidification of layered melt pools. The (e.g., substantially) repetitive microstructure may have an average layer height of at least about 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, or 500 μm. The (e.g., substantially) repetitive microstructure may have an average layer height of at most about 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, or 10 μm. The (e.g., substantially) repetitive microstructure may have an average layer height of any value between the aforementioned values of layer height (e.g., from about 0.5 μm to about 500 μm, from about 15 μm to about 50 μm, from about 5 μm to about 150 μm, from about 20 μm to about 100 μm, or from about 10 μm to about 80 μm).

The printed 3D object may be printed without the use of auxiliary support, may be printed using a reduced amount of auxiliary support features, or printed using spaced apart auxiliary support features. In some embodiments, during the 3D printing, the printed 3D object may be devoid of auxiliary support or auxiliary support mark(s) that are indicative of a presence or removal of the auxiliary support. In some examples, during the 3D printing, the 3D object may be devoid of auxiliary support and of any mark(s) of an auxiliary support (including a base structure) that was removed (e.g., subsequent to the generation of the 3D object). The printed 3D object may comprise a single auxiliary support (e.g., or mark thereof). The single auxiliary feature (e.g., auxiliary support or auxiliary structure) may be a platform or a mold. The auxiliary support may be adhered to the platform, or mold. The 3D object may comprise a mark(s) belonging to an auxiliary structure(s). The 3D object may comprise a plurality of marks belonging to auxiliary features. At times, the 3D object may be devoid of marks pertaining to an auxiliary support. During and/or after the 3D printing, the 3D object may be devoid of an auxiliary support. The 3D object may be devoid of one or more auxiliary support features and of one or more marks pertaining to an auxiliary support. The mark may comprise variation in: grain orientation, layering orientation, layering thickness, material density, the degree of compound segregation to grain boundaries, material porosity, the degree of element segregation to grain boundaries, material phase, metallurgical phase, crystal phase, or v crystal structure (e.g., where the variation may not have been created by the geometry of the 3D object alone), or any combination thereof; and may thus be indicative of a prior existing auxiliary support that was removed. The variation may be forced upon the generated 3D object by the geometry of the support. In some instances, the 3D (e.g., micro) structure of the printed 3D object may be forced by the auxiliary support (e.g., by a mold). For example, a mark may be a point of discontinuity that is not explained by the geometry of the 3D object, which does not include any auxiliary supports. The point of discontinuity may arise during a cutting (e.g., chopping off) of the auxiliary support (e.g., subsequent to the 3D printing). A mark may be a surface feature that cannot be explained by the geometry of a 3D object, which does not include any auxiliary supports (e.g., a mold). The plurality of auxiliary features or auxiliary support feature marks may be spaced apart by a spacing distance of at least 1.5 millimeters (mm), 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The plurality of auxiliary support features or auxiliary support feature marks may be spaced apart by a spacing distance of at most 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 20 mm, 20.5 mm, 21 mm, 25 mm, 30 mm, 30.5 mm, 31 mm, 35 mm, 40 mm, 40.5 mm, 41 mm, 45 mm, 50 mm, 80 mm, 100 mm, 200 mm 300 mm, or 500 mm. The plurality of auxiliary support features or auxiliary support feature marks may be spaced apart by a spacing distance of any value between the aforementioned auxiliary support space values (e.g., from 1.5 mm to 500 mm, from 2 mm to 100 mm, from 15 mm to 50 mm, or from 45 mm to 200 mm). This spacing is collectively referred to herein as the “auxiliary feature spacing distance.”

The 3D object may comprise a layered structure indicative of a 3D printing process that is devoid of auxiliary support (or auxiliary support feature mark(s) that are indicative of a presence or removal of the auxiliary support feature(s)). The 3D object may comprise a layered structure indicative of a 3D printing process, which includes one, two, or more auxiliary supports (or marks thereof). The supports (or support marks) can be on the surface of the 3D object. The auxiliary supports (or support marks) can be on an external, on an internal surface (e.g., a cavity within the 3D object), or any combination thereof. The layered structure can have a layering plane. In one example, two auxiliary support features (or auxiliary support feature marks) present in (e.g., on) the 3D object may be spaced apart by the auxiliary feature spacing distance. The acute (i.e., sharp) angle alpha between the straight line connecting the two auxiliary supports (or auxiliary support marks) and the direction of normal to the layering plane may be at least about 45 degrees (°), 50°, 55°, 60°, 65°, 70°, 75°, 80°, or 85°. The acute angle alpha between the straight line connecting the two auxiliary supports (or auxiliary support marks) and the direction of normal to the layering plane may be at most about 90°, 85°, 80°, 75°, 70°, 65°, 60°, 55°, 50°, or 45°. The acute angle alpha between the straight line connecting the two auxiliary supports (or auxiliary support marks) and the direction of normal to the layering plane may be any angle range between the aforementioned angles (e.g., from about 45 degrees (°), to about 90°, from about 60° to about 90°, from about 75° to about 90°, from about 80° to about 90°, or from about 85° to about 90°). For example, the acute angle alpha between the straight line connecting the two auxiliary supports (or auxiliary support marks) and the direction normal to the layering plane may from about 87° to about 90°. The two auxiliary supports (or auxiliary support feature marks) can be on the same surface of the 3D object. The same surface can be an external surface or an internal surface (e.g., a surface of a cavity within the 3D object). When the angle between the shortest straight line connecting the two auxiliary supports or auxiliary support marks and the direction of normal to the layering plane is greater than 90°, one can consider the complementary acute angle. In some embodiments, any two auxiliary supports or auxiliary support marks are spaced apart by at least about 10.5 millimeters. In some embodiments, any two auxiliary supports or auxiliary support marks are spaced apart by at least about 40.5 millimeters. In some embodiments, any two auxiliary supports (or auxiliary support marks) are spaced apart by the auxiliary feature spacing distance.

In some examples, the diminished number of auxiliary supports or lack of auxiliary support during the 3D printing, will provide a 3D printing process that requires a smaller amount of material, produces a smaller amount of material waste, and/or requires smaller energy as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforesaid values (e.g., from about 1.1 to about 10, or from about 1.5 to about 5).

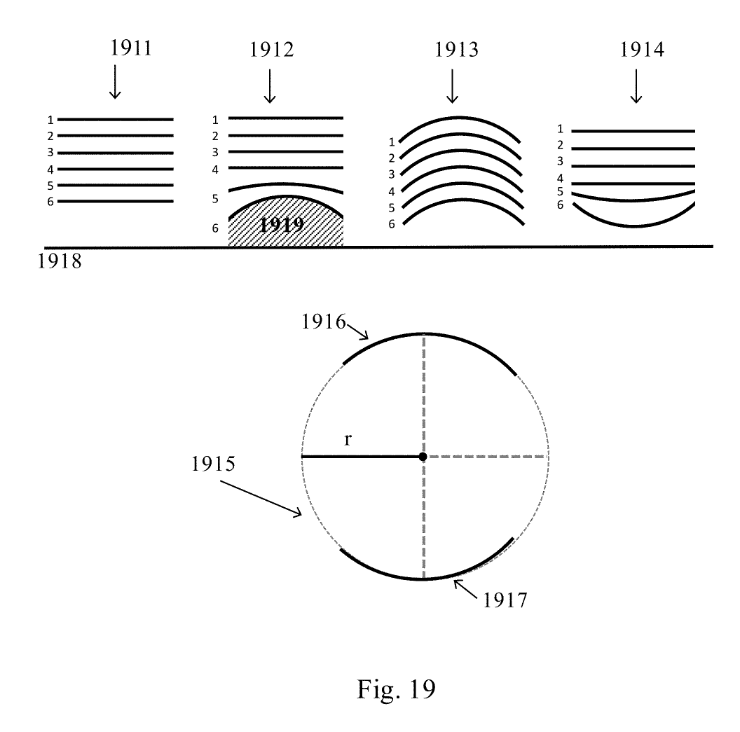

The one or more layers within the 3D object may be (e.g., substantially) planar (e.g., FIG. 19, 1911). The one or more layers within the 3D object may be (e.g., substantially) flat. The (e.g., substantially) planar one or more layers may have a large radius of curvature. The one or more layers may have a radius of curvature equal to the surface radius of curvature. The surface radius of curvature may have a value of at least about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The surface radius of curvature may have a value of at most about 0.1 centimeter (cm), 0.2 cm, 0.3 cm, 0.4 cm, 0.5 cm, 0.6 cm, 0.7 cm, 0.8 cm, 0.9 cm, 1 cm, 5 cm, 10 cm, 20 cm, 30 cm, 40 cm, 50 cm, 60 cm, 70 cm, 80 cm, 90 cm, 1 meter (m), 1.5 m, 2 m, 2.5 m, 3 m, 3.5 m, 4 m, 4.5 m, 5 m, 10 m, 15 m, 20 m, 25 m, 30 m, 50 m, or 100 m. The surface radius of curvature may have any value between any of the afore-mentioned values of the radius of curvature (e.g., from about 10 cm to about 90 m, from about 50 cm to about 10 m, from about 5 cm to about 1 m, from about 50 cm to about 5 m, or from about 40 cm to about 50 m). In some examples, the one or more layers may be included in a planar section of the 3D object, or may be a planar 3D object. In some instances, part of at least one layer within the 3D object has the radius of curvature mentioned herein. The radius of curvature may be measured by optical microscopy, electron microscopy, confocal microscopy, atomic force microscopy, speedometer, caliber (e.g., vernier caliber), positive lens, interferometer, or laser (e.g., tracker). The radius of curvature may be measured by a microscopy method described herein.

The radius of curvature, “r,” of a curve at a point can be a measure of the radius of the circular arc (e.g., FIG. 19, 1916) which best approximates the curve at that point. The radius of curvature can be the inverse of the curvature. In the case of a 3D curve (also herein a “space curve”), the radius of curvature may be the length of the curvature vector. The curvature vector can comprise of a curvature (e.g., the inverse of the radius of curvature) having a particular direction. For example, the particular direction can be the direction towards the platform (e.g., designated herein as negative curvature), or away from the platform (e.g., designated herein as positive curvature). For example, the particular direction can be the direction towards the direction of the gravitational field (e.g., designated herein as negative curvature), or opposite to the direction of the gravitational field (e.g., designated herein as positive curvature). A curve (also herein a “curved line”) can be an object similar to a line that is not required to be straight. A straight line can be a special case of curved line wherein the curvature is (e.g., substantially) zero. A line of substantially zero curvature has a (e.g., substantially) infinite radius of curvature. A curve can be in two dimensions (e.g., vertical cross section of a plane), or in three-dimension (e.g., curvature of a plane). The curve may represent a cross section of a curved plane. A straight line may represent a cross section of a flat (e.g., planar) plane. FIG. 19 shows an example of a vertical cross section of a 3D object 1912 comprising planar layers (layer numbers 1-4) and non-planar layers (e.g., layers numbers 5-6) that have a radius of curvature. FIGS. 19, 1916 and 1917 are super-positions of curved layer on a circle 1915 having a radius of curvature “r.” The one or more layers may have a radius of curvature equal to the radius of curvature of the layer surface.

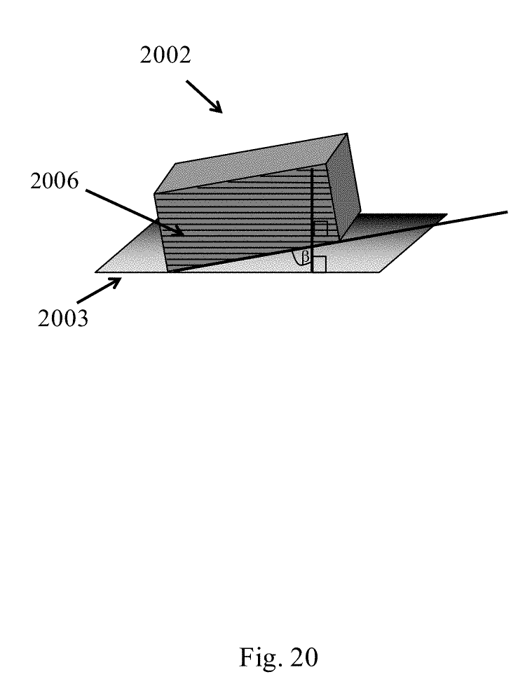

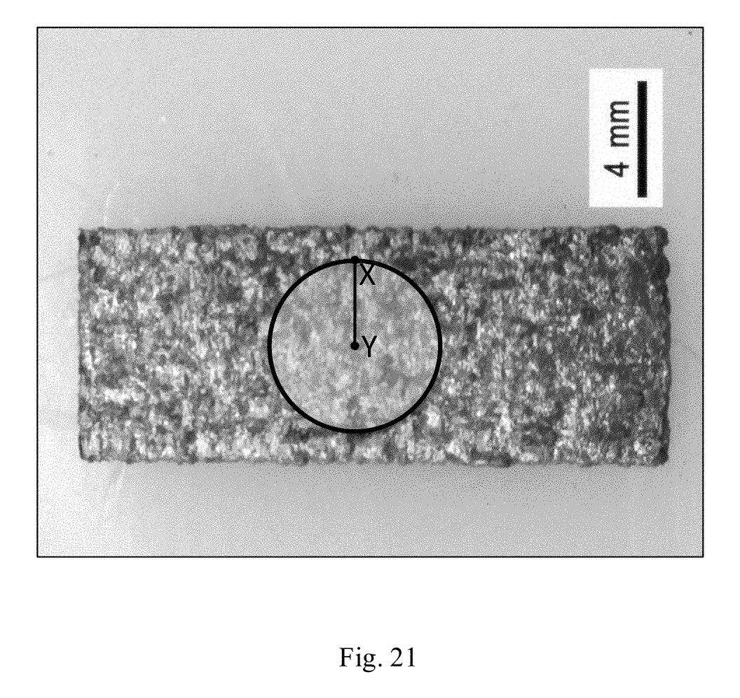

The 3D object may comprise a layering plane N of the layered structure (e.g., FIG. 20, 2006). The layered structure can have a layering plane. FIG. 20 shows a schematic example of a 3D object 2002 having a layering structure (e.g., comprising layer 2006) adjacent to a platform 2003, wherein the average surface of the layering plane forms an angle with the platform (e.g., equal to 90° minus the angle beta in FIG. 20). The 3D object may comprise points X and Y (e.g., FIG. 21), which reside on the surface of the 3D object, wherein X is spaced apart from Y by at least about 10.5 millimeters or more. In some embodiments, X is spaced apart from Y by the auxiliary feature spacing distance. A sphere of radius XY that is centered at X lacks one or more auxiliary supports that are indicative of a presence or removal of the one or more auxiliary support features. The acute angle between the straight line XY and the direction normal to the layering plane may be of the value of the acute angle alpha. Alpha may be 90° subtracted by the angle beta. When the angle between the straight line XY and the direction of normal to N is greater than 90°, one can consider the complementary acute angle. Each layer of the 3D structure can be made of a single material or of multiple materials. Sometimes one part of the layer may comprise one material, and another part may comprise a second material different than the first material. A layer of the 3D object may be composed of a composite material. The 3D object may be composed of a composite material. The 3D object may comprise a functionally graded material. At times, the area of an intersecting sphere of radius XY with an exposed surface of the 3D object is devoid of auxiliary support. FIG. 21 shows an example of a top view of a 3D object that has an exposed surface. The exposed surface includes an intersection area of a sphere having a radius XY, which intersection area is devoid of auxiliary support. The value of the radius XY may be any value of the auxiliary feature spacing distance.

In another aspect disclosed herein is a system for generating a 3D object, including a pattern that comprises a particulate material that is disposed on a source surface, a target surface, and a controller operatively coupled to the source surface and target surface, and is programmed to: (i) direct the formation of the pattern on the source surface, and (ii) direct a generation of the 3D object from at least a portion of the particulate material that transfers from the source surface to the target surface.

In another aspect is a system for generating a 3D object that comprises: a source surface that is configured to retain a pattern of particulate material, which pattern is in accordance with a model design of the 3D object; a target surface for forming at least a portion of the 3D object from at least a portion of the particulate material deposited from the source surface to the target surface; and a controller operatively coupled to the source surface and to the target surface, wherein the controller is programmed to: (i) form the pattern of particulate material on the source surface and (ii) generate the 3D object from the at least a portion of the particulate material on the target surface. The pattern may be made by specific localization of the particulate material. The pattern may be made by the particulate material. The placement of the particulate material on the source surface may create the pattern.

The systems may further comprise one or more material releasing electrodes that assist in releasing at least part of the particulate material from the source surface. The controller may be further operatively couple to the one or more material releasing electrodes. The controller may be further programmed to direct a release of the at least a portion of the particulate material from the first surface at a time between operations (i) and (ii). The at least a portion of the particulate material may transport to the target surface. The material releasing electrodes may be material repelling electrodes or material attracting electrodes.

The particulate material may be a charged material. The system may further comprise a CPOD that transports at least a portion of the particulate material from the source surface to the target surface. The controller may be operatively couple to the CPOD and may be programmed (e.g., during the time between operations (i) and (ii)) to direct the transport of at least a portion of the pattern (e.g., comprising the particulate material) to the target surface.

The system may further comprise an imaging device that images at least a portion of the particulate material from the source surface to the target surface. The controller may be further operatively coupled to the imaging device, and is further programmed (e.g., during the time between operations (i) and (ii)) to direct the transport and imaging of at least a portion of the pattern (e.g., that comprises the particulate material) from the source surface to the target surface.

The source surface may comprise a curved surface. The source surface may be a surface of a 3D plane. The first surface may comprise a non-planar surface. The first surface may comprise a non-homogenous (e.g., non flat) surface. The target surface may be separated from the source surface by a gap. The controller may be operatively coupled to the source surface and the target surface. The controller may be programmed to direct an atmospheric transport of at least a portion of the pattern (e.g., that comprises the particulate material) from the source surface onto the target surface. The controller may direct a generation of the 3D object from the least a portion of the pattern that has been transported (e.g., to the target surface). The transport may be an atmospheric transport. The atmospheric transport may be a transport though an atmosphere. The atmospheric transport may be a transport though one or more gases. The atmosphere may comprise one or more gasses. The atmosphere may be in a positive, ambient, or negative pressure. The ambient pressure may be (e.g., substantially) one atmosphere.

The system may further comprise one or more electrodes that transport at least a portion of the particulate material from the source surface to the target surface. The controller may be further operatively coupled to the one or more electrodes. The controller may be further programmed (e.g., during the time between operations (i) and (ii)) to direct the transport of at least a portion of the pattern from the source surface to the target surface.

The system may further comprise one or more energy sources that generate one or more energy beams. The system may further comprise a first energy source, or a first set of energy sources. The first energy source(s) may project a first (e.g., set of) energy beam(s). The systems may further comprise a second energy source, or a second set of energy sources. The second energy source(s) may project a second (e.g., set of) energy beam(s). The second energy source(s) may generate heat energy. The second energy source(s) may generate radiative heat. The second energy source(s) may generate non-focused energy. The second energy source(s) may generate non-directed energy. The first energy source(s) may project a first energy that is directed to the first surface (e.g., source surface). The second energy source(s) may project a second energy that is directed to the second surface (e.g., target surface). The second energy may be directed towards the material bed. The second energy may be directed towards the transferred (or transferring) particulate material. At times, the energy beam may be focused. The energy beams may comprise an array of energy beams. The cross-sections of the energy beams may overlap. The energy beams may comprise a diode array.

The controller may be operatively coupled to any of the energy source(s). The controller may direct the second energy source(s) to project an energy beam that transforms the material. The material may be transformed into a transformed material that subsequently hardens into a hardened material as part of the 3D object. The material may transform into the hardened material as part of the 3D object. The controller may be operatively coupled to the second energy beam(s) and directs the second energy beam(s) along a path. The path may be predetermined. The path may be generated by a tool comprising computer aided manufacturing (CAM) and/or computer added design (CAD). The controller may be operatively coupled to the first energy beam(s) and direct the first energy beam(s) along a path. The path may be predetermined. The first energy beam(s) may be directed along a path on the source surface. The material releasing electrodes may incorporate a CPOD. The CPOD may assist the transport of at least a portion of the material from the first surface to the second surface. The CPOD may further accelerates the at least a portion of the material that transfers from the source surface onto the target surface. The generation of the 3D object may comprise deforming the at least a portion of the particulate material adjacent to the target surface, into a deformed material. The deformation may comprise plastic deformation. The deformation may comprise elastic deformation. The transformed material may constitute at least a part of the 3D object. The controller may be operatively coupled to the CPOD and directs the acceleration of the at least a portion of the relocating material (e.g., from the source surface to the target surface). For example, the controller may direct the timing, amplitude, and/or time span of the acceleration. The controller may direct the rate in which the velocity of the relocating material changes per unit of time. The controller may direct the direction of acceleration (e.g., general or (e.g., substantially) precise direction). The acceleration may comprise (e.g., substantially) constant acceleration or varied acceleration. The acceleration may comprise (e.g., substantially) uniform acceleration or non-uniform acceleration. The acceleration may comprise (e.g., substantially) uniform increase in terms of the velocity of the material. The acceleration may comprise an increase in the velocity of the material that is non-uniform. The acceleration may comprise a (e.g., substantially) linear increase in the velocity of the relocating material. The acceleration may comprise a non-linear increase in the velocity of the relocating material. The controller may control the non-uniformity of the acceleration. The controller may control the, non-linearity of the acceleration. The controller may control the variability of the acceleration.

In another aspect is a system for generating a 3D object that comprises a first particulate material that is charged; a charged pattern comprising variation in electrical charge; a target surface that is separated from the source surface by a gap; and a controller operatively coupled to the first particulate material, the source surface, and the target surface, and is programmed to: (i) direct the first particulate material to the source surface, wherein a portion of the first particulate material is attached to the source surface, wherein a non-attached particulate material (e.g., that does not attach to the source surface) is a second particulate material, wherein the second particulate material is dispensed onto a target surface, wherein the attached depends on the electrical charge of a position in the pattern, and (ii) direct the generation of at least a part of the 3D object from the second particulate material. Non-attached can be non-adhered. The system may further comprise one or more first energy sources and/or second energy sources. The controller may be operatively coupled to the energy source(s) and direct the energy (e.g., beam) emitted from the source(s) (e.g., as described herein). For example, the controller may direct the first energy (e.g., beam) onto the source surface. For example, the controller may direct the second energy onto the target surface, or to a position (e.g., substantially) perpendicular to the target surface.

FIG. 17 shows an example of an energy beam 1715 that generates a first pattern on the source surface 1709, and a second energy beam 1719 that transforms the relocating material 1705. Energy beam 1715 is generated by energy source 1701, and energy beam 1719 is generated by energy source 1718.

The system may further comprise a material dispensing mechanism (e.g., a material dispenser) that dispenses the particulate material, wherein the controller is operatively coupled to the material dispensing mechanism and is programmed to direct dispensing the particulate material. Dispensing the particulate material can be from the material dispenser to at least a portion of the source or intermediate surface.

In another aspect is a system for generating a 3D object that comprises: a material bed comprising a particulate material; a material adding mechanism that adds material to the material bed; a surface level identification mechanism that identifies height variation in an exposed surface of the material bed; and a controller that is operatively coupled to the material bed, the material adding mechanism, and the surface level identification mechanism (e.g., surface level identifier, surface level indicator), and is programmed to: (i) direct the surface level identification mechanism to identify one or more height variations in the exposed surface of the material bed, wherein the material bed is utilized to forming at least one 3D object; (ii) direct the material adding mechanism to add material (e.g., particulate and/or transformed) to the exposed surface of the material bed according to the identification of height variation in order to form a planar surface, wherein the adding is conducted without contacting the exposed surface of the material bed. The material adding mechanism may comprise a material dispenser (e.g., powder dispenser). The surface identification mechanism may comprise one or more sensors. The surface identification mechanism may comprise a processor (e.g., a computer). The surface identification mechanism may comprise a central processing unit. The surface identification mechanism may comprise an electromagnetic beam. The electromagnetic beam may comprise a laser beam. The electromagnetic beam may comprise infrared, visible light, and/or ultraviolet radiation. The electromagnetic radiation may comprise a radio frequency radiation. The electromagnetic radiation may comprise short-wavelength radio waves. The radio waves may comprise ultra-high frequency, high frequency, or low frequency radio waves. The surface identification mechanism may comprise an opening port. The surface identification mechanism may comprise a screen, a keyboard, and/or a printer. The surface identification mechanism may comprise Bluetooth technology. The surface identification mechanism may comprise a communication port. The communication port may be a serial port or a parallel port. The communication port may be a Universal Serial Bus port (i.e., USB). The surface identification mechanism may comprise USB ports. The USB can be micro or mini USB. The USB port may relate to device classes comprising 00h, 01h, 02h, 03h, 05h, 06h, 07h, 08h, 09h, 0Ah, 0Bh, 0Dh, 0Eh, 0Fh, 10h, 11h, DCh, E0h, EFh, FEh, or FFh. Any mechanism and/or processor may comprise the communication port. The surface identification mechanism (and/or any mechanism and/or processor disclosed herein) may comprise a plug and/or a socket (e.g., electrical, AC power, DC power). The surface identification mechanism (and/or any mechanism and/or processor disclosed herein) may comprise an adapter (e.g., AC and/or DC power adapter). The surface identification mechanism (and/or any mechanism and/or processor disclosed herein) may comprise a power connector. The power connector can be an electrical power connector. The power connector may comprise a magnetically attached power connector. The power connector can be a dock connector. The connector can be a data and power connector. The connector may comprise pins. The connector may comprise at least 10, 15, 18, 20, 22, 24, 26, 28, 30, 40, 42, 45, 50, 55, 80, or 100 pins.

In another aspect is a system for transport of a solid material that comprises: a particulate material that is charged; a target surface; a CPOD that assists in transporting the particulate material from a position away from the target surface, onto the target surface; and a controller operatively coupled to the particulate material, the target surface and the CPOD, and is programmed to assist in transporting the particulate material to the target surface by using the CPOD. The particulate material can comprise a solid particle.

The system may further comprise a material dispensing mechanism (e.g., material dispenser) comprising the particulate material, wherein the controller is operatively connected to the material dispensing mechanism, and directs the material dispensing mechanism to dispense the particulate material. The material dispensing mechanism may comprise an exit opening port. The particulate material may exit the material dispensing mechanism though the exit opening port. The particulate material may be charged prior to being disposed into the material dispensing system. The particulate material may be charged within the material dispensing system. The particulate material may be charged after exiting the material dispensing system. The systems may further comprise a source surface. The source surface may comprise the particulate material. The CPOD may be situated between the source surface and the target surface. The controller may be operatively connected to the source surface and is programmed to transport the material from the source surface onto the target surface. The source surface may comprise a photoconductive surface. The particulate material may be charged with a first type of polarity (e.g., electrical polarity). The systems may further comprise one or more energy sources emitting one or more first (e.g., set of) beam(s). The first (e.g., set of) energy beam(s) may cause the source surface to present a charged pattern at specified locations. For example, the first energy beam may reveal a charge that is present within an item on which the source surface is disposed. For example, the first (e.g., set of) energy beam(s) may form a charge on the source surface by virtue of its electromagnetic interaction with the substance within the surface (e.g., by photochemical interaction and/or reaction). The charged pattern may be of a second type of polarity that is opposite to the first polarity type. The controller may be operatively coupled to the first (e.g., set of) energy beam(s). The controller may be programmed to direct the first (e.g., set of) energy beam(s) along a path comprising the specified locations. The specified locations may be a predetermined. The specified locations may be determined automatically or manually. The specified locations may be determined based on a design or based on a model of the 3D object. The specified locations may be generated by software. The specified locations may be determined at a whim. The system further comprises one or more material releasing electrodes that release material from the first surface (e.g., by repelling the material from the first surface, and/or by attracting the material away from the first surface).

The CPOD may accelerate the charged material. The controller may be further programmed to accelerate the particulate material and cause the particulate material to deform at the target surface. Deformation may comprise plastic or elastic deformation.

The systems may further comprise a chamber. The CPOD and/or the target surface may be disposed within the chamber. The chamber may comprise a pressurized atmosphere. For example, the pressure may be at least about 1 atmosphere, 10⁻⁴ milliTorr, or least 10⁻⁶ milliTorr. The pressure may be at most 1 atmosphere. For example, the pressure may be any pressure disclosed herein.

In another aspect is a system for generating a 3D object that comprises: a pattern comprising a particulate material that is disposed on a source surface; a target surface; an imaging device that images at least a portion of the particulate material from the source surface to the target surface; and a controller operatively coupled to the source surface, the imaging device, and the target surface, and is programmed to direct: (i) formation of the pattern on the first surface, (ii) transport and image of at least a portion of the pattern comprising the particulate material to the target surface, and (iii) generation of the 3D object from the least a portion of the pattern comprising the particulate material. The pattern may be a predetermined pattern. The pattern may be formed by specific arrangement of the particulate material on the source surface.

In another aspect is an apparatus for generating a 3D object that comprises a controller that is programmed to implement a method that comprises: depositing a particulate material from a source surface to a target surface, wherein the particulate material is disposed on the source surface in a pattern that is in accordance with a model design of the 3D object; and generating the 3D object from the at least a portion of the particulate material on the target surface.

In another aspect disclosed herein is an apparatus for generating a 3D object, comprising a controller that is programmed to direct a generation of at least a portion of the 3D object from a particulate material that is transported from a source surface to a target surface.

The controller may be programmed to direct one or more material releasing electrodes to assist in releasing the particulate material from a source surface. The particulate material may form a pattern on the source surface. The particulate material that is released may transport to a target surface. The one or more material releasing electrodes may be operatively coupled to the source surface and/or to the target surface. The controller may be programmed to direct a CPOD to transport at least a portion of a pattern comprising the particulate material from the source surface to the target surface. The CPOD may be operatively coupled to the source surface and/or to the target surface. The controller may be programmed to direct an imaging device to image at least a portion of the pattern comprising the particulate material from the source surface to the target surface. The particulate material may be a charged particulate material. The imaging device may be operatively coupled to the source surface and/or to the target surface. The imaging device may image the pattern onto the target surface, for example, using any of the imaging methodologies described herein.

In some instances, the controller is programmed to direct an atmospheric transport of at least a portion of a pattern comprising a particulate material (e.g., a charged powder material) from the source surface onto the target surface. The atmospheric transport may comprise a transport though an atmosphere. An atmospheric transport may comprise a transport trough a gaseous environment. The gaseous environment may comprise one or more gasses. The gaseous environment may be of a positive, ambient, or negative pressure. The source surface may be planar, flat, curved, or uneven. The source surface may be a 3D plane. The source surface may comprise a curvature. The target and source surface may be separated by a gap. In some examples, the controller may be programmed to direct one or more electrodes to transport at least a portion of the pattern comprising the particulate material from the source surface to the target surface. The one or more electrodes may be operatively coupled to the source surface and/or to the target surface.

In another aspect is an apparatus for generating a 3D object that comprises a source surface comprising a pattern formed of a particulate material, and a target surface, wherein the particulate material that transports from the source surface to the target surface may form at least a portion of the 3D object. The target surface may be disposed adjacent to the source surface. Adjacent may be below, above, or to the side. In some embodiments, adjacent is below.

In another aspect is an apparatus for forming a 3D object that comprises: a source surface that is configured to retain a pattern of particulate material, which pattern is in accordance with a model design of the 3D object; and a target surface disposed adjacent to the source surface, wherein at least a portion of the 3D object is formed at the target surface from at least a portion of the particulate material that is deposited on the target surface from the source surface.

In some embodiments, the apparatus further comprises one or more material releasing electrodes that release at least a portion of the particulate material from the source surface (e.g., by attracting and/or repelling the at least a portion of the particulate material). The one or more material releasing electrodes may be disposed between the source surface and the target surface. In some embodiments, the source surface may be separated from the target surface by a gap. In some embodiments, the apparatuses further comprise a CPOD that transports at least a portion of the pattern from the source surface onto the target surface. The CPOD may be disposed between the source surface and the target surface. The CPOD may be disposed adjacent to the source surface. The CPOD may be disposed adjacent to the target surface. The apparatuses may comprise an imaging device that images at least a portion of the pattern of particulate material (e.g., pattern formed by a charged particulate material) from the source surface onto the target surface. The imaging device may be disposed between the source surface and the target surface. The imaging device may be disposed adjacent to the source surface. The imaging device may be disposed adjacent to the target surface.

The apparatus may further comprise a material dispensing member (e.g., material dispenser) comprising the particulate material. The material dispenser may dispense the particulate material onto the source surface. The material dispenser may be disposed adjacent to the source surface. The apparatuses may further comprise an intermediate surface. The particulate material may be dispensed from the material dispensing member onto the intermediate surface. The particulate material may transfer from the intermediate surface to the source surface. The particulate material may be transferred from the intermediate surface to the source surface. The transfer may comprise electrical attraction of the particulate material to the source surface. The transfer may comprise contacting the intermediate surface with the source surface. The intermediate surface may be disposed between the material dispensing member and the source surface. Between as understood herein is inclusive. The source surface may comprise a photoconductive surface. The apparatuses may further comprise a first one or more energy source(s) (e.g., set). The first energy source(s) (e.g., set) may emit one or more first energy beam(s) (e.g., set). The first energy source(s) (e.g., set) may travels along a path on the source (e.g., photoconductive) surface at specified locations. The first energy source(s) (e.g., set) may interact with the source surface (e.g., photochemicaly). The interaction of the first energy source(s) (e.g., set) may facilitate generation of a charged path in the specified locations. The particulate material may have a first type of polarity (e.g., electrical polarity or magnetic polarity). The charged path may be of a second type of polarity that is opposite to the first type of polarity. The apparatus may further comprise at least one second energy source (e.g., set). The at least one second energy source (e.g., set) may emit a second energy (e.g., one energy beam or a set of energy beams) that transform(s) at least a portion of the particulate material that transferred to the target surface. The transformation may form a transformed material that (e.g., subsequently) hardens to yield at least a portion of the 3D object. The transformation may form at least a portion of the 3D object. The apparatus may further comprise a CPOD that assists in transporting at least a portion of the particulate material onto the target surface. The CPOD may further assist in accelerating the particulate material on its transfer to the target surface.

The apparatus may comprise one or more electrodes. The electrode(s) may transport at least a portion of the material pattern (e.g., comprising a charged particulate material) from the source surface to the target surface. The one or more electrodes may be disposed between the source surface and the target surface. The one or more electrodes may be disposed adjacent to the source surface. The one or more electrodes may be disposed adjacent to the target surface.

In another aspect is an apparatus for generating a 3D object that comprises a controller that is programmed to direct a particulate material onto a source surface comprising a pattern having variations in charge (e.g., electrical or magnetic), wherein the particulate material is charged, and wherein a portion of the particulate material is attached to the source surface. The attachment of the particulate material to a particular position in the pattern may depend on the charge at that particular position. The controller may be further programmed to direct at least one energy source to emit energy (e.g., beam) that transforms the particulate material that does not attach to the source surface (herein “non-attached material,” or “non-adhered material”) and is dispensed onto a target surface. The controller may be programmed to direct the emitted energy to transform the particulate material into a transformed material that (e.g., subsequently) hardens into a hardened material as part of the 3D object. The controller may be programmed to direct the emitted energy to transform the particulate material into at least a portion of the 3D object. The target surface may be operatively coupled to the at least one energy source. The target surface may be operatively coupled to the source surface. The relative locations of the source and target surfaces may be coupled.

In another aspect is an apparatus for forming a 3D object that comprises: a particulate material that is charged, a source surface comprising a pattern having variations in electrical charge, and a target surface disposed adjacent to the source surface and is separated from the source surface by a gap. At times, a portion of the charged material is attached to the source surface, wherein a non-attached particulate material (e.g., that does not attach to the first surface) is dispensed onto the target surface. The attachment of the charged material to the source surface may depend on the charge of a specific positions on the pattern (e.g., the polarity and/or magnitude of this charge). The non-attached particulate material may form at least a part of the 3D object (e.g., after it has been transformed by an energy beam, and optionally hardened into the 3D object). The source surface may be disposed adjacent to the particulate material.

The charge of the particulate material may be of a first type of (e.g., electrical and/or magnetic) polarity (e.g., minus). The charged pattern may include locations having the first type of polarity (e.g., minus), and locations having a second type of polarity that is opposite to the first type of electrical polarity (e.g., plus).

The apparatuses may further comprise at least one first energy source (e.g., set). The first energy source (e.g., or set) may project a first energy beam (e.g., or set thereof). The charge variation of the source surface may become apparent due to the interaction of the energy beam with the source (e.g., photoconductive) surface. The energy beam(s) may travel along a predetermined path.

The apparatuses may comprise at least one second energy source (e.g., set). The second energy source may generate a second energy (e.g., or set thereof). The second energy may transform at least a portion of the non-attached particulate material (e.g., at the target surface) to a transformed material. Non-attached may include non-adhered, not stuck-to, not affixed, loose, free, disconnected, unbound, unattached, or not connected. The transformed material may subsequently harden to yield at least a portion of the formed 3D object. The second energy may transform at least a portion of the non-attached particulate material (e.g., at the target surface) to at least a portion of the 3D object.

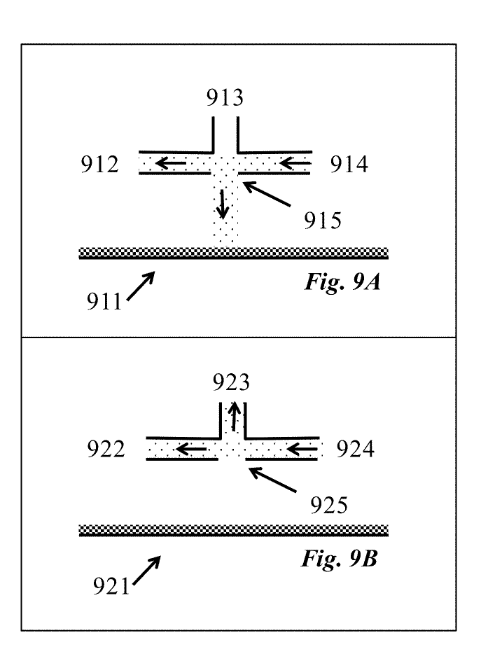

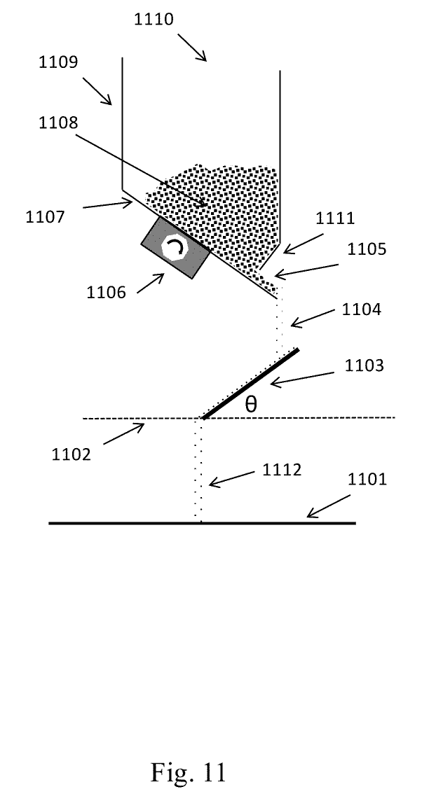

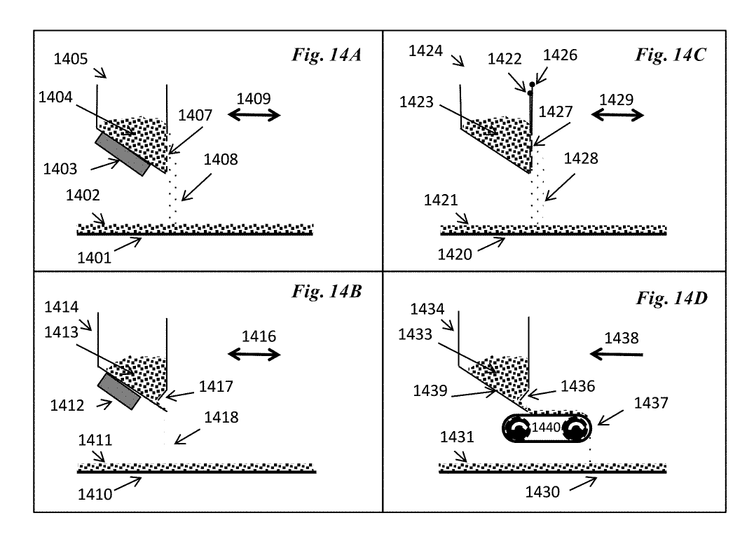

The material dispensing mechanism (e.g., dispenser) may comprise a material reservoir. The material dispensing mechanism may comprise an exit opening port. The exit opening port may be situated on the face of the dispenser that points towards the target surface, and/or away from the target surface (e.g., directly away or at an angle). The exit opening port may be situated at the top, bottom, and/or side of the material dispensing mechanism. The bottom of the material dispensing mechanism as understood herein is the face of the material dispensing mechanism that points towards the bottom of the enclosure (e.g., towards the platform, and/or the material bed). The material dispensing mechanism may comprise a top opening from which the particulate material is being removed (e.g., by an intermediate surface, or by a source surface). The material dispensing mechanism may comprise a reservoir comprising a top opening. FIG. 4 shows an example of a material dispensing mechanism 401 having a top opening 402. In FIG. 4, the particulate material within the material dispensing mechanism reservoir is removed by an intermediate surface 404. FIG. 9A shows an example of a material dispensing mechanism comprising a bottom opening 915. FIG. 14A shows an example of a material dispensing mechanism 1405 comprising a side opening 1407 that comprises a mesh. The material dispensing mechanism may comprise a slanted plane that is internal to the particulate material reservoir (e.g., FIG. 14D, 1439). The material dispensing mechanism may comprise a slanted plane that is external to the particulate material reservoir. FIG. 11 shows an example of a material dispensing mechanism 1110 comprising a side opening 1105 and a slated plane 1103 that is external to the material dispensing mechanism 1108. The side opening may be restricted by a restricting plane 1111 (e.g., a blade). The external slanted plane (e.g., 1103) may comprise a rough surface on which the material is dispensed after exiting from the exit opening port. The external slanted plane may be disposed adjacent the exit opening port of the material dispensing mechanism. The external slanted plane may be disposed below the exit opening port. The external slanted plane may be disposed between the exit opening port and the source surface. The external slanted plane may be movable before, during, and/or after the 3D printing. Movable may be horizontally and/or vertically. The movement of the external slanted plane may regulate the (i) FLS of the stream of falling particulate material, (ii) density of the particulate material in the stream of falling particulate material (e.g., 1705) and/or (iii) thickness of the layer of particulate material that adheres to the source surface (e.g., 1716). The movement of the external slanted plane may regulate the (a) FLS of the stream of falling particulate material and/or (b) density of the particulate material in the stream of falling particulate material, wherein at least one of (a) and (b) may correlate to the thickness of the layer of particulate material that adheres to the source surface.

The exit opening port may comprise an obstruction (e.g., 1111). The obstruction may be a restricting plane. The obstruction may include a mesh (e.g., FIG. 14A, 1407). The material dispensing member may comprise an electrical field potential. The material dispensing member may comprise an apparatus that injects into the particulate material a charge density (e.g., magnetic or electric). The material dispensing member may be stationary. The material dispensing member may be movable. The material dispensing member may be movable relative to the source surface, intermediate surface, and/or target surface. The material dispensing member may be stationary relative to the source surface, intermediate surface, and/or target surface.

The material dispensing member may comprise one or more material fluidization members. The material fluidization members may include gas openings, stirrers, shakers (e.g., vortex shaker), or vibrators. The material fluidization member may cause isolated particles of material (e.g., powder) to separate from each other. The material dispensing member may comprise one or more gas openings (e.g., tubes, or nozzles). The material fluidization member may comprise one or more gas openings (e.g., tubes, or nozzles). The material fluidization members may comprise one or more mixing members (e.g., mixing blades, magnetic stirrers, mechanical stirrers). The material fluidization member may comprise one or more vibrators, or shakers. The material dispensing member may comprise a magnetic material. The material dispensing member may comprise an elemental metal, a polymer, a metal alloy, a ceramic, an organic polymer, a resin, or an allotrope of elemental carbon. The material fluidization members may comprise a rod (e.g., shaking rod, vibrating rod, or stirring rod).

In another aspect is an apparatus for forming a 3D object that comprises: a material bed having an exposed surface, and comprising a particulate material; a surface level identification mechanism that identifies height variation in the exposed surface of the material bed; and a material adding mechanism that adds material to material bed according to the height variations identified by the surface level identification mechanism. The surface level identification mechanism may include a computer. The surface level identification mechanism may include software. The surface level identification mechanism may include a sensor. The identification may include projecting surface height variation according to procedures previously conducted in the material bed. The identification may include projecting surface height variation according to portions of the 3D object that were previously generated in the material bed. The identification may include projecting surface height variation according to historic and/or projected (e.g., simulated) data. For example, the identification may include projecting surface height variation according to software projected data. The identification may include detecting surface height variation(s) according to one or more sensors. The material adding mechanism may include a material dispensing member. The material adding mechanism can include a source surface that is separated from the exposed surface of the material bed by a gap. The material adding mechanism can include a mechanism for generating a pattern on a source surface. The charged pattern can include a particulate material that forms the pattern, which particulate material is charged. The charged pattern may correspond to (e.g., compensate for) the height variations of the exposed surface of the material bed. The charged pattern may correspond to the locations in the exposed surface of the material bed where material is lacking. The material adding mechanism may further comprise a material releasing electrode. The material adding mechanism may further comprise a CPOD. The material adding mechanism may further comprise an imaging device. The source surface can include a curvature. The source surface can be flat and/or planar. The source surface can be bent. The source surface can be non-flat. The source surface can be a 3D plane. The source surface can be separated from the material bed by a gap. The material adding mechanism may further comprise an electrode situated between the source surface and the exposed surface of the material bed (e.g., the target surface). The material adding mechanism may further comprise an electrode situated adjacent to the source surface. The material adding mechanism may further comprise an electrode situated adjacent to the exposed surface of the material bed. The apparatuses may further comprise one or more energy sources generating one or more energy beams that interact with the source (e.g., photoconductive) surface at specific locations to form a charged pattern. The charged pattern may be of a first polarity type. The particulate material may be charged in a second polarity type that is opposite to the first polarity type. The charged material may adhere to the charged pattern by an attraction force of their respective opposite charges. The charged material may adhere to the charged pattern by a force comprising an electrostatic force or a magnetic force. FIGS. 4 and 8 show example of material adding mechanisms.

A software may comprise a non-transitory computer readable medium.

In another aspect is an apparatus for generating 3D object that comprises a controller that is programmed to direct a surface level identification mechanism to identify height variations in an exposed surface of a material bed, and direct a material adding mechanism to add material to the exposed surface of the material bed according to the identification of height variation, in order to form a planar exposed surface of the material bed. The particulate material may be selectively added to the exposed surface of the material bed according to the identification. The particulate material may be added to places that were identified as lacking material (e.g., valleys, or depressions in the exposed surface of the material bed). The addition of the particulate material may be conducted with or without contacting the exposed surface of the material bed. The material adding mechanism may be operatively coupled to the exposed surface of the material bed. The material bed may be utilized to form the 3D object. The surface level identification mechanism may be operatively coupled to the exposed surface of the material bed.

In another aspect is an apparatus for the transport of a particulate (e.g., solid) material that comprises a CPOD that assists in transporting the particulate material that is charged, from a position away from a target surface to the target surface. The CPOD may be disposed between the position away from the target surface and the target surface. The CPOD may be disposed adjacent to the target surface. The CPOD may be disposed adjacent to the position away from the target surface.

In another aspect is an apparatus for transport of a particulate material that comprises a controller that is programmed to direct a CPOD to assist in transporting a particulate material that is charged, from a position away from a target surface to the target surface, wherein the CPOD and the target surface are operatively coupled to the controller.

In another aspect is an apparatus for generating a 3D object that comprises a controller that is programmed to direct an imaging device to image at least a portion of a pattern comprising a charged first material from a source surface onto a target surface, and direct a generation of at least a portion of the 3D object from the at least a portion of a pattern comprising the charged first material that is transported onto the target surface, wherein the first material is a particulate material. The target surface may be an exposed surface of a material bed. The material bed may comprise a second material that is different from the first material. The pattern may be formed by the first material. The imaging device may be operatively coupled to the source surface and/or target surface. The material bed may comprise the target surface. The material bed may comprise a second material that is different from the first material. The second material may offer support to the forming 3D object (e.g., during the 3D printing and/or after the 3D printing).

In another aspect is an apparatus for forming a 3D object that comprises a source surface comprising a pattern formed of a first material; a target surface that is disposed adjacent to the source surface; and an imaging device that images at least a portion of the pattern from the source surface onto the target surface. The transported first material may subsequently form at least a part of the 3D object. The imaging device may be disposed between the source surface and the target surface. The imaging device may be disposed adjacent to the source surface. The imaging device may be disposed adjacent to the target surface. The material bed may comprise a second material that is different from the first material. The second material may offer support to the forming 3D object (e.g., during the 3D printing and/or after the 3D printing).

One or more sensors (at least one sensor) can detect the topology of the target surface (e.g., an exposes surface of the material bed). The sensor can detect the amount of particulate material deposited on the target surface. The sensor can be a proximity sensor. The sensor can detect the amount of particulate material deposited on the exposes surface of a material bed. The sensor can detect the physical state of the particulate material that is deposited on the target surface. The sensor can detect the crystallinity of the particulate material deposited on the target surface. The sensor can detect the amount of particulate material transferred by or though the CPOD. The sensor can detect the amount of particulate material released or relocated from the photoconductive surface. The sensor can detect the temperature of the particulate material. For example, the sensor may detect the temperature of the particulate material in a material dispensing mechanism, on the source surface, or on the target surface. The sensor may detect the temperature of the particulate material during its transfer to the target surface. The sensor may detect the temperature and/or pressure of the atmosphere within an enclosure or a chamber in which the CPOD is disposed. The sensor may detect the temperature of the material bed.

The target (e.g., average) temperature may be controlled. The target temperature may be of the particualte material target, intermediate, and/or source surface. The target temperature may be of an average temperature of the material bed. The target may be (e.g., substantially) equal to an ambient, or room temperature. The target temperature can be at most about 10° C. (degrees Celsius), 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The target temperature can be at least about 10° C., 20° C., 25° C., 30° C., 40° C., 50° C., 60° C., 70° C., 80° C., 90° C., 100° C., 120° C., 140° C., 150° C., 160° C., 180° C., 200° C., 250° C., 300° C., 400° C., 500° C., 600° C., 700° C., 800° C., 900° C., 1000° C., 1200° C., 1400° C., 1600° C., 1800° C., or 2000° C. The target temperature can be any temperature between the afore-mentioned material average temperatures (e.g., from about 10° C. to about 2000° C., from about 10° C. to about 60° C., from about 10° C. to about 100° C., from about 10° C. to about 150° C., from about 10° C. to about 200° C., from about 10° C. to about 400° C., from about 400° C. to about 1000° C., or from about 1000° C. to about 2000° C.). The target temperature may be an average temperature.

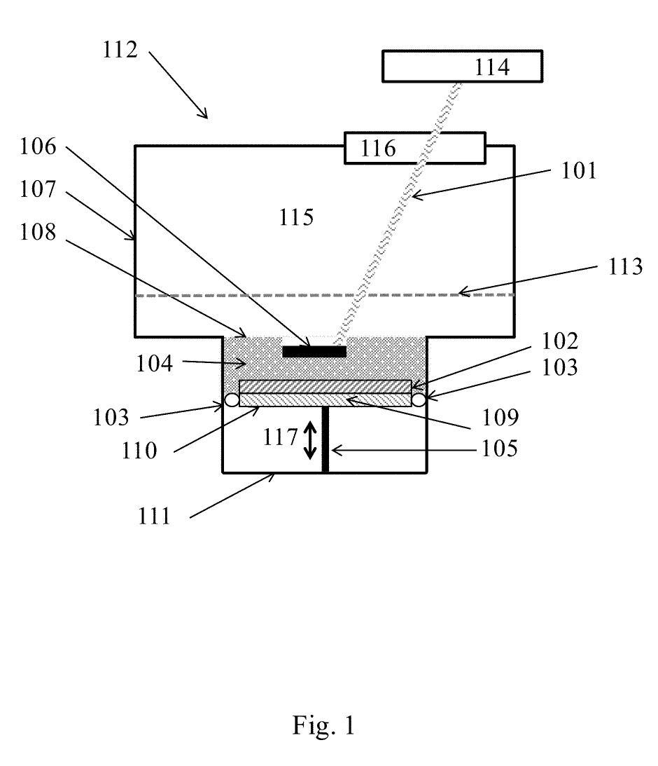

The at least one sensor can be operatively coupled to a control system (e.g., computer control system). The sensor may comprise light sensor, acoustic sensor, vibration sensor, chemical sensor, electrical sensor, magnetic sensor, fluidity sensor, movement sensor, speed sensor, position sensor, pressure sensor, force sensor, density sensor, or proximity sensor. The sensor may include temperature sensor, weight sensor, particulate material level sensor, gas sensor, or humidity sensor. The gas sensor may sense any of the gas delineated herein. The temperature sensor may comprise Bolometer, Bimetallic strip, calorimeter, Exhaust gas temperature gauge, Flame detection, Gardon gauge, Golay cell, Heat flux sensor, Infrared thermometer, Microbolometer, Microwave radiometer, Net radiometer, Quartz thermometer, Resistance temperature detector, Resistance thermometer, Silicon band gap temperature sensor, Special sensor microwave/imager, Temperature gauge, Thermistor, Thermocouple, Thermometer, or Pyrometer. The pressure sensor may comprise Barograph, Barometer, Boost gauge, Bourdon gauge, Hot filament ionization gauge, Ionization gauge, McLeod gauge, Oscillating U-tube, Permanent Downhole Gauge, Piezometer, Pirani gauge, Pressure sensor, Pressure gauge, Tactile sensor, or Time pressure gauge. The position sensor may comprise Auxanometer, Capacitive displacement sensor, Capacitive sensing, Free fall sensor, Gravimeter, Gyroscopic sensor, Impact sensor, Inclinometer, Integrated circuit piezoelectric sensor, Laser rangefinder, Laser surface velocimeter, LIDAR, Linear encoder, Linear variable differential transformer (LVDT), Liquid capacitive inclinometers, Odometer, Photoelectric sensor, Piezoelectric accelerometer, Rate sensor, Rotary encoder, Rotary variable differential transformer, Selsyn, Shock detector, Shock data logger, Tilt sensor, Tachometer, Ultrasonic thickness gauge, Variable reluctance sensor, or Velocity receiver. The optical sensor may comprise a Charge-coupled device, Colorimeter, Contact image sensor, Electro-optical sensor, Infra-red sensor, Kinetic inductance detector, light emitting diode (e.g., light sensor), Light-addressable potentiometric sensor, Nichols radiometer, Fiber optic sensors, Optical position sensor, Photo detector, Photodiode, Photomultiplier tubes, Phototransistor, Photoelectric sensor, Photoionization detector, Photomultiplier, Photo resistor, Photo switch, Phototube, Scintillometer, Shack-Hartmann, Single-photon avalanche diode, Superconducting nanowire single-photon detector, Transition edge sensor, Visible light photon counter, or Wave front sensor. The weight of the material bed can be monitored by one or more weight sensors in, or adjacent to, the material. For example, a weight sensor in the material bed can be at the bottom of the material bed. The weight sensor can be between the bottom of the enclosure (e.g., FIG. 1, 111) and the substrate (e.g., FIG. 1, 109) on which the base (e.g., FIG. 1, 102) or the material bed (e.g., FIG. 1, 104) may be disposed. The weight sensor can be between the bottom of the enclosure and the base on which the material bed may be disposed. The weight sensor can be between the bottom of the enclosure and the material bed. A weight sensor can comprise a pressure sensor. The weight sensor may comprise a spring scale, a hydraulic scale, a pneumatic scale, or a balance. At least a portion of the pressure sensor can be exposed on a bottom surface of the material bed. In some cases, the weight sensor can comprise a button load cell. The button load cell can sense pressure from a particulate material adjacent to the load cell. In another example, one or more sensors (e.g., optical sensors or optical level sensors) can be provided adjacent to the material bed such as above, below, or to the side of the material bed. In some examples, the one or more sensors can sense the particulate material level (e.g., in the material bed). The particulate material level sensor can be in communication with a material dispensing system (also referred to herein as material dispensing member, or material dispensing mechanism). Alternatively, or additionally a sensor can be configured to monitor the weight of the material bed by monitoring a weight of a structure that contains the material bed. One or more position sensors (e.g., height sensors) can measure the height of the material bed relative to the substrate. The position sensors can be an optical sensor. The position sensors can determine a distance between one or more energy beams (e.g., a laser or an electron beam) and a surface of the material bed. The one or more sensors may be connected to a control system (e.g., a processor, or computer).

The methods, systems, software and/or apparatuses can comprise a photoconductive surface. The photoconductive surface may comprise a material that is capable of altering its electrical charge when it absorbs light (e.g., of a certain wavelength or wavelength range). The photoconductive surface may be a coating. The photoconductive material may include a conductive polymer. The conductive polymer may one that is used in xerography (photocopying), in infrared detection application, and/or in television. The photoconductor may comprise a ceramic, metallic, semi conductive, or organic material. For example, the photoconductive material may include polyvinylcarbazole, silicon, zinc oxide, silicon oxide, boron nitride, silicon nitride, cadmium sulfide, lead sulfide, or selenium. The silicon oxide may comprise doped silicon oxide. The doping may comprise hydrogen or nitrogen doping.

The photoconductive surface may be included in a surface of a cylinder (e.g., drum), plate, 3D plane, or belt (e.g., conveyor belt). The belt may comprise a flexible belt. The belt may comprise an oval or triangular belt. The photoconductive surface can be included in a substantially flat and/or planar surface. At times, the photoconductive surface comprises a curvature. At times, the photoconductive surface is a curved surface. The photoconductive surface can be a substantially flat and/or planar surface. At times, the photoconductive surface is an irregular surface. At times, the photoconductive surface is a 3D plane.

In some examples, the photoconductive surface is charged (either positively or negatively) and becomes non-charged when it interacts with an energy beam (e.g., an electromagnetic beam). The charge may be electrical charge and/or magnetic charge. In some instances, the charge is an electrical charge. The photoconductive surface may be non-charged and becomes charged when interacting with an energy beam. The charge of the photoconductive surface may be reversed when interacting with an energy beam (e.g., at the position of interaction or adjacent thereto). An article (or a portion thereof) adjacent to the photoconductive surface can be charged. Adjacent may be directly or indirectly adjacent.

In some instances, the core of the item (which the photoconductive surface is a part of) or a portion thereof may be of a charge type that is opposite to the charge type of the photoconductive surface (prior to any energy beam interaction). The charged core (or a portion thereof) may be of a charge type that is opposite to the charge type of the particulate material. The charge type of the core (e.g., FIG. 4, 408) may remain constant during the 3D printing process. The charge type of the core (e.g., FIG. 8, 808) may vary during the 3D printing process. For example, the charge type of the core (e.g., FIG. 17, 1708) may alternate during the 3D printing process from one charge type, to the opposite charge type. In some instances, the alternation may be after deposition of each layer, or after deposition of a more than one layer. The charge of the core may be of a greater magnitude as compared to the charge magnitude of the particulate material. For example, the magnitude of the charge of the core may be at least about 1.5, 2, 5, 10, 15, 20, 25, or 30 times larger than the magnitude of the charge of the particulate material. The magnitude of the charge of the core may be multiplied any value between the aforementioned values, as compared to the magnitude of the charge of the material (e.g., from about 1.5 to about 30 times larger).

In some instances, the surface of the item (e.g., source surface) or a portion thereof may be of a charge type that is opposite to the charge type of the core (prior to any energy beam interaction). The charged source surface (or a portion thereof) may be of a charge type that is opposite to the charge type of the particulate material. The charge type of the source surface (e.g., FIG. 8, 809) may vary during the 3D printing process. For example, the charge type of the source surface (e.g., FIG. 17, 1709) may alternate during the 3D printing process from one charge type, to the opposite charge type. In some instances, the alternation may be after deposition of each layer, or after deposition of a more than one layer. The charge of the source surface may be of a greater magnitude as compared to the charge magnitude of the particulate material. For example, the magnitude of the charge of the source surface may be at least about 1.5, 2, 5, 10, 15, 20, 25, or 30 times larger than the magnitude of the charge of the particulate material. The magnitude of the charge of the source surface may be multiplied any value between the aforementioned values, as compared to the magnitude of the charge of the material (e.g., from about 1.5 to about 30 times larger).

The charge (e.g., electrical charge) of the photoconductive surface that does not interact with an energy beam may have a charge polarity type that remains the same throughout the 3D printing process. The charge of the photoconductive surface that does not interact with an energy beam may have a charge polarity type that varies during the 3D printing process. The variation may be in the type of electrical polarity, or in the intensity of the electrical charge. The variation may be in the type of magnetic polarity, or in the intensity of the magnetic charge. The charge of the photoconductive surface that does not interact with an energy beam may have a charge polarity type that alternates during the 3D printing process. The alternation may take place after deposition of each layer of particulate material, or after deposition of a number of layers. The variation (or alternation) may take place before, after, or during the time in which the energy beam interacts with the photoconductive surface, and/or 3D printing. For example, the charge polarity may be changed from a positive polarity to a negative polarity, or from a negative polarity to a positive polarity. At times, the item on which the photoconductive material is disposed contains a chargeable material (e.g., particulate material). In some examples, the chargeable material is charged by a first type of electrical polarity (e.g., positive or negative). In some instances, at least a part of item (e.g., drum) interior is charged by a first type of electrical polarity, and the photoconductive surface is charge by a second type of electrical polarity that is opposite to the first type of electrical polarity. For example, the interior of the item (e.g., cylinder interior) may be positively charged, while the photoconductive surface is negatively charged. At the positions at which the energy beam interacts with the photoconductive surface, the energy beam may neutralize the charge of the photoconductive material, and thus reveal the charge of the item interior (e.g., core). For example, at an interaction position of the energy beam with the photoconductor, the energy beam may manifest (e.g., reveal, expose) the first type of electrical polarity of the interior of the item. By interacting with a plurality of positions on the photoconductive surface, the energy beam may form a charged pattern (e.g., path, pattern, or formation) on the photoconductive surface. That charged pattern may be (e.g., subsequently) erased. For example, the pattern may be erased by neutralizing the photoconductive surface, or conversely by charging the entire photoconductive surface. The pattern may be erased by homogenously exposing (e.g., substantially) the entire photoconductive surface to this (or another) energy beam.

The energy beam may discharge a charge on the source surface as it travels in a path thus forming a discharge pattern on the source surface. In an example, the particulate material may be charged in a type of electrical polarity that is opposite to the one of the interior of the item. As the energy beam travels along the path pattern it forms a discharge pattern that reveals the charge of the core, thus allowing the particulate material to adhere to the charged pattern. In an example, the particulate material may be charged by a type of electrical polarity that is the same as that of the core, and the photoconductive surface comprises a polarity that is opposite to the one of the particulate material. As the energy beam travels along the path pattern it forms a discharge pattern that reveals the charge of the core, thus allowing the particulate material to be repelled from the charged pattern and adhere to the source surface in positions different from the pattern. The pattern can be non-charged, charged at the electrical polarity of the particulate material, or charged at a polarity opposite to the one of the particulate material. At times, the core of the item is not charged. At times, the energy beam transforms the source surface from one polarity to an opposite polarity as it interacts with the source surface at a particular location. The particulate material may have a charge of the same polarity of the formed pattern (e.g., on the source surface), or of the position of the source surface different from the pattern. At times, the particulate material may adhere to the pattern. At times, the particulate material may adhere to the source surface at positions other than the pattern.

The item (e.g., cylinder, plate or belt) carrying the photoconductive surface may translate (e.g., horizontally and/or vertically). For example, the cylinder may rotate. The plate or belt may translate horizontally, vertically, or in an angle. The angle may be a planar or a compound angle.

The photoconductive surface and/or the particulate material may be charged by a charging mechanism. The charging mechanism may comprise one or more charging members. The charging mechanism (also herein “charging device”) may comprise a corona discharge member. The corona may be positive or negative. The charging mechanism may comprise an ionizing gas. The charging mechanism may comprise a charging fluid. The charging mechanism may comprise a gas discharge lamp. The gas discharge lamp may comprise low pressure, high pressure, or high intensity discharge lamp. The charging mechanism may comprise a dielectric-barrier discharge. The charging mechanism may induce an electrostatic charge on the photoconductive surface. The electrostatic charge may be of at least about 600 volts of a certain electrical polarity (e.g., negative polarity).

The methods, systems, software, and/or apparatuses can comprise a first and second energy source. In some cases, the system can comprise three, four, five, or more energy sources. The system can comprise an array of energy sources. The energy sources can be a set. In some cases, the system can comprise a third energy source. The energy beam can interact with at least a portion of the photoconductive surface. The energy source can project energy (e.g., heat energy and/or energy beam). The energy (e.g., flux or beam) can interact with at least a portion of the material (e.g., particulate or transformed) in the material bed. The energy can heat the particulate material before during and/or after the material interacts with the photoconductive surface. The energy can heat the particulate material before during and/or after it translates with the assistance (e.g., through) the CPOD. The energy can heat at least a fraction of a 3D object at any point during its formation and/or thereafter. Alternatively or additionally, the material bed may be heated by a heating member (e.g., to a target temperature) comprising a lamp, a strip heater (e.g., mica strip heater), a heating rod, or a radiator (e.g., a panel radiator). In some cases, the system can have a single (e.g., first) energy source. An energy source can be a source configured to deliver energy to an area (e.g., a confined area). An energy source can deliver energy (e.g., to the confined area) through radiative heat transfer. The energy beam may include a radiation comprising an electromagnetic, or charge particle beam. The energy beam may include a radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy source may include a laser source. The energy source may include an electron gun. The energy source may include an energy source capable of delivering energy to a point or to an area. In some embodiments the energy source can be a laser. In an example a laser can provide light energy at a peak wavelength of at least about 100 nanometer (nm), 500 nm, 750 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 750 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). An energy beam from the first and/or second energy source can be incident on, or be directed to, the source surface (e.g., photoconductive surface), or the target surface. The energy beam can be directed to a specified area on the surface (e.g., source and/or target) for a specified time period. The material in the material bed can absorb the energy from the energy source (e.g., energy beam, radiator or lamp) and, and as a result, a localized region of the material can increase in temperature. The energy source and/or beam can be moveable such that it can translate relative to the surface. In some instances, the energy source may be movable such that it can translate relative to the top surface of the material bed, the material adding mechanism, and/or source surface. The energy beam(s) and/or source(s) can be moved via a scanner (e.g., galvanometer scanner), a polygon, a mechanical stage, or any combination of thereof. The galvanometer may comprise a mirror. The galvanometer scanner may comprise a two axis galvanometer scanner. The scanner may comprise a modulator. The scanner may comprise a polygonal mirror. The scanner can be the same scanner for two or more energy sources and/or beams. Each energy source and/or beam may have a separate scanner. The energy sources can be translated independently of each other. In some cases, at least two energy sources and/or beams can be translated at different rates. For example, the movement of the first energy source and/or beam may be faster as compared to the movement of the second energy source and/or beam. The system and/or apparatus disclosed herein may comprise one or more shutters (e.g., safety shutters).

FIG. 1 depicts an example of a system that can be used to generate a 3D object using a 3D printing process disclosed herein. The system can include an enclosure (e.g., a chamber 112). At least a fraction of the components in the system can be enclosed in the chamber. At least a fraction of the chamber can be filled with a gas to create a gaseous environment (i.e., an atmosphere). The gas can be an inert gas (e.g., Argon, Neon, Helium, Nitrogen). The chamber can be filled with another gas or mixture of gases. The gas can be a non-reactive gas (e.g., an inert gas). Non-reactive may be with respect to the particulate, transformed, and/or hardened material. The gaseous environment can comprise argon, nitrogen, helium, neon, krypton, xenon, hydrogen, carbon monoxide, or carbon dioxide.

The pressure in the chamber can be at least about 10⁻⁷ Torr, 10⁻⁶ Torr, 10⁻⁵ Torr, 10⁻⁴ Torr, 10⁻³ Torr, 10⁻² Torr, 10⁻¹ Torr, 1 Torr, 10 Torr, 100 Torr, 1 bar, 2 bar, 3 bar, 4 bar, 5 bar, 10 bar, 20 bar, 30 bar, 40 bar, 50 bar, 100 bar, 200 bar, 300 bar, 400 bar, 500 bar, or 1000 bar. The pressure in the chamber can be at least about 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at most about 10⁻⁷ Torr, 10⁻⁶ Torr, 10⁻⁵ Torr, or 10⁻⁴ Torr, 10⁻³ Torr, 10⁻² Torr, 10⁻¹ Torr, 1 Torr, 10 Torr, 100 Torr, 200 Torr, 300 Torr, 400 Torr, 500 Torr, 600 Torr, 700 Torr, 720 Torr, 740 Torr, 750 Torr, 760 Torr, 900 Torr, 1000 Torr, 1100 Torr, or 1200 Torr. The pressure in the chamber can be at a range between any of the aforementioned pressure values (e.g., from about 10⁻⁷ Torr to about 1200 Torr, from about 10⁻⁷ Torr to about 1 Torr, from about 1 Torr to about 1200 Torr, or from about 10⁻² Torr to about 10 Torr). In some cases, the pressure in the chamber can be standard atmospheric pressure. At times, the pressure in the chamber can be ambient pressure (e.g., neutral pressure). In some examples, the chamber can be under vacuum pressure. In some examples, the chamber can be under a positive pressure (e.g., above ambient pressure). In some cases, the enclosure pressure can be standard atmospheric pressure.

The chamber can comprise two or more gaseous layers. The gaseous layers can be separated by molecular weight or density such that a first gas with a first molecular weight or density is located in a first region below the imaginary line 113, and a second gas with a second molecular weight or density is located in a second region of the chamber above the imaginary line 113. The first molecular weight or density may be smaller than the second molecular weight or density. The first molecular weight or density may be larger than the second molecular weight or density. The gaseous layers can be differentiated by temperature. The first gas can be in a lower region of the chamber relative to the second gas. The second gas and the first gas can be in adjacent locations. The second gas can be on top of, over, and/or above the first gas. In some cases, the first gas can be argon and the second gas can be helium. The molecular weight or density of the first gas can be at least about 1.5*, 2*, 3*, 4*, 5*, 10*, 15*, 20*, 25*, 30*, 35*, 40*, 50*, 55*, 60*, 70*, 75*, 80*, 90*, 100*, 200*, 300*, 400*, or 500* greater than the molecular weight or density of the second gas. The symbol “*” as used herein designates the mathematical operation “times.” The molecular weight of the first gas can be higher than the molecular weight of air. The molecular weight or density of the first gas can be higher than the molecular weight or density of oxygen gas (e.g., O₂). The molecular weight or density of the first gas can be higher than the molecular weight or density of nitrogen gas (e.g., N₂). At times, the molecular weight or density of the first gas may be lower than that of oxygen gas or nitrogen gas.

The first gas with the relatively higher molecular weight or density can fill a region of the system where the material bed is located (e.g., 104). The second gas with the relatively lower molecular weight or density can fill a region of the system away from the region where the 3D object is formed (e.g., in the chamber 112 and above the line 113). The material layer can be supported on a substrate (e.g., 109). The substrate can have a circular, rectangular, square, or irregularly shaped cross-section. The substrate may comprise a base disposed above the substrate. The substrate may comprise a base (e.g., 102) disposed between the substrate and a material layer (or a space to be occupied by a material layer). A thermal control unit (e.g., a cooling member such as a heat sink or a cooling plate, a heating plate, or a thermostat) can be provided inside of the region where the 3D object is formed or adjacent to the region where the 3D object is formed (e.g., in the chamber). At least a portion of the thermal control unit can be provided outside of the region where the 3D object is formed (e.g., at a predetermined distance). The thermal control unit can form at least one section of a boundary region where the 3D object is formed (e.g., the container accommodating the material bed).

The concentration of oxygen in the enclosure (e.g., chamber) can be minimized. The concentration of oxygen and/or humidity in the chamber can be maintained below a predetermined threshold value. For example, the gas composition in the chamber can contain a level of oxygen and/or humidity that is at most about 100 parts per billion (ppb), 10 ppb, 1 ppb, 0.1 ppb, 0.01 ppb, 0.001 ppb, 100 parts per million (ppm), 10 ppm, 1 ppm, 0.1 ppm, 0.01 ppm, or 0.001 ppm. The gas composition of the chamber can contain an oxygen and/or humidity level between any of the aforementioned values (e.g., from about 100 ppb to about 0.001 ppm, from about 1 ppb to about 0.01 ppm, or from about 1 ppm to about 0.1 ppm). In some cases, the chamber can be opened at the completion of a formation of a 3D object. When the chamber is opened, ambient air containing oxygen and/or humidity can enter the chamber. Exposure of one or more components inside of the chamber to oxygen, humidity, and/or air can be reduced by, for example, flowing an inert gas while the chamber is open (e.g., to prevent entry of ambient air), and/or by flowing a heavy gas (e.g., argon) that rests on the surface of the material bed. In some cases, components that absorb oxygen and/or water on to their surface(s) can be sealed while the chamber is open.

The chamber can be configured such that gas inside of the chamber has a relatively low leak rate from the chamber to an environment outside of the chamber. At times, the leak rate can be at most about 100 milliTorr/minute (mTorr/min), 50 mTorr/min, 25 mTorr/min, 15 mTorr/min, 10 mTorr/min, 5 mTorr/min, 1 mTorr/min, 0.5 mTorr/min, 0.1 mTorr/min, 0.05 mTorr/min, 0.01 mTorr/min, 0.005 mTorr/min, 0.001 mTorr/min, 0.0005 mTorr/min, or 0.0001 mTorr/min. The leak rate may be between any of the aforementioned leak rates (e.g., from about 0.0001 mTorr/min to about, 100 mTorr/min, from about 1 mTorr/min to about, 100 mTorr/min, or from about 1 mTorr/min to about, 100 mTorr/min). The enclosure can be sealed such that the leak rate of gas from inside the chamber to an environment outside of the chamber is low. The seals can comprise O-rings, rubber seals, metal seals, load-locks, or bellows on a piston. The chamber can have a controller configured to detect leaks above a specified leak rate (e.g., by using a sensor). The sensor may be coupled to a controller. In some instances, the controller is able to identify a leak by detecting a decrease in pressure in side of the chamber over a given time interval.

A particulate material can be dispensed onto the substrate to form a 3D object from the particulate material. The particulate material can be dispensed from a source surface (e.g., photoconductive surface) to the target surface. The material dispensing mechanism can be adjacent to the material bed. The source surface may span the entire width of the material bed, entire length of the material bed, or a portion of the material bed. In some examples, at least of a plurality of source surfaces can work in parallel or sequentially. The use of the multiple source surfaces may accelerate the production rate of the 3D object by at least about a factor of about 1.5, 2, 3, 4, 5, 6, 7, 8, 9, or 10. The use of the multiple source surfaces may accelerate the production rate of the 3D object by a factor within any value between the aforementioned factor values (e.g., from about a factor of 1.5 to about a factor of 10, from about a factor of 2 to about a factor of 5, or from about a factor of 3 to about a factor of 7). The source surface may comprise an array of source surfaces (e.g., array of photoconductive surfaces). The array of source surfaces may be spaced apart evenly or unevenly. The array of array of source surfaces may be spaced apart at most about 0.1 mm, 0.3 mm, 0.5 mm, 1 mm, 1.5 mm, 2 mm, 3 mm, 4 mm, or 5 mm. The array of particulate material delivery components may be spaced apart at least about 0.1 mm, 0.3 mm, 0.5 mm, 1 mm, 1.5 mm, 2 mm, 3 mm, 4 mm, or 5 mm. The array of array of source surfaces may be spaced apart between any of the afore-mentioned spaces of the leveling members (e.g., from about 0.1 mm to about 5 mm, from about 0.1 mm to about 2 mm, from about 1.5 mm to about 5 mm). The source surface(s) may contact the target surface. Each source surface may be coupled to a scanner. Alternatively, one scanner can be coupled to two or more source surfaces. The scanner may aid in the translation of the material adding mechanism.

The source surface(s) may be separated from the target surface by a gap. FIG. 4 shows an example of a source surface (e.g., 413) that is separated from a target surface (e.g., 411) by a gap (e.g., 412). The source surface may be separated from the target surface by at most about 0.1 mm, 0.3 mm, 0.5 mm, 1 mm, 1.5 mm, 2 mm, 3 mm, 4 mm, 5 mm, 1 cm, 5 cm, 20 cm, 30 cm, 50 cm, or 1 m. The source surface may be separated from the target surface by at least about 0.1 mm, 0.3 mm, 0.5 mm, 1 mm, 1.5 mm, 2 mm, 3 mm, 4 mm, 5 mm, 1 cm, 5 cm, 20 cm, 30 cm, 50 cm, or 1 m. The source surface may be separated from the target surface by a value that is between any of the afore-mentioned values (e.g., from about 0.1 mm to about 1 m, from about 0.1 mm to about 2 mm, from about 1.5 mm to about 5 mm, from about 5 mm to about 20 cm, or from about 5 cm to about 1 m). The gap may include a gas (e.g., an atmosphere). The gap may be termed gaseous gap or atmospheric gap. The gas may be any of the aforementioned gasses. The gas (e.g., atmosphere) may be of any of the enclosure (e.g., chamber) pressures mentioned herein.

The source surface may be coupled to a material dispensing mechanism. FIG. 4 shows an example of a material dispensing mechanism. The material dispensing mechanism may comprise a reservoir (e.g., 401). The reservoir may comprise an opening port. The opening port may be an entrance opening port, an exit opening port, or be both as an exit and entrance opening port. The material dispensing mechanism may dispense particulate material. An exit opening port may allow material to exit from the reservoir. An entrance opening port may allow material to enter into the reservoir. The exit opening port and the entrance opening port can be the same or different opening ports. The material dispensing mechanism may comprise an intermediate surface (e.g., 404). The intermediate surface may comprise a planar, surface or a curved surface. The intermediate surface may be a photoconductive surface. The intermediate surface (e.g., 404) may contact the source surface (e.g., 407). The intermediate surface may be a surface of a cylinder (e.g., drum), a 3D plane (e.g., a planar surface), or a belt (e.g., a conveyor belt). The intermediate surface may translate (e.g., horizontally and/or vertically) and/or rotate. The source surface may translate (e.g., horizontally and/or vertically) and/or rotate. The intermediate surface may rotate in a direction opposite to the rotational direction of the source surface. The intermediate surface may rotate in a direction of the rotational direction of the source surface. The source and/or intermediate surface may rotate on an axis. The axis of rotation may be (e.g., substantially) normal to the direction of the gravitational force. The axis of rotation may be (e.g., substantially) parallel to the platform, and/or target plane. The intermediate surface may translate in the translation direction of the source surface. The translation of the intermediate surface may be synchronized with the translation direction of the source surface. The intermediate surface may be charged (e.g., by a charging mechanism). The material dispensing mechanism may comprise a charging mechanism. The charging mechanism may charge the material within the material dispensing mechanism. The material dispensing mechanism may exclude a charging mechanism. The material may enter the material dispensing mechanism as a charged material. The intermediate surface may have a charge (e.g., electrical and/or magnetic) that is of an opposite polarity to the charge of the material. The material dispensing mechanism may comprise a leveling member (e.g., a scraper, 403). The leveling member may level the particulate material that adheres (e.g., via an electrostatic force) to the intermediate surface. The scraper may comprise a blade, a plank, or a rod. The scraper may comprise an obstruction (e.g., blade, a plank, or a rod). The scraper may homogenously level the height of the layer of material that attaches to the intermediate surface (e.g., 414). Attach may include adhere, affix, connect, or stick-to. The blade may comprise a doctor blade. The position of the scraper, the material dispensing mechanism (e.g., powder dispenser), the intermediate surface, the source surface, and/or the target surface may be altered manually or electronically. The scraper, the material dispensing mechanism (and any of the parts thereof such as, for example, the slanted plane), intermediate surface, source surface, and/or target surface may be controlled by a control mechanism. The scraper, the material dispensing mechanism, and/or the intermediate surface may be coupled to the position of the source surface, the CPOD, and/or the target surface. The slanted plane may be external or internal. The external slanted plane and the may be of a shape and/or material of the scraper disclosed herein.

The blade may comprise a concave or convex plane. The blade may be able to level the particulate material and cut, remove, shear, and/or scoop any unwanted particulate material. The blade may have an indentation, depression, or cavity. The indentation can be of any shape. For example, the indentation can comprise a shape having an elliptical (e.g., circular), rectangular (e.g., square), triangular, pentagonal, hexagonal, octagonal, any other geometric shape, or a random shape. The blade may have an indentation that is able to cut, push, lift, and/or scoop the particulate material as it moves (e.g., laterally). The blade may comprise at least one slanted plane. For example, the part closer to the tip of the blade may comprise at least one slanted plane. The blade may comprise a tapered bottom plane (e.g., a chamfer). The tapered bottom plane may be planar or curved. The blade may comprise a planar or a curved plane. The radius of curvature may be above the tapered bottom plane (e.g., away from the direction of the substrate), or below the tapered bottom plane (e.g., towards the direction of the surface). At least part of the blade may comprise elemental metal, metal alloy, an allotrope of elemental carbon, ceramic, plastic, rubber, resin, polymer, glass, stone, or a zeolite. At least part of the blade may comprise a hard material. At least part of the blade may comprise a soft material. The at least part of the blade may comprise the tip of the blade, the bottom of the blade facing the source and/or intermediate surface. At least part of the blade may comprise a material that is non bendable during the leveling and/or scraping of the particulate material. At least part of the blade may comprise a material that is substantially non-bendable when pushed against the particulate material during the leveling and/or scraping process. At least part of the blade may comprise a material that is substantially non-bendable during the leveling and/or scraping of the particulate material (e.g., from the intermediate and/or source surface). At least part of the blade may comprise an organic material. At least part of the blade may comprise plastic, rubber, or Teflon®. The blade may comprise a material to which the particulate material does not cling. At least part of the blade may comprise a coating to which the particulate material does not cling. At least part of the blade may be charged to prevent clinging of the particulate material to the blade. The blade may be movable. For example, the blade may be movable horizontally, vertically, or at an angle. The blade may be movable manually and/or automatically (e.g., by a mechanism controlled by a controller). The movement of the blade may be programmable. The movement of the blade may be predetermined. The movement of the blade may be according to an algorithm. The movement may be before, during, and/or after the 3D printing.

In some embodiments, the material dispensing mechanism dispenses the particulate material onto the source surface. The material dispensing mechanism can dispense material (e.g., powder) directly onto the source surface. The material dispensing mechanism can dispense the particulate material indirectly onto the source surface (e.g., by using an intermediate surface). The intermediate surface can comprise a flat and/or planar surface. The flat and/or planar surface may comprise a slated surface. The source and intermediate surfaces may contact. The source and intermediate surfaces may be separated by a gap. FIG. 8 shows an example of a material dispensing mechanism 802 that dispenses particulate material onto an intermediate slated surface 803, from which the particulate material dispenses onto the target surface 809. In some embodiments, the intermediate surface is an integral part of the material dispensing mechanism. The intermediate surface can be separate from the material dispensing mechanism. The intermediate surface may be planar, or curved. The intermediate surface may be a 3D plane. FIG. 4 shows an example of an intermediate surface 404 that is curved.

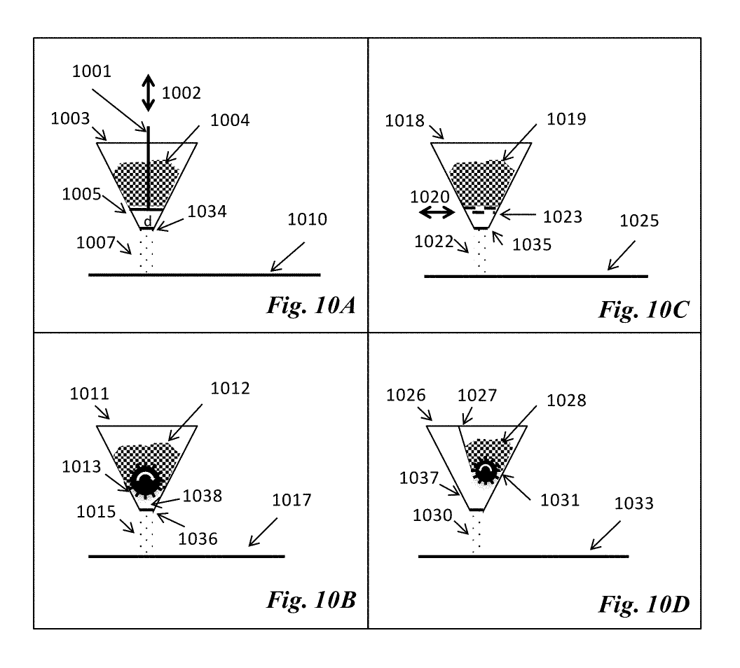

FIGS. 10A-D schematically depict vertical side cross sections of various mechanisms for dispensing the particulate material. FIG. 10A depicts a material dispenser 1003 situated above the target surface 1010. FIG. 10B depicts a material dispenser 1011 situated above the surface 1017. FIG. 10C depicts a material dispenser 1018 situated above the surface 1025. FIG. 10D depicts a material dispenser 1026 situated above the surface 1033.

The source surface may be coupled to a material removal mechanism (e.g., a powder removal mechanism). For example, FIG. 8 shows a source surface 809 that is situated adjacent to a material removal mechanism (e.g., including parts 810-812) which may release (e.g., scrape off) material that adheres to the source surface 816 using a 3D plane (e.g., blade) 810. The scraped off particulate material may be collected in a reservoir 811. The material in the reservoir may be reused (as is or after conditioning) in future applications. The material removal mechanism may be coupled to the material dispensing system. The material removal mechanism can be oriented above, below, and/or to the side of the source surface.

The material removal mechanism may translatable horizontally, vertically, or at an angle. The translation of the material removal mechanism may be coupled to the translation of the source and/or intermediate surface relative to the target surface. The material removal mechanism may comprise a material entrance opening port and a material exit opening port. The material entrance port and material exit port may be the same opening. The material entrance port and material exit port may be the same or different openings. For example, the material entrance and material exit ports may be spatially separated. The spatial separation may be on the external surface of the material removal mechanism. The spatial separation may be along the surface area of the material removal mechanism. The material entrance and material exit ports may be (e.g., fluidly) connected. For example, the material entrance and material exit ports may be connected within the material removal mechanism. For example, the connection may be an internal cavity within the material removal mechanism.

The material dispensing mechanism may translatable horizontally, vertically, or at an angle. The material dispensing mechanism may comprise a material entrance opening port and a material exit opening port. The material entrance port and material exit port may be the same opening. The material entrance port and material exit port may be different openings. The material entrance and material exit ports may be spatially separated. The spatial separation may be along the external surface of the material dispensing mechanism. The spatial separation may be along the surface area of the material dispensing mechanism. The material entrance and material exit ports may be connected. The material entrance and material exit ports may be connected within the material dispensing mechanism. The connection may be an internal cavity within the material dispensing mechanism. The particulate material may travel from the material entry port to the material exit port, though the internal cavity. For example, FIG. 11 shows an entrance port 1110 and an internal cavity in which the particulate material 1108 resides, and an exit opening port 1105. The particulate material can be dispensed from a top material dispensing mechanism. The top material dispensing mechanism can be located above the source surface. The top material dispensing mechanism may be located above or below the widest horizontal planar portion of a vertical cross section of an item (e.g., cylinder) on which the source surface is disposed. The exit opening port of the top material dispensing mechanism may be located above or below the widest horizontal planar portion of a vertical cross section of an item on which the source surface is disposed. The position at which the material exits the of the top material dispensing mechanism may be located above or below the widest horizontal planar portion of a vertical cross section of a cylinder on which the source surface is disposed. FIG. 8 shows an example of a material dispensing mechanism that includes 802 and 803 that is located above the widest horizontal planar portion 814 of a vertical cross section of the cylinder 808 on which the source surface 809 is disposed. FIG. 17 shows an example of a material dispensing mechanism that includes 1702 and 1704. A position 1703 at which the particulate material exits the material dispensing system is located below the widest horizontal planar portion 1714 of a vertical cross section of the cylinder 1708 on which the source surface 1709 is disposed.

The material dispensing mechanism can dispense material at a predetermined time, rate, location, dispensing scheme, or any combination thereof. In some examples, the material dispensing mechanism contacts the source surface and/or the intermediate surface. In some examples, the material dispensing mechanism does not contact the source surface and/or the intermediate surface. The material dispensing mechanism may be separated from the source surface and/or intermediate surface by a gap. The gap may be adjustable. The vertical distance of the gap may be at least about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The vertical distance of the gap may be at most about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The vertical distance of the gap may be any value between the aforementioned values (e.g., from about 0.5 mm to about 100 mm, from about 0.5 mm to about 60 mm, or from about 40 mm to about 100 mm).

The material dispensing mechanism may have at least one opening. The size of the opening, the shape of the opening, the timing and the duration of the opening may be controlled (e.g., directed, adjusted, and/or regulated) by a controller.

The material removal mechanism may comprise a force that causes the particulate material to travel from the source surface towards the interior of the material removal mechanism (e.g., the reservoir). The material removal mechanism may comprise negative pressure (e.g., vacuum), electrostatic force, electric force, magnetic force, or physical force. The material dispensing mechanism may comprise positive pressure (e.g., a gas) that causes the particulate material to leave the material dispensing mechanism and travel into its opening. The gas may comprise any gas disclosed herein. The gas may aid in fluidizing the particulate material that remains in the material bed after a portion of a particulate material has been transformed. The removed particulate material may be recycled, conditioned, and re-applied into the source surface by the material dispensing mechanism. The particulate material may be continuously recycled though the operation of the material removal system (e.g., before, during, and/or after the 3D printing). For example, the particulate material may be recycled after a layer of material has been removed (e.g., from the source surface). The particulate material may be recycled after several layers of particulate material have been removed. The particulate material may be recycled after a 3D object has been printed. At times, a plurality of 3D object may be printed in the same material bed.

The systems, apparatuses, software, and/or methods described herein can comprise a material recycling system (herein “recycling system”). The recycling system can collect unused (e.g., comprising particulate or transformed) material and return the unused particulate material to a reservoir of a material dispensing mechanism (e.g., the material dispensing reservoir), and/or to the bulk reservoir. Unused particulate material may be a particulate material that was not used to form at least a portion of the 3D object. At least a fraction of the particulate material scraped by the scraper can be recovered by the recycling system. At least a fraction of the particulate material within the material bed that did not transform to subsequently form the 3D object can be recovered by the recycling system. A vacuum (e.g., which can be located at an edge of the material bed) can collect unused material. Unused material can be removed from the material bed without vacuum. Unused material can be removed from the material bed manually. Unused material can be removed from the material bed by positive pressure (e.g., by blowing away the unused material). Unused material can be removed from the material bed by actively pushing it from the material bed (e.g., mechanically or using a positive pressurized gas). A gas flow can direct unused material to the vacuum. A material collecting mechanism (e.g., a shovel) can direct unused material to exit the material bed (and optionally enter the recycling system). The recycling system can comprise one or more filters (e.g., sieves) to control a size range of the particles returned to the reservoir. In some cases, a Venturi scavenging nozzle can collect unused material. The nozzle can have a high aspect ratio (e.g., at least about 2:1, 5:1, 10:1, 20:1, 30:1, 40:1, or 100:1) such that the nozzle does not become clogged with material particle(s). In some embodiments, the particulate material may be collected by a drainage system though one or more drainage ports that drain unused material from the material bed into one or more drainage reservoirs. The unused material in the one or more drainage reservoirs may be re used (e.g., after filtration and/or further treatment). Unused material may be a remainder of a material that did not transform to form the 3D object.

The material removal mechanism can comprise a reservoir of particulate material and/or a mechanism configured to deliver the particulate material from the reservoir to the material dispensing mechanism. The particulate material in the reservoir can be treated (e.g., conditioned). Conditioned may be for the 3D printing. The treatment may include heating, cooling, maintaining a predetermined temperature, sieving, filtering, charging, and/or fluidizing (e.g., with a gas). The reservoir can be emptied after each particulate material layer has been leveled, when the reservoir is filled up, at the end of a build cycle, and/or at a whim. The reservoir can be continuously emptied during the operation of the material removal mechanism. At times, the material removal mechanism does not have a reservoir. At times, the material removal mechanism constitutes a material removal (e.g., a suction) channel that leads to an external reservoir and/or to the material dispensing mechanism. The material removal and/or dispensing mechanism may comprise an internal reservoir.

The reservoir of the material dispensing mechanism and/or the material removal mechanism can be of any shape. The reservoir can be a tube (e.g., flexible or rigid). The reservoir can be a funnel. The reservoir can have a rectangular cross section or a conical cross section. The reservoir can have an amorphous shape.

The material removal mechanism may include one or more suction nozzles. The suction nozzle may comprise any of the nozzles described herein. The nozzles may comprise of a single opening or a multiplicity of openings as described herein. The openings may be vertically leveled or not leveled). The openings may be vertically aligned, or misaligned. In some examples, at least two of the multiplicity of openings may be misaligned. The multiplicity suction nozzles may be aligned at the same height relative to the surface (e.g., source surface), or at different heights (e.g., vertical height). The different height nozzles may form a pattern, or may be randomly situated in the suction device. The nozzles may be of one type, or of different types. The material removal mechanism (e.g., suction device) may comprise a curved surface, for example adjacent to the side of a nozzle. Particulate material that enters though the nozzle may be collected at the curved surface. The nozzle may comprise a cone. The cone may be a converging cone or a diverging cone.

A controller may control the material removal and/or material dispensing mechanism. The controller may control the source, intermediate, and/or target surface. For example, the control may comprise controlling the speed (velocity) of a lateral movement of the source, intermediate, and/or target surface.

The controller may control the level of pressure (e.g., vacuum, ambient, or positive pressure) in the material removal mechanism, material dispensing mechanism, and/or the enclosure (e.g., chamber). The pressure level may be constant or varied. The pressure level may be turned on and off manually or by the controller. The pressure level may be less than about 1 atmosphere pressure, more than about 1 atmosphere pressure, or (e.g., about) 1 atmosphere pressure. The pressure level may be any pressure level disclosed herein.

The controller may control the charging mechanism. For example, the controller may control the amount of magnetic, and/or electrical charge generated by the charging mechanism. For example, the controller may control the polarity type of magnetic, and/or electrical charge generated by the charging mechanism. The controller may control the timing and the frequency at which the charge is generated.

Control may comprise regulate, monitor, restrict, limit, govern, restrain, supervise, direct, guide, manipulate, or modulate.

The material dispensing mechanism can be oriented adjacent to the target surface. Adjacent may by above, below, or to the side. The material dispensing mechanism may rotate at an axis. The axis of rotation may be normal to the direction in which particulate material exits the material dispensing mechanism. At times, the material dispensing mechanism may not be rotatable. The material dispensing mechanism may translatable horizontally, vertically, or at an angle. The axis of rotation of the material dispensing mechanism may be normal or parallel to the direction of translation. The material dispensing mechanism may dispense particulate material at predetermined time, rate, location, dispensing scheme, or any combination thereof.

The CPOD and/or material releasing electrode(s) may aid in dispensing particulate material (e.g., from the source surface to the target surface) at predetermined time, rate, location, dispensing scheme, or any combination thereof. The controller may control the CPOD and/or the material releasing electrode(s). The controller may control the trajectory of the material that travels within the CPOD, or with the aid of the CPOD. The controller may control the movement of the CPOD and/or material releasing electrode(s). The material releasing electrode(s) may be a part of the CPOD. The movement may be horizontal, vertical, or angular movement. Angular may comprise a planar or compound angle. The controller may control the intensity of field generated by the one or more electrodes (e.g., that are a part of the CPOD and/or material releasing electrode(s)). The controller may control the imaging (e.g., that is performed with the assistance of (e.g., by) the CPOD).

The material dispensing mechanism can dispense particulate material onto at least a fraction of the (e.g., source, intermediate, and/or target) surface. The CPOD can assist in dispensing particulate material to at least a fraction of the (e.g., source, intermediate, and/or target) surface. The material dispensing mechanism may comprise one or more openings though which gas travels though. The CPOD may comprise at least one gas that travels though the CPOD. The gas may aid in fluidizing the particulate material that resides in the material reservoir (e.g., of the material dispenser), or that is dispensed from the material dispensing mechanism.

In some instances, the reservoir of the material dispensing mechanism comprises an exit opening port, wherein the particulate material is being displaced (e.g., flows) within the reservoir from one side of the exit port to the other side. The displacement may be a lateral displacement (e.g., from right to left), or an angular displacement (e.g., at a planar or compound angle). The displacement may comprise laminar and/or turbulent flow. The rate of the displacement may determine the amount of material that exits though the exit port (e.g., due to gravitational force). In some embodiments, the particulate material is attracted to a position away from the exit opening port. The attraction may comprise electrical, magnetic, or physical attraction. The physical attraction may comprise negative pressure (e.g., vacuum). A pressure variation may effectuate the displacement. The pressure variation may comprise positive pressure at one side of the opening, and ambient pressure (e.g., about 1 atmosphere) at the other side. The pressure variation may comprise positive pressure at one side of the opening, and negative pressure at the other side. The pressure variation may comprise ambient pressure at one side of the opening, and negative pressure at the other side. A charge (magnetic and/or electrical) variation may similarly effectuate the displacement in case the material responds to the charge type (i.e., magnetic or electrical respectively).

An example is shown in FIGS. 9A and 9B. In FIG. 9A, particulate material flows from one side of the opening 915 (e.g., from 914) to the other side (e.g., to 912), for example (e.g., due to pressure variation). In FIG. 9A, there is no attracting force (e.g., at position 913) that attracts the particulate material away from the exit opening 915, and the particulate material flows downwards though the exit opening 915. In FIG. 9B, particulate material flows from one side of the opening 925 (e.g., from 924) to the other side (e.g., to 922), wherein there is an attracting force (e.g., at position 923) that attracts the particulate material away from the exit opening 925, and therefore (e.g., substantially) no particulate material flows though the exit opening.

The reservoir of the material dispensing mechanism may comprise a single compartment or a plurality of compartments. At least two of the multiplicity of compartments may have identical or different vertical cross sections, horizontal cross sections, surface areas, and/or volumes. At least two of the walls of the compartments may comprise identical or different materials. At least two of the multiplicity of compartments may be connected such that gas may travel (flow) from one compartment to another (termed herein “flowably connected”). The multiplicity of compartments may be connected such that material that was picked up by the gas (e.g., airborne particulate material) may travel (flow) from one compartment to another. FIG. 9B shows examples of a material dispensing mechanism having three compartments (e.g., of substantially identical cross sections) that are flowably connected as illustrated by the gas flow 922, 923 and 924 within the internal cavity of the material dispensing mechanism. The material dispensing mechanism may comprise a gas entrance port, gas exit port, material entrance port, or a material exit port. In some examples, the material dispensing mechanism may comprise at least two material exits. The gas entrance and the material entrance ports may be the same or different entrance port(s). The gas exit and the material exit ports may be the same or different ports. The material dispensing mechanism may have an exit opening port trough which material exits (e.g., FIG. 9A, 915; or FIG. 9B, 925). In some examples, a material exit opening port faces the target surface, platform, and/or bottom of the enclosure. In some examples, an exit opening port resides at the bottom of the material dispensing system. The exit opening port may comprise an obstacle. For example, the exit opening port may comprise a mesh, slit, hole, slanted baffle, shingle, ramp, slanted plane, or any combination thereof. The mesh may have any mesh values disclosed herein. In some examples, the mesh can comprise hole sizes of at least about 5 μm, 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm. The mesh can comprise hole sizes of at most about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, or 1000 μm. The mesh can comprise hole sizes between any of the hole sizes disclosed herein (e.g., from about 5 μm to about 1000 μm, from about 5 μm to about 500 μm, from about 400 μm to about 1000 μm, or from about 200 μm to about 800 μm).

The reservoir in which the bottom opening is situated can be symmetrical (e.g., FIG. 10A having a C₂ vertical symmetry axis and a vertical mirror axis), or unsymmetrical (e.g., FIG. 10D) in at least one plane. The direction of the gas flow can coincide with the direction of lateral movement of the material dispensing and/or removal system, not coincide, or flow opposite thereto. The particulate material can be supplied from a reservoir. The supply of the particulate material can be from the top of the material dispensing mechanism, from its bottom, or from its side. The particulate material can be elevated by an elevation mechanism into the reservoir or out of the reservoir. The elevation mechanism can comprise an escalator, elevator, conveyor, lift, ram, plunger, auger screw, or Archimedes screw. For example, the elevation mechanism can comprise a conveyor or an elevator. The elevation mechanism can comprise a mechanical lift. The elevation mechanism can comprise a transportation system that is assisted by gas (e.g., pressurized gas), gravity, electricity, heat (e.g., steam), and/or gravity (e.g., weights). Any conveyor and/or surface described herein may comprise a smooth (e.g., flat) surface or a coarse surface. The conveyor may comprise ledges, protrusions, or depressions. The protrusions or depressions may trap material to be conveyed to the reservoir or from the reservoir.

Any of the material dispensing mechanisms described herein can be configured to deliver the particulate material from the reservoir to the material bed and/or to a surface (e.g., source surface, target surface, and/or intermediate surface). Material in the reservoir can be preheated, cooled, be (e.g., maintained) at an ambient or a predetermined temperature.

The gas (e.g., in the material dispensing system, in the CPOD, or in the enclosure) may travel (e.g., flow) at a velocity. The velocity may be variable or constant. The velocity may be varied. The velocity may be at least about 0.001 Mach, 0.03 Mach, 0.005 Mach, 0.007 Mach, 0.01 Mach, 0.03 Mach, 0.05 Mach, 0.07 Mach, 0.1 Mach, 0.3 Mach, 0.5 Mach, 0.7 Mach, 1 Mach, 2 Mach, 3 Mach, 4 Mach, 5 Mach, 6 Mach, 7 Mach, 8 Mach, 9 Mach, 10 Mach, 15 Mach, 20 Mach, 25 Mach, or 30 Mach. The velocity may be at most about at most about 30 Mach, 25 Mach, 20 Mach, 15 Mach, 10 Mach, 9 Mach, 8 Mach, 7 Mach, 6 Mach, 5 Mach, 4 Mach, 3 Mach, 2 Mach, 1 Mach, 0.7 Mach, 0.5 Mach, 0.3 Mach, 0.1 Mach, 0.07 Mach, 0.05 Mach, 0.03 Mach, 0.01 Mach, 0.007 Mach, 0.005 Mach, 0.003 Mach, or 0.001 Mach. The velocity may be between any of the aforementioned velocity values (e.g., from about 1 Mach to about 30 Mach, from 1 Mach to 8 Mach, or from 7 Mach to 30 Mach, from about 0.01 Mach to about 0.7 Mach, from about 0.005 Mach to about 0.01 Mach, from about 0.05 Mach to about 0.9 Mach, from about 0.007 Mach to about 0.5 Mach, or from about 0.001 Mach to about 1 Mach).

The controller may control the gas velocity. For example, the controller may control type of gas that travels within the material dispensing mechanism, material removal mechanism, CPOD, and/or enclosure. The controller may control the amount of particulate material released by the material dispensing mechanism and/or by the source surface (e.g., by controlling the material releasing electrode(s) and/or the CPOD). The controller may control the position at which the particulate material is deposited on the surface (e.g., target surface intermediate surface, and/or source surface). The controller may control the FLS (e.g., cross section) of the flux of particulate material (e.g., FIG. 8, 805) that is deposited on the (e.g., target) surface. The controller may control the rate of particulate material deposition on the surface. The controller may control the vertical height position of the material dispensing system, material removal system, intermediate surface, source surface, target surface, material bed, material releasing electrode(s), and/or CPOD. The controller may control the any of the gaps disclosed herein. The control of the gap may comprise the FLS of the gap. The control of the gap may comprise control of the vertical height of the gap, and/or the atmospheric content of the gap. The controller may control the movement (e.g., rotation) of the surface. For example, the controller may control the velocity and direction of the rotation. The controller may control the angle (FIG. 11, theta “θ”) of that slanted plane. The controller may control the rate of vibration of the vibrators that are part of the material dispensing system (e.g., FIG. 11, 1106). For example, the controller may control the rate of vibration of the particulate material in the reservoir within the material dispensing system.

A layer dispensing mechanism can dispense the particulate material, level, distribute, spread, and/or remove the (e.g., particulate) material in a material bed. In some embodiments, the layer dispensing mechanism comprises a material dispensing mechanism, material removal mechanism, source surface, intermediate surface, energy source, gas, CPOD, or material releasing electrode. The layer dispensing mechanism may be the material adding mechanism.

The layer dispensing mechanism may be heated or cooled. At least one component within the layer dispensing mechanism may be heated or cooled. At least one component within the layer dispensing mechanism that contacts the particulate material may be heated or cooled. The particulate material (e.g., in the reservoir), source surface, intermediate surface, gas, CPOD, and/or material releasing electrode may be heated or cooled.

The layer dispensing mechanism or any of its components may be exchangeable, removable, non-removable, or non-exchangeable. The material dispensing mechanism, material removal mechanism, source surface, intermediate surface, energy source, enclosure, CPOD, or material releasing electrode(s), and/or any of their components, may be exchangeable, removable, non-removable, or non-exchangeable. The layer dispensing mechanism may comprise exchangeable parts. The layer dispensing mechanism may distribute material across the target surface. The layer dispensing mechanism can provide particulate material (e.g., substantially) uniformity across the target surface such that portions of the target surface that comprise the dispensed particulate material, which are separated from one another by at least about 1 mm, 2 mm, 3 mm, 4 mm, 5 mm, or 10 mm, have a height deviation of at least about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80 μm, 70 μm, 60 μm, 50 μm, 40 μm, 30 μm, 20 μm, or 10 μm; of at most about 10 mm, 9 mm, 8 mm, 7 mm, 6 mm, 5 mm, 4 mm, 3 mm, 2 mm, 1 mm, 500 μm, 400 μm, 300 μm, 200 μm, 100 μm, 90 μm, 80, 70 μm, 60 μm, 50 μm, 40 μm, 30 μm, 20 μm, or 10 μm; or of any value between the afore mentioned height deviation values. For example, the layer dispensing mechanism can provide particulate material uniformity across the target surface (e.g., material bed) such that portions of the target surface that comprise the dispensed particulate material, which are separated from one another by a distance of from about 1 mm to about 10 mm, have a height deviation from about 10 mm to about 10 μm. The layer dispensing mechanism may achieve a deviation from a (e.g., substantial) planar uniformity in at least one plane (e.g., horizontal plane) of at most about 20%, 10%, 5%, 2%, 1% or 0.5%, as compared to the average plane (e.g., horizontal plane) created at the target surface (e.g., top of a material bed).

A controller may be operatively coupled to the layer dispensing mechanism and control (e.g., direct and/or regulate) the layer dispensing mechanism. The controller may control the rate of lateral movement of the layer dispensing mechanism. The controller may control the revolution rate of a surface (e.g., intermediate or source) that is included in the layer dispensing mechanism. The controller may control the rotational direction of the surface (e.g., cylinder). The controller may control the temperature of the: particulate material, reservoir, the surface (e.g., intermediate, source and/or target), gas, enclosure, material bed, energy source, the electrode, CPOD, or any combination thereof. The controller may control the trajectory, velocity, and/or acceleration of the particulate material that travels from the source surface to the target surface. The controller may control the imaging performed. The imaging may be performed with the assistance (e.g., by) the CPOD. The controller may control the pattern formed by the energy source on the source (e.g., photoconductive) surface. The controller may control the pattern formed by the particulate material on the source surface. The controller may control the degree of deformation of the particulate material at, or prior to reaching, the target surface. The CPOD may comprise one or more electrodes. The controller may control the charge of the: particulate material, surface, item interior (e.g., core), electrode (e.g., material removing electrode, and/or CPOD), or any combination thereof.

The movement of the layer dispensing mechanism or any of its components may be predetermined. The movement of the layer dispensing mechanism or any of its components may be according to an algorithm.

The mechanism (e.g., material dispensing mechanism, material removal mechanism, charging mechanism), surface (e.g., intermediate, source, or target), the electrode (e.g., CPOD, material removal electrode), platform (e.g., substrate and/or base), material bed, enclosure, energy source, energy beam, or any combination thereof, may be movable (e.g., horizontal, vertical, or at an angle). The movement may be controlled. The control may be manual or automatic. The control may be programmed or be effectuated a whim. The control may be according to an algorithm. The algorithm may comprise a 3D printing algorithm, or motion control algorithm.

The layer dispensing mechanism or any of its components may travel in a horizontal direction from one side of the enclosure (e.g., material bed) to its other side. The mechanism, surface, electrode, energy source, energy beam, obstruction (e.g., blade, a plank, or a rod), or any combination thereof, may travel in a horizontal direction from one side of the enclosure (e.g., the material bed) to its other side. The vertical, horizontal, and/or angular position of the mechanism, surface, electrode, energy source, energy beam, obstruction (e.g., blade, a plank, or a rod), or any combination thereof, may be adjustable.

The ultrasonic CPOD can assist in dispensing (e.g., may dispense) the particulate material onto a target surface. The electrodes within the CPOD, rate of movement (e.g., lateral movement) of the CPOD, rate (e.g., velocity) of movement of the source surface (e.g., rate of rotation, lateral movement), or any combination thereof, can be chosen such that particulate material is delivered to the surface at a predetermined rate and/or position. The CPOD can assist in dispensing the particulate material to a point on the target surface from a location above the target surface. The CPOD can assist in dispensing the material onto the surface from a location that is at a higher height relative to the target surface (e.g., the top of the enclosure). The CPOD can assist in dispensing the particulate material onto the surface in a downward or sideward direction. The CPOD can assist in dispensing the material onto the surface in a downward direction. The particulate material may be dispensed using gravitational force at least in part. The CPOD can assist in dispensing the particulate material from a position above a specific position on the target surface.

The CPOD can assist the acceleration of (e.g., can accelerate) the particulate material onto the target surface. The acceleration of the particulate material can cause the particulate material to (e.g., entirely) transform (e.g., from a solid state to a liquid state) during its travel to the target surface. The acceleration of the particulate material can cause it to transform before it contacts the target surface. The acceleration of the particulate material can cause it to transform at target surface. The acceleration of the particulate material can cause it to transform after reaching the target surface. The particulate material can be heated, before, during, and/or after it transports from the source surface to the target surface.

The material dispensing mechanism can be an ultrasonic material dispensing mechanism. For example, the material dispensing mechanism can be a vibratory material dispensing mechanism. The material dispensing mechanism may comprise a vibrator or a shaker. The mechanism configured to deliver the particulate material to the surface (e.g., source surface) can comprise a vibrating mesh. The vibration may be formed by an ultrasonic transducer, a piezo-electric device, a rotating motor (e.g., having an eccentric cam), or any combination thereof. The ultrasonic and/or vibratory material dispensing mechanism can dispense particulate material in two or three dimensions. The frequency of an ultrasonic and/or vibratory disturbance of the material dispenser can be chosen such that material is delivered to the surface at a predetermined rate. The ultrasonic and/or vibratory dispenser can dispense particulate material onto a point on the surface from a location above the surface. The ultrasonic and/or vibratory dispenser can dispense particulate material onto the surface from a location that is at a relatively higher height relative to the target surface (e.g., from the top of the enclosure). The ultrasonic and/or vibratory dispenser can dispense particulate material onto the surface in a downward and/or sideward direction. The ultrasonic and/or vibratory dispenser can dispense material onto the surface in a downward direction. The material may be dispensed using gravitational force at least in part. The ultrasonic and/or vibratory dispenser can be a top-dispenser that dispenses the particulate material from a position above a specific position on the surface. The vibrator may comprise a spring. The vibrator may be an electric or hydraulic vibrator.

The material dispenser can comprise a vibrator. The vibrator can be located within the material dispenser reservoir, and/or outside of the material dispenser reservoir. The vibrator may be a vibrating rod. FIG. 11 shows an example for a material dispenser 1110 comprising a vibrator 1106 that is located outside of the material dispenser reservoir (e.g., comprising the particulate material 1108). The material dispenser can comprise two or more vibrators (e.g., an array of vibrators). The array of vibrators can be arranged linearly, non-linearly, or at random. The array of vibrators can be arranged along the opening of the material dispenser, and/or in proximity thereto. The material dispenser can comprise multiple opening ports. The array of vibrators can be situated along the array of opening ports (e.g., the multiple openings) and/or in proximity thereto. The vibrators can be arranged along a line. The vibrators can be arranged along a linear pattern. The vibrators can be arranged along a non-linear pattern. The arrangement of the vibrators can determine the rate at which the particulate material exits the material dispensing mechanism. The vibrator(s) may reside on a face of the material dispensing mechanism. The vibrator may reside next to an exit opening (e.g., port). The material dispensing mechanism can comprise a mesh that is connected to a vibrator. The material dispensing mechanism comprises a mesh that is capable of vibrating. The vibrator(s) can vibrate at least part of the particulate material within the material dispensing mechanism (e.g., within the reservoir, FIG. 11, 1108). The vibrators(s) can vibrate at least a part of the body of the material dispensing mechanism. The body of the material dispensing mechanism (e.g., the reservoir body) may comprise a light material such as a light elemental metal (e.g., aluminum) or metal alloy. The vibrators can be controlled manually or automatically (e.g., by a controller). The vibrator frequency may be at least about 20 Hertz (Hz), 30 Hz, 40 Hz, 50 Hz, 60 Hz, 70 Hz, 80 Hz, 90 Hz, 100 Hz, 110 Hz, 120 Hz, 130 Hz, 140 Hz, 150 Hz, 160 Hz, 170 Hz, 180 Hz, 190 Hz, 200 Hz, 210 Hz, 220 Hz, 230 Hz, 240 Hz, 250 Hz, 260 Hz, 270 Hz, 280 Hz, 290 Hz, 300 Hz, 350 Hz, 400 Hz, 450 Hz, 500 Hz, 550 Hz, 600 Hz, 700 Hz, 800 Hz, 900 Hz, or 1000 Hz. The vibrator frequency may be at most about 20 Hertz (Hz), 30 Hz, 40 Hz, 50 Hz, 60 Hz, 70 Hz, 80 Hz, 90 Hz, 100 Hz, 110 Hz, 120 Hz, 130 Hz, 140 Hz, 150 Hz, 160 Hz, 170 Hz, 180 Hz, 190 Hz, 200 Hz, 210 Hz, 220 Hz, 230 Hz, 240 Hz, 250 Hz, 260 Hz, 270 Hz, 280 Hz, 290 Hz, 300 Hz, 350 Hz, 400 Hz, 450 Hz, 500 Hz, 550 Hz, 600 Hz, 700 Hz, 800 Hz, 900 Hz, or 1000 Hz. The vibrator frequency may be any number between the afore-mentioned vibrator frequencies (e.g., from about 20 Hz to about 1000 Hz, from about 20 Hz, to about 400 Hz, from about 300 Hz to about 700 Hz, or from about 600 Hz to about 1000 Hz). At least two of the vibrators in the array of vibrators can vibrate in the same or in different frequencies. The vibrator can have a vibration amplitude of at least about 1 times the gravitational force (G), 2 times G, 3 times G, 4 times G, 5 times G, 6 times G, 7 times G, 8 times G, 9 times G, 10 times G, 11 times G, 15 times G, 17 times G, 19 times G, 20 times G, 30 times G, 40 times G, or 50 times G. The vibrator can have a vibration amplitude of at most about 1 times the gravitational force (G), 2 times G, 3 times G, 4 times G, 5 times G, 6 times G, 7 times G, 8 times G, 9 times G, 10 times G, 11 times G, 15 times G, 17 times G, 19 times G, 20 times G, 30 times G, 40 times G, or 50 times G. The vibrator can vibrate at amplitude having any value between the afore-mentioned vibration amplitude values (e.g., from about 1 times G to about 50 times G, from about 1 times G to about 30 times G, from about 19 times G to about 50 times G, or from about 7 times G to about 11 times G).

The systems and/or apparatuses disclosed herein may comprise one or more motors. The motors may comprise servomotors. The servomotors may comprise actuated linear lead screw drive motors. The motors may comprise belt drive motors. The motors may comprise rotary encoders. The apparatuses and/or systems may comprise switches. The switches may comprise homing or limit switches. The motors may comprise actuators. The motors may comprise linear actuators. The motors may comprise belt driven actuators (e.g., FIG. 14, 1440). The motors may comprise lead screw driven actuators. The actuators may comprise linear actuators. The actuator may be a vertical actuator (e.g., to drive an elevation mechanism, such as shown in an example of FIGS. 1, 117 and 105).

In some cases, the mechanism configured to deliver the material from the reservoir to the target surface (i.e., material dispensing mechanism) can comprise a screw, an elevator, or a conveyor. The screw can be a rotary screw in a vessel. When the screw is rotated, particulate material can be dispensed from the screw though an exit opening (e.g., exit port). The screw can dispense particulate material in an upward, lateral, or downward direction (e.g., relative to the target surface). The screw can be an auger or Archimedean screw. For example, the screw can be an Archimedes screw. For example, the screw can be an auger screw. The spacing and size of the screw thread can be chosen such that a predetermined amount of particulate material is dispensed on to the substrate with each turn or partial turn of the screw. The turn rate of the screw can be chosen such that particulate material is dispensed from the material dispensing mechanism at a predetermined rate. In some cases, particulate material dispensed by the screw can be spread on at least a fraction of the target surface by a rotary screw, linear motion of a spreading tool, and/or one or more baffles.

The material dispensing mechanism may be shaped as an inverted cone, a funnel, an inverted pyramid, a cylinder, any irregular shape, or any combination thereof. Examples of funnel dispensers are depicted in FIGS. 10A-D, showing side cross sections of material dispensing mechanisms. The bottom opening of the material dispensing mechanism (e.g., FIG. 10A, 1034) may be completely blocked by a vertically movable plane (e.g., 1005) above which particulate material is disposed (e.g., 1004). The plane can be situated directly at the opening, or at a vertical distance “d” from the opening. The movement (e.g., 1002) of the vertically movable plane may be controlled. When the plane is translated vertically upwards (e.g., away from the target surface (e.g., 1010)), side openings are formed between the plane and the edges of the material dispenser, out of which material can slide though the funnel opening (e.g., 1007). The material dispensing mechanism may comprise at least one mesh that may ensure homogenous (e.g., even) distribution of the material on to the target surface. The mesh can be situated at the bottom opening of the material dispenser (e.g., 1034) or at any position between the bottom opening and the position at which the plane completely blocks the material dispenser (e.g., at any position within the distance “d” in FIG. 10A).

The material dispensing mechanism can be a double mesh dispenser (e.g., FIG. 10C). The double mesh dispenser may be shaped as an inverted cone, a funnel, an inverted pyramid, a cylinder, any irregular shape, or any combination thereof. Examples of funnel dispensers are depicted in FIGS. 10A-D, showing cross-sections of a material dispenser. The bottom of the double mesh dispenser can comprise an opening (e.g., 1035). The opening may comprise of two meshes (e.g., 1023) of which at least one is movable (e.g., horizontally). The two meshes are (e.g., horizontally) aligned such that the opening of one mesh can be completely blocked by the second mesh. A movement (e.g., horizontal movement, 1020) of the at least one movable mesh may misalign the two meshes and form openings that allow flow of particulate material from the reservoir above the two meshes (e.g., 1019) down towards the direction of the target surface (e.g., 1025). The degree of misalignment of the meshes can alter the size and/or shape of the openings though which the material can exit the material dispensing mechanism. The openings (e.g., mesh holes) can have a FLS of at least about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. The openings can have a FLS of at most about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. The openings can have a FLS between any of the aforementioned values (e.g., from about 0.001 mm to about 10 mm, or from 0.1 mm to about 5 mm).

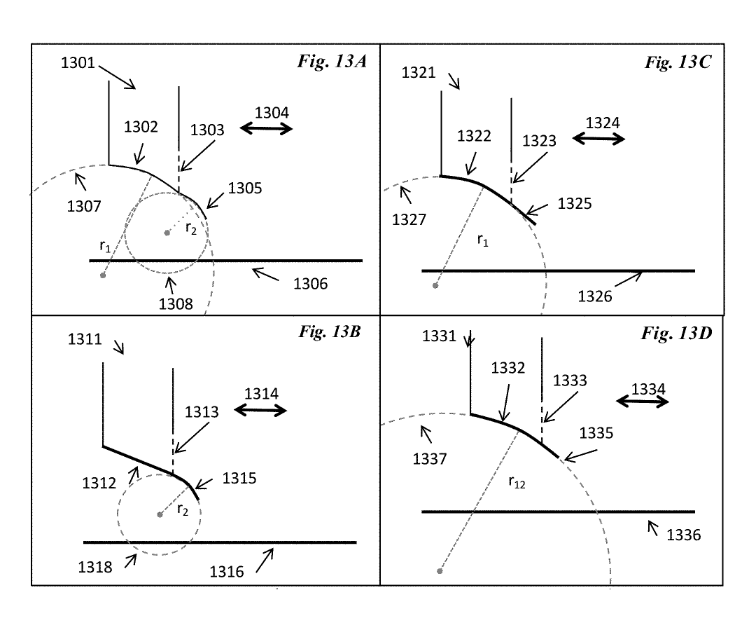

The material dispensing mechanism may comprise an exit opening port that resides within a face of the material dispensing mechanism. The face may be the bottom of the material dispenser, which faces the target surface. FIG. 10C shows an example of a material dispensing mechanism having a bottom facing exit opening port 1035. The face in which the exit opening port resides may be different than the bottom face of the material dispensing mechanism. For example, the face may be a side of the material dispensing mechanism. The face may be a face that is not parallel to the layer of particulate material. The face may be substantially perpendicular to the average plane formed by the top surface of the material bed. FIG. 11 shows an example of a material dispensing mechanism having a side exit opening port 1105 that is (e.g., substantially) perpendicular to the target surface 1101. The face may be (e.g., substantially) perpendicular to the average plane of the target surface, the substrate, and/or the base. The face may be situated at the top face of the material dispensing mechanism. The top face of the material dispensing mechanism may be the face that faces away from the target surface, platform, and/or bottom of the enclosure. The top face of the material dispensing mechanism may be the face that faces away from the exposed surface of the material bed. The face may be a side face. The side face may be a face that is not the bottom or the top face (e.g., FIG. 14A, 1303). A plane in the face (e.g., the entire face) may lean towards the target surface, material bed, platform, and/or bottom of the container. Leaning may be forming an (e.g., acute) angle with the target surface, material bed, platform, and/or bottom of the container. Leaning may comprise a plane that is curved. The curvature may be towards the target surface, platform, bottom of the enclosure, and/or towards the material bed. The curved surface may have a radius of curvature centering at a point below or above the bottom of the material dispenser (e.g., FIG. 13D, 1332).

The material dispensing mechanism may comprise a bottom having at least one (e.g., external) slanted bottom surface (e.g., FIG. 14, 1439, or FIG. 10D, 1037). In some instances, one edge (side) of the surface at the bottom of the material dispensing mechanism lies vertically above another edge of that surface. The surface may be convex or concave. The angle of the first slanted bottom surface may be adjustable or non-adjustable. The first slanted bottom surface may face the bottom of the enclosure, the substrate or the base. The bottom of the material dispensing mechanism may be a slanted surface.

The bottom of the material dispensing mechanism may comprise one or more additional surfaces. The one or more additional surfaces may be adjacent to the bottom of the material dispensing mechanism. The one or more additional surfaces may be connected to the bottom of the material dispensing mechanism (e.g., FIG. 13C, 1325). The one or more additional surfaces may be disconnected from the material dispensing mechanism (e.g., FIG. 11, 1103). The one or more additional surfaces may be extensions of the bottom face of the material dispenser. The one or more additional surfaces may be slanted. The angle of the one or more additional surfaces may be adjustable or non-adjustable (e.g., before, during, and/or after the 3D printing). The one or more additional surfaces that are slanted may form an acute angle (theta “θ,” FIG. 11, 1103) in a second direction with a surface parallel to the average top surface of the material bed. The direction (first and/or second) may be clockwise or anti-clockwise direction. The direction may be positive or negative direction. The first direction may be the same as the second direction. The first direction may be opposite to the second direction. For example, the first and second direction may be clockwise. The first and second direction may be anti-clockwise. The first direction may be clockwise and the second direction may be anti-clockwise. The first direction may be anti-clockwise and the second direction may be clockwise. The first and second direction may be viewed from the same position. At least part of the one or more additional surfaces may be situated at a vertical position that is different than the bottom of the first slanted bottom surface. At least part of the one or more additional surfaces may be situated at a vertical position that is higher than the bottom of the first slanted bottom surface. At least part of the one or more additional surfaces may be situated at a vertical position that is lower than the bottom of the first slanted bottom surface. The lower most position of the one or more additional surfaces may be situated at a vertical position that is higher or lower than the lower most position of the first slanted bottom surface. The upper most position of the one or more additional surfaces may be situated at a vertical position that is higher or lower than the upper most position of the first slanted bottom surface. FIG. 11 shows an example of a material dispensing mechanism 1110 having a slanted bottom surface 1107. The material dispensing mechanism comprises an additional slanted surface 1103 forming an angle theta with an imaginary plane 1102 parallel to the target surface 1101. Theta may be at least about 5°, 10°, 15°, 20°, 30°, 40°, 50°, 60°, 70°, or 80°. Theta may be at most about 5°, 10°, 15°, 20°, 30°, 40°, 50°, 60°, 70°, or 80°. Theta may be of any value between the afore-mentioned degree values for gamma and/or delta (e.g., from about 5° to about, 80°, from about 5° to about, 40°, or from about 40° to about, 80°). The slanted surface may be horizontally and/or vertically separated from the material exit opening (e.g., port) by a gap. The gap may be adjustable. The angle of the slanted surface may be adjustable. The one or more additional surface may comprise a conveyor (E.g., FIG. 14D, 1440). The conveyor can move in the (e.g., lateral) direction of movement of the material dispenser, or in a direction opposite to the direction of movement of the material dispenser.

A top surface of a slanted surface may be flat or rough. The top surface of the slanted surface may comprise extrusions or depressions. The depressions or extrusions may be random or follow a pattern. The top surface of the slanted surface may be blasted (e.g., by any blasting method disclosed herein). The top surface of the slanted surface may be formed by sanding with a sand paper. The sand paper may be of at most about 24 grit, 30 grit, 36 grit, 40 grit, 50 grit, 60 grit, 70 grit, 80 grit, 90 grit, 100 grit, 120 grit, 140 grit, 150 grit, 160 grit, 180 grit, 200 grit, 220 grit, 240 grit, 300 grit, 360 grit, 400 grit, 600 grit, 800 grit, or 1000 grit. The sand paper may be of at least 24 grit, 30 grit, 36 grit, 40 grit, 50 grit, 60 grit, 70 grit, 80 grit, 90 grit, 100 grit, 120 grit, 140 grit, 150 grit, 160 grit, 180 grit, 200 grit, 220 grit, 240 grit, 300 grit, 360 grit, 400 grit, 600 grit, 800 grit, or 1000 grit. The sand paper may be a sand paper between any of the afore-mentioned grit values (e.g., from about 60 grit to about 400 grit, from about 20 grit to about 300 grit, from about 100 grit to about 600 grit, or from about 20 grit to about 1000 grit). The roughness of the top surface of the slanted surface may be equivalent to the roughness of the sand paper mentioned herein. The roughness of the top surface of the slanted surface may be equivalent to a roughness of a treatment with the sand paper mentioned herein. The slanted surface (e.g., 1103) and the body of the material dispenser (e.g., the reservoir 1110) may be of the same type of material or of different types of materials.

A slanted surface may comprise a rougher, heavier, denser, and/or harder (e.g., less bendable) material than one substantially composing the body of the material dispensing mechanism. For example, the body of the material dispensing mechanism may be made of a light metal (e.g., aluminum), while the slanted surface may be made of steel and/or a steel alloy. The slanted surface may be mounted, while the body of the material dispenser may vibrate or bend. The particulate material that exits out of the exit opening (e.g., port) of the material dispenser reservoir (e.g., FIG. 11, 1108) may travel downwards using the gravitational force (e.g., 1104). The exiting particulate material may contact the slanted surface (e.g., 1103) during its fall, bounce off the slanted surface (e.g., 1103), and continue its downward fall (e.g., 1112) to the target surface (e.g., 1101). In some embodiments, as the particulate material exits the material dispensing mechanism to the environment of the enclosure (e.g., chamber) and travels in the vertical direction towards the target surface (e.g., travels down towards the target surface), it encounters at least one obstruction. The obstruction can be a surface. The surface can be stationary or moving (e.g., a conveyor). The surface can be rough or smooth. The obstruction may comprise a rough surface. The obstruction can be a slanted surface (e.g., that forms an angle with the exposed surface of the material bed). The angle can be any of the theta angles described herein.

The material dispensing mechanism may comprise a bottom having a vertical cross section forming a first curved bottom plane. The first curved bottom plane may have a radius of curvature that is situated below the bottom of the material dispensing mechanism (e.g., in the direction of the substrate). The first curved bottom plane may have a radius of curvature that is situated above the bottom of the material dispensing mechanism (e.g., in the direction away from the substrate). The radius of curvature of the first curved bottom plane may be adjustable or non-adjustable. FIG. 13A and FIG. 13C show examples of vertical cross sections of material dispensing mechanisms 1301 and 1321, respectively, having curved bottom planes 1302 and 1322 respectively. The bottom of the material dispensing mechanism may comprise one or more additional planes. The one or more additional planes may be adjacent to the bottom of the material dispensing mechanism. The one or more additional planes may be connected to the bottom of the material dispensing mechanism. The one or more additional planes may be disconnected from the material dispensing mechanism. The one or more additional planes may be extensions of the bottom face of the material dispensing mechanism (e.g., FIG. 13C, 1325). The one or more additional planes may be curved (e.g., FIG. 13B, 1315). The radius of curvature of the one or more additional planes may be adjustable or non-adjustable (e.g., before, during, and/or after the 3D printing). The vertical cross section of the one or more additional curved planes may have a radius of curvature that is situated below the one or more additional curved planes (e.g., towards the direction of the substrate). The vertical cross section of the one or more additional curved planes may have a radius of curvature that is situated above the one or more additional curved planes (e.g., towards the direction away from the substrate). The radius of curvature of the one or more additional curved planes may be the same or different than the radius of curvature of the first curved bottom plane. The radius of curvature of the one or more additional curved planes may be smaller or larger than the radius of curvature of the first curved bottom plane. FIG. 13A shows an examples of a material dispensing mechanism 1301 with curved bottom plane 1302 having a radius of curvature r₁, and an additional curved plane 1305 that is directly connected to the curved bottom plane 1302, and has a radius of curvature r₂, wherein r₂ is smaller than r₁, and both respective curve centers are situated below the bottom of the material dispenser and the additional plane, towards the direction of the substrate 1306. The one or more additional curved planes and the first curved bottom plane may be situated on the same curve. FIG. 13D shows an examples of a vertical cross section of a material dispensing mechanism 1331 with curved bottom plane 1332 and having a radius of curvature r₁₂, that extends beyond the position of the exit opening port 1333 of the material dispensing mechanism, and thus forms an “additional curved plane” 1335. In this example, the vertical cross section of the “additional curved plane” and the bottom of the material dispenser are situated on the same circle (e.g., 1337) which center is situated below the bottom of the material dispensing mechanism, in the direction of the substrate 1336. The material dispensing mechanism may have a planar bottom that may or may not be slanted. The material dispenser may have a planar bottom that is parallel to the substrate (or to an average plane formed by the substrate). The material dispensing mechanism may have one or more additional planes that are curved. The radius of curvature of the curved planes (or a vertical cross section thereof) may be situated below the curved plane (e.g., in the direction of the substrate). FIG. 13B shows an example of a vertical cross section of a material dispensing mechanism 1311 with slanted bottom plane 1312 and a curved additional plane 1315. The material dispensing mechanism may have a curved bottom. The material dispenser may have one or more additional planes that are or are not slanted. The material dispenser may have one or more additional planes that are parallel or perpendicular to the platform. The center of the curved planes (or a vertical cross section thereof) may be situated below the curved plane (e.g., towards the direction of the substrate). FIG. 13C shows an examples of a vertical cross section of a material dispenser 1321 with a curved bottom plane 1322 and a slanted additional (extended) plane 1325 that is planar (e.g., not curved). The radius of curvature r₁, r₂ and/or r₁₂ may be at least about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The radius of curvature r₁, r₂ and/or r₁₂ may be at most about 0.5 mm, 1 mm, 2 mm, 3 mm, 4 mm, 5 mm, 6 mm, 7 mm, 8 mm, 9 mm, 10 mm, 20 mm, 30 mm, 40 mm, 50 mm, 60 mm, 70 mm, 80 mm, 90 mm, or 100 mm. The radius of curvature r₁, r₂ and/or r₁₂ may be of any value between the afore-mentioned values (e.g., from 0.5 mm to about 100 mm, from about 0.5 mm to about 50 mm, or from about 50 mm to about 100 mm).

The material dispensing mechanism can comprise a side exit opening and a plurality of additional planes. At least one of the planes may be slanted. At least one of the planes may be a conveyor. The one or more planes can reside at the bottom of the material dispenser. The second plane can be an (e.g., direct) extension of the bottom of the material dispensing mechanism. The second plane can be (e.g., directly) connected or disconnected from the bottom of the material dispensing mechanism.

The opening of the material dispensing mechanism can comprise a mesh or a plane with holes (collectively referred to herein as “mesh”, e.g., FIG. 14A, 1407). The mesh comprises a hole (or an array of holes). The hole (or holes) can allow the particulate material to exit the material dispensing mechanism. The hole in the mesh can have a FLS of at least about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, or 1000 μm. The hole in the mesh can have a FLS of at most about 10 μm, 20 μm, 30 μm, 40 μm, 50 μm, 60 μm, 70 μm, 80 μm, 90 μm, 100 μm, 110 μm, 120 μm, 130 μm, 140 μm, 150 μm, 160 μm, 170 μm, 180 μm, 190 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, or 1000 μm. The hole in the mesh can have a FLS of any value between the afore-mentioned FLSs (e.g., from about 10 μm to about 1000 μm, from about 10 μm to about 600 μm, from about 500 μm to about 1000 μm, or from about 50 μm to about 300 μm). The FLS of the holes may be adjustable or fixed (e.g., before, during, and/or after the 3D printing). In some embodiments, the opening comprises a plurality of meshes. At least one of the plurality of meshes may be movable. The movement of at least one of the plurality meshes may be controlled (e.g., manually or automatically (e.g., by a controller)). The relative position of at least two of the plurality of meshes with respect to each other may determine the rate at which the particulate material passes through the hole(s). The FLS of the holes may be electrically and/or thermally controlled. For example, the mesh may be heated or cooled. The vibrator may vibrate (e.g., controllably vibrate) the mesh. The temperature and/or vibration of the mesh may be controlled (e.g., manually and/or automatically). For example, the holes of the mesh can shrink or expand as a function of the temperature and/or electrical charge of the mesh. The mesh can be conductive. The mesh may comprise a mesh of standard mesh number of at least 50, 70, 90, 100, 120, 140, 170, 200, 230, 270, 325, 550, or 625. The mesh may comprise a mesh of standard mesh number between any of the aforementioned mesh numbers (e.g., from 50 to 625, from 50 to 230, from 230 to 625, or from 100 to 325). The standard mesh number may be US or Tyler standards. At least two of the meshes may have at least one position where no particulate material can pass though the exit opening. At least two of the meshes may have a least one position where a maximum amount of particulate material can pass though the exit opening. At least two of the meshes can be identical or different. The size of at least two of the holes in the two meshes can be identical or different. The shape of the holes in at least two meshes can be identical or different. FIG. 14C shows an example of a material dispenser 1424 having an opening 1427 having two meshes (or two planes with holes). FIG. 14C shows an example where the extension of two meshes 1422 and 1426 can be translated vertically.

The opening (e.g., port) of the material dispensing mechanism can comprise a plane. The plane can be a 3D plane. The plane can be planar. The plane can comprise a blade. The blade can be a “doctor's blade.” FIG. 14B shows an example of a material dispenser 1414 having an opening comprising a plane 1417. The opening may comprise both a blade and one or more meshes (or planes with holes). The mesh(es) (or plane(s) with holes) may be closer to the exit opening than the blade. The blade may be closer to the exit opening than the mesh(es) (or plane(s) with holes). The exit opening can comprise several meshes and blades. The exit opening can comprise a first blade followed by a mesh that is followed by a second blade closest to the surface of the exit opening. The exit opening can comprise a first mesh followed by a blade, which is followed by a second mesh closest to the surface of the exit opening. The first and second blades may be identical or different. The first and second meshes may be identical or different. The exit opening can comprise a first mesh, followed by a second mesh, followed by a blade. The exit opening can comprise a blade followed by a first mesh, followed by a second mesh. The meshes and blades may be arranged in any sequential order. The material dispenser may comprise a spring at the exit opening.

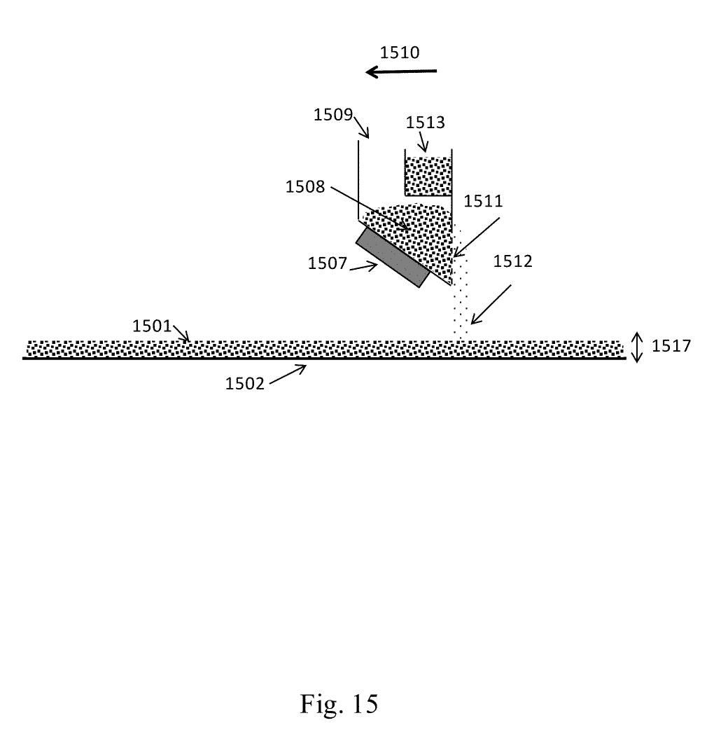

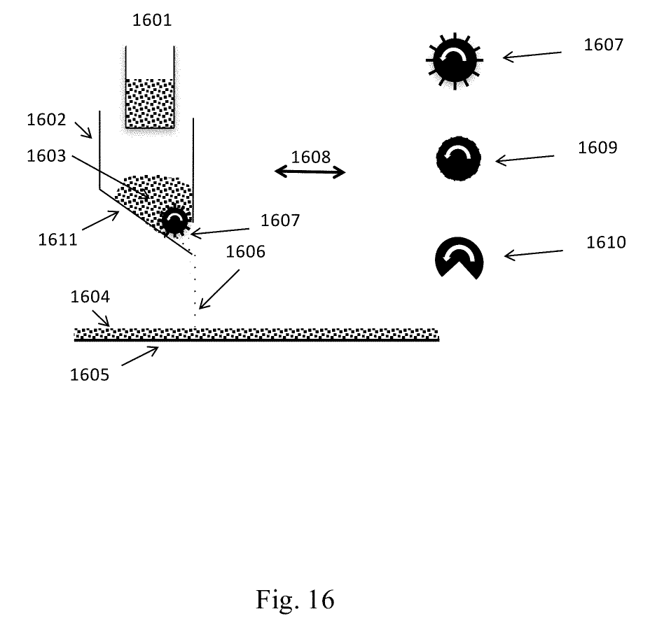

Any of the layer dispensing mechanisms described herein can comprise a bulk reservoir (e.g., a tank, a pool, a tub, or a basin) to that can accommodate the particulate material. The dispensing mechanism can comprise a mechanism configured to deliver the particulate material from the bulk reservoir to the layer dispensing mechanism (e.g., a recoater). The reservoir can be connected or disconnected from the layer dispensing mechanism or any of its components (e.g., from the material dispenser). FIG. 15 shows an example of a bulk reservoir 1513, which is connected to the material dispensing mechanism 1509. FIG. 16 shows an example of a bulk reservoir 1601, which is disconnected from the material dispensing mechanism 1602. The disconnected reservoir can be located above, below, or to the side of the material bed. The disconnected bulk reservoir can be located above the material bed, for example above the particulate material entrance opening to the material dispensing mechanism (e.g., material dispenser). The connected bulk reservoir may be located above, below, or to the side of the material exit opening port of the material dispenser. The connected bulk reservoir may be located above the material exit opening of the material dispenser. Material can be stored in the bulk reservoir. The bulk reservoir may hold at least an amount of particulate material sufficient to form one layer of particulate material in the material bed, a plurality of such layers, or sufficient particulate material to build one or more 3D object in a material bed. The bulk reservoir may hold at least about 200 grams (gr), 400 gr, 500 gr, 600 gr, 800 gr, 1 Kilogram (Kg), or 1.5 Kg of particulate material. The bulk reservoir may hold at most 200 gr, 400 gr, 500 gr, 600 gr, 800 gr, 1 Kg, or 1.5 Kg of particulate material. The bulk reservoir may hold an amount of material between any of the afore-mentioned amounts of bulk reservoir material (e.g., from about 200 gr to about 1.5 Kg, from about 200 gr to about 800 gr, or from about 700 gr to about 1.5 kg).

The reservoir of the material dispensing mechanism (e.g., FIG. 16, 1603) may hold at least an amount of particulate material sufficient for at least one, two, three, four or five layers of particulate material in the material bed. The reservoir of the material dispensing mechanism may hold at least an amount of particulate material sufficient for at most one, two, three, four or five layers. The reservoir of the material dispensing mechanism may hold an amount of particulate material between any of the afore-mentioned amounts of particulate material (e.g., sufficient to a number of layers of particulate material in the material bed from about one layer to about five layers). The reservoir of the material dispensing mechanism may hold at least about 20 grams (gr), 40 gr, 50 gr, 60 gr, 80 gr, 100 gr, 200 gr, 400 gr, 500 gr, or 600 gr of material. The reservoir of the material dispensing mechanism may hold at most about 20 gr, 40 gr, 50 gr, 60 gr, 80 gr, 100 gr, 200 gr, 400 gr, 500 gr, or 600 gr of material. The reservoir of the material dispensing mechanism may hold an amount of material between any of the afore-mentioned amounts (e.g., from about 20 gr to about 600 gr, from about 20 gr to about 300 gr, or from about 200 gr to about 600 gr.). Particulate material may be transferred from the bulk reservoir to the reservoir of the material dispensing mechanism by any analogous method described herein for exiting of material from the material dispenser.

At times, the exit opening ports (e.g., holes) in the bulk reservoir exit opening may have a larger FLS relative to those of the material dispenser exit opening port. For example, the bulk reservoir may comprise an exit comprising a mesh or a surface comprising at least one hole. The mesh (or a surface comprising at least one hole) may comprise a hole with a FLS of at least about 0.25 mm, 0.5 mm. 1 mm, 2 mm, 3 mm, 4 mm, 5 mm, 6 mm, 7 mm, 8 mm, 9 mm, or 1 centimeter. The mesh (or a surface comprising at least one hole) may comprise a hole with a FLS of at most about 0.25 mm, 0.5 mm. 1 mm, 2 mm, 3 mm, 4 mm, 5 mm, 6 mm, 7 mm, 8 mm, 9 mm, or 1 centimeter. The mesh (or a surface comprising at least one hole) may comprise a hole with a FLS of any value between the afore-mentioned values (e.g., from about 0.25 mm to about 1 cm, from about 0.25 mm to about 5 mm, or from about 5 mm to about 1 cm). The hole can be of a shape comprising a rectangle (e.g., cube), ellipsoid (e.g., circle), triangle, pentagon, hexagon, heptagon, octagon, icosahedron, or an irregular shape. The hole can be of a shape comprising a geometric shape (e.g. Euclidian shape). The hole can comprise a curved shape. The hole can comprise a non-curved shape. The bulk reservoir may comprise a plane that may have at least one edge that is translatable into or out of the bulk reservoir. The bulk reservoir may comprise a plane that may pivot into, or out of, the bulk reservoir (e.g., a flap door). Such translation may create an opening, which may allow material in the reservoir to flow out of the reservoir (e.g., using gravity).

A controller may be operatively coupled to the bulk reservoir and/or reservoir of the material dispensing mechanism. The controller may control the amount of material released from the (e.g., bulk) reservoir by controlling, for example, the amount of time the conditions for allowing material to exit the bulk reservoir are in effect. A controller may control the amount of particulate material released from the material dispensing mechanism by controlling, for example, the amount of time the conditions for allowing particulate material to exit the material dispensing mechanism are in effect (e.g., the time the vibrator is on). In some examples, the material dispensing mechanism dispenses of any excess amount of particulate material that is retained within the reservoir of the material dispensing mechanism, prior to the loading of particulate material from the bulk reservoir to the reservoir of the material dispensing mechanism. In some examples, the material dispensing mechanism does not dispense of any excess amount of particulate material that is retained within its reservoir, prior to loading of particulate material from the bulk reservoir to the reservoir of the material dispensing mechanism. Material may be transferred from the bulk reservoir to the reservoir of the material dispensing mechanism using a scooping mechanism. The scooping mechanism may scoop material from the bulk reservoir and transfers it to the material dispensing mechanism. The scooping mechanism may scoop a fixed or predetermined amount of particulate material. The scooped amount may be adjustable. The scooping mechanism may pivot (e.g., rotate) in the direction perpendicular to the scooping direction. The (e.g., bulk) reservoir or any of its parts may be exchangeable, or non-exchangeable. The bulk reservoir or any of its parts may be removable, or non-removable. The bulk reservoir may comprise exchangeable parts. The material dispenser (and/or any of its parts) may be exchangeable, removable, non-removable, or non-exchangeable. The material dispensing mechanism may comprise exchangeable parts.

Material in the bulk reservoir and/or in the material dispensing mechanism (e.g., material dispenser reservoir) can be preheated, cooled, be at an ambient temperature or maintained at a predetermined temperature.

The material dispensing mechanism may dispense the particulate material at an average rate of at least about 1000 cubic millimeters per second (mm³/s), 1500 mm³/s, 2000 mm³/s, 2500 mm³/s, 3000 mm³/s, 3500 mm³/s, 4000 mm³/s, 4500 mm³/s, 5000 mm³/s, 5500 mm³/s, or 6000 mm³/s. The material dispensing mechanism may dispense the particulate material at an average rate of at most about 1000 mm³/s, 1500 mm³/s, 2000 mm³/s, 2500 mm³/s, 3000 mm³/s, 3500 mm³/s, 4000 mm³/s, 4500 mm³/s, 5000 mm³/s, 5500 mm³/s, or 6000 mm³/s. The material dispensing mechanism may dispense the particulate material at an average rate between any of the afore-mentioned average rates (e.g., from about 1000 mm³/s to about 6000 mm³/s, from about 1000 mm³/s to about 3500 mm³/s, or from about 3000 mm³/s to about 6000 mm³/s).

The material dispensing mechanism can comprise a rotating roll. The surface of the roll may be a smooth or rough. Examples of roll surfaces are shown in FIG. 16 and include a rough surface roll 1609, roll with protrusions 1607, and a roll with a depression 1610. The surface of the roll may include depressions and/or protrusions (e.g., FIG. 10B, 1013). The roll may be situated such that at a certain position, the particulate material disposed above the roll (e.g., FIG. 10, 1012 or FIG. 16, 1603) is unable to flow downwards as the roll shuts the opening of the material dispenser. When the roll rotates (either clockwise or counter clockwise), a portion of the particulate material may be trapped within the depressions and/or, and may be transferred from the particulate material occupying side of the material dispenser (e.g., FIG. 10B, 1038), to the material free side of the material dispenser (e.g., that is closer to the exit opening port). Such transfer may allow the particulate material to be expelled out of the exit opening of the material dispensing mechanism (e.g., 1036) towards the target surface (e.g., 1017). A similar mechanism is depicted in FIG. 10D showing an example of a material dispensing mechanism that comprises an internal wall (e.g., 1027). The material transferred by the roll 1031, may be thrown onto another internal wall (e.g., 1037), and may then exit the material dispensing mechanism (e.g., 1030) though its exit opening port.

The material dispensing mechanism can comprise a flow of gas mixed with material particles. The number density of the particles in the gas and the flow rate of the gas can be chosen such that a predetermined amount of particulate material is dispensed from the material dispensing mechanism in a predetermined time period. The gas flow rate can be chosen such that gas blown onto the target surface does not disturb a (e.g., particulate) material layer in the material bed and/or the 3D object. The gas flow rate can be chosen such that gas blown onto the material bed does not disturb at least the position of the 3D object.

The material dispensing mechanism may comprise a tube (e.g., a straight or curved tube). The tube can comprise an opening. The opening can be located at an inflection point of the curved tube shape. The opening can be located on the outside of the curved tube shape. The opening can be on a side of the tube towards the substrate. The opening can be a hole (e.g., pinhole). The pinhole can have a diameter or other maximum length scale of at least about 0.001 mm, 0.01 mm, 0.03 mm, 0.05 mm, 0.07 mm, 0.09 mm, 0.1 mm, 1 mm, 2 mm, 3 mm, 4 mm, 5 mm, or 10 mm. A mixture of gas and material particles can be driven through the curved tube. The material particles can be suspended in the gas. At least a fraction of the material particles can exit the curved tube through the opening. The number density of the particles in the gas and the flow rate of the gas can be selected such that a predetermined amount of particulate material is dispensed on to the target surface in a predetermined time period. The gas flow rate can be chosen such that gas blown onto the substrate does not disturb a material layer on the target surface and/or the 3D object. The distance between the opening and the source surface (e.g., of a roller) can be adjusted such that a predetermined amount of particulate material is dispensed on to the source surface in a predetermined time period. In some cases, the size of the opening can be selected such that particles in a predetermined size range exit the curved tube through the opening and dispensed onto the source surface.

Any of the systems (collectively “the system”), and/or apparatuses (collectively “the apparatus”) may comprise a controller. The controller may control the vibrator(s). For example, the controller may control the operation of the vibrator(s). The controller may control the amplitude of vibrations of the vibrator(s). The controller may control the frequency of vibration of the vibrator(s). When the system comprises more than one vibrator, the controller may control each of them individually, or as a group (e.g., collectively). The controller may control each of the vibrators sequentially. The controller may control the amount of particulate material released by the material dispensing mechanism. The controller may control the velocity of the material released by the material dispensing mechanism. The controller may control the height from which material is released from the material dispensing mechanism. The controller may control the position of the material dispensing mechanism. The controller may control the position of a mechanism. The position may comprise a vertical position, horizontal position, or angular position. The position may comprise coordinates.

The controller may control the operation of the item (e.g., roller or drum) comprising the intermediate and/or source surface. The controller may control the velocity of the item (e.g., lateral, angular and/or rotational velocity). When the controller may control each item (e.g., roller) individually or at least two of the items in concert. The controller may control at least two (e.g., each) of the items sequentially. The controller may control the amount of particulate material dispensed on the intermediate and/or source surface. The controller may control the velocity of the material deposited on the intermediate and/or source surface. The controller may control the height of a layer of material disposed on the intermediate and/or source surface. The controller may control the position of the item(s), intermediate, and/or source surface. The controller may control the position of the scraper (e.g., 3D plane such as a doctor blade). The position may comprise a vertical, horizontal, and/or angular position. The position may comprise coordinates.

The controller may control the path traveled by the material dispensing mechanism, (e.g., the item therein), and/or platform. The controller may control the level (e.g., thickness) of a layer of the particulate material deposited on the intermediate, source, and/or target surface. For example, the controller may control the final height (e.g., average final height) of the newly deposited layer of particulate material.

In another aspect is a method for generating 3D object from a material that comprises leveling a layer of particulate material utilizing one or more apparatuses as described herein. The layer may be disposed adjacent to (e.g., above) the bottom of the enclosure, and/or substrate. The particulate material may be deposited by the layer dispensing mechanism (e.g., material dispenser).

In another aspect is a method for generating at least one 3D object from a particulate material that comprises: dispensing a particulate material towards a bottom of an enclosure (e.g., towards the platform) utilizing at least one apparatus described herein. The particulate material may be dispensed from the material dispenser and/or from the source surface when the material dispenser and/or item comprising the source surface travel in a first direction.

The method may comprise vibrating at least part of the particulate material, and/or at least part of the material dispensing mechanism. The at least part of the material dispensing mechanism may comprise vibrating at least part of the exit opening of the material dispensing mechanism and/or vibrating at least a portion of the particulate material in the reservoir of the material dispensing mechanism. The method may comprise vibrating the particulate material in the material bed to level the top surface of the material bed. The method may comprise vibrating the enclosure, the platform (e.g., substrate, and/or base), the container that accommodates the material bed, or any combination thereof, in order to level the particulate material at the top surface of the material bed. The vibrations may be sonic (e.g., ultrasonic) vibrations. The leveling may be result in a (e.g., substantially) planar top surface of the material bed, having a deviation from the average plane created by the top surface. The deviation from the average plane may be of any deviation from height and/or planar uniformity value disclosed herein. The deviation from the average plane may be of any displacement value disclosed herein.

At least a portion of the 3D object can be vertically displaced (e.g., sink) in the material bed. At least a portion of the 3D object can be surrounded by the remainder of the particulate material within the material bed (e.g., submerged). At least a portion of the 3D object can rest in the material bed without substantial being vertically displaced (e.g., sinking). Lack of substantial vertical displacement can amount to a vertical movement of at most about 40%, 20%, 10%, 5%, or 1% of the layer thickness. Lack of substantial vertical displacement (e.g., sinking) can amount to at most about 100 μm, 30 μm, 10 μm, 3 μm, or 1 μm. At least a portion of the 3D object can rest in the material bed without substantial movement (e.g., horizontal movement, or movement at an angle). Lack of substantial movement can amount to at most 100 μm, 30 μm, 10 μm, 3 μm, or 1 μm. The 3D object can rest on the substrate when the 3D object is sunk or submerged in the fluidized material bed.

The system and/or apparatus components described herein can be adapted and/or configured to generate a 3D object. The 3D object can be generated through a 3D printing process. A first layer of particulate material can be provided adjacent to a platform and/or bottom of an enclosure. The platform may comprise a substrate and/or a base. The base can be a previously formed layer of hardened material or any other surface upon which a layer or bed of particulate material is spread, held, placed, or supported. In the case forming the first layer of the 3D object. the first particulate material layer can be formed the material bed without a base, without one or more auxiliary support features (e.g., rods), or without other supporting structure other than the particulate material (e.g., within the material bed). Subsequent layers can be formed such that at least one portion of a subsequent layer transforms and adheres (e.g., fuses (e.g., melts or sinters), binds, and/or otherwise connects) to the at least a portion of a previously formed layer. In some instances, the at least a portion of the previously formed layer of particulate material that transforms and (e.g., subsequently) hardens into a hardened material, acts as a base for formation of the 3D object. In some cases, the first layer of the 3D object comprises at least a portion of the base. The particulate material layer can comprise particles of homogeneous or heterogeneous size and/or shape.

In some examples, the methods, apparatuses, software, and/or systems disclosed herein exclude compaction of the material (e.g., utilizing a compaction plate).

The methods, systems, software, and/or apparatuses disclosed herein may comprise at least one energy source. In some cases, the system can comprise 1, 2, 3, 4, 5, 6, 7, 8, 9, 10, 30, 100, 300, 1000 or more energy sources. For example, one or more energy sources can be direct energy beam(s) onto the source surface (e.g., photoconductive surface). One or more energy beams can be directed onto the target surface. The system can comprise an array of energy sources. Alternatively or additionally, the source surface, target surface, material bed, 3D object (or part thereof), or any combination thereof may be heated by a heating member comprising a lamp (e.g., a focused lamp), heating rod, or radiator (e.g., a panel radiator). The heating member may comprise an energy beam.

In some cases, the at least one energy source is a single (e.g., first) energy source. An energy source can be a source configured to deliver energy to an area (e.g., a confined area). An energy source can deliver energy to the confined area through radiative heat transfer. The energy beam may include a radiation comprising an electromagnetic, or charge particle beam. The energy beam may include a radiation comprising electromagnetic, electron, positron, proton, plasma, or ionic radiation. The electromagnetic beam may comprise microwave, infrared, ultraviolet, or visible radiation. The energy beam may include an electromagnetic energy beam, electron beam, particle beam, or ion beam. An ion beam may include a cation or an anion. A particle beam may include radicals. The electromagnetic beam may comprise a laser beam. The energy beam may comprise plasma. The energy source may include a laser source. The laser source may comprise a Nd:YAG, Neodynium (e.g., neodymium-glass), or a Ytterbium laser. The laser may comprise a carbon dioxide laser (CO₂ laser). The energy source can provide an energy beam having a power of at least about 100 watt (W), 150 W, 200 W, 250 W, 350 W, 500 W, 550 W, 600 W, 650 W, 700 W, 1000 W, or 1500 W. The energy source can provide an energy beam having a power of at most about 100 W, 150 W, 200 W, 250 W, 350 W, 500 W, 550 W, 600 W, 650 W, 700 W, 1000 W or 1500 W. The energy source can provide an energy beam having a power of any value between the aforementioned values (e.g. from about 100 W to about 1500 W, or from about 200 W to about 500 W). The energy source may include an electron gun. The energy source may include an energy source capable of delivering energy to a point or to an area. In some embodiments the energy source can be a laser. In an example a laser can provide light energy at a peak wavelength of at least about 100 nanometer (nm), 500 nm, 1000 nm, 1010 nm, 1020 nm, 1030 nm, 1040 nm, 1050 nm, 1060 nm, 1070 nm, 1080 nm, 1090 nm, 1100 nm, 1200 nm, 1500 nm, 1600 nm, 1700 nm, 1800 nm, 1900 nm, or 2000 nm. In an example, a laser can provide light energy at a peak wavelength of at most about 2000 nm, 1900 nm, 1800 nm, 1700 nm, 1600 nm, 1500 nm, 1200 nm, 1100 nm, 1090 nm, 1080 nm, 1070 nm, 1060 nm, 1050 nm, 1040 nm, 1030 nm, 1020 nm, 1010 nm, 1000 nm, 500 nm, or 100 nm. The laser can provide light energy at a peak wavelength between any of the afore-mentioned peak wavelength values (e.g., from about 100 nm to about 2000 nm, from about 500 nm to about 1500 nm, or from about 1000 nm to about 1100 nm). The energy source can provide an energy beam having an energy density of at least about 50 joules/cm² (J/cm²), 100 J/cm², 200 J/cm², 300 J/cm², 400 J/cm², 500 J/cm², 600 J/cm², 700 J/cm², 800 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of at most about 50 J/cm², 100 J/cm², 200 J/cm², 300 J/cm², 400 J/cm², 500 J/cm², 600 J/cm², 700 J/cm², 800 J/cm², 1000 J/cm², 500 J/cm², 1000 J/cm², 1500 J/cm², 2000 J/cm², 2500 J/cm², 3000 J/cm², 3500 J/cm², 4000 J/cm², 4500 J/cm², or 5000 J/cm². The energy source can provide an energy beam having an energy density of any value between the aforementioned values (e.g., from about 50 J/cm² to about 5000 J/cm², from about 200 J/cm² to about 1500 J/cm², from about 1500 J/cm² to about 2500 J/cm², from about 100 J/cm² to about 3000 J/cm², or from about 2500 J/cm² to about 5000 J/cm²). The power per unit area of the energy beam may be at least about 100 Watt per millimeter square (W/mm²), 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm2, 7000 W/mm², or 10000 W/mm². The power per unit area of the energy beam may be at most about 110 W/mm², 200 W/mm², 300 W/mm², 400 W/mm², 500 W/mm², 600 W/mm², 700 W/mm², 800 W/mm², 900 W/mm², 1000 W/mm², 2000 W/mm², 3000 W/mm², 5000 W/mm², 7000 W/mm², or 10000 W/mm². The power per unit area of the energy beam may be any value between the aforementioned values (e.g., from about 100 W/mm² to about 3000 W/mm², from about 100 W/mm² to about 5000 W/mm², from about 100 W/mm² to about 10000 W/mm², from about 100 W/mm² to about 500 W/mm², from about 1000 W/mm² to about 3000 W/mm², from about 1000 W/mm² to about 3000 W/mm², or from about 500 W/mm² to about 1000 W/mm²). The energy beam may be continuous or non-continuous (e.g., pulsing). The energy beam may be modulated before and/or during the formation of a transformed material as part of the 3D object. The energy beam may be modulated before and/or during the 3D printing process.

An energy beam generated by the energy source can be incident on, or be directed parallel to (e.g., FIG. 17, 1719) the target surface. An energy beam from the energy source can be directed at an acute angle within a value of from parallel to perpendicular to the target surface (e.g., FIG. 1, 101). The energy beam can be directed onto a specified area of at least a portion of the source surface and/or target surface for a specified time period. A material at target surface (e.g., powder material such as in a top surface of a powder bed) can absorb the energy from the energy beam and, and as a result, a localized region of the material can increase in temperature. The energy beam can be moveable such that it can translate relative to the source surface and/or target surface. The energy source may be movable such that it can translate relative to the target surface. The energy source may be movable such that it can translate relative to the source surface. The energy beam(s) and/or source(s) can be moved via a scanner (e.g., as disclosed herein). At least two of the energy sources can be movable with the same scanner. At least two of the energy beams can be movable with the same scanner. At least two of the energy source(s) and/or beam(s) can translate independently of each other. In some cases, at least two of the energy source(s) and/or beam(s) can be translated at different rates (e.g., velocities). In some cases, at least two of the energy source(s) and/or beam(s) can be comprise at least one different characteristic. The characteristics may comprise wavelength, power, amplitude, trajectory, footprint, intensity, power per unit area, energy, or charge. The charge can be electrical and/or magnetic charge.

The energy source can be an array, or a matrix of energy sources (e.g., laser diodes). Each of the energy sources in the array or matrix can be independently controlled (e.g., by a control mechanism) such that any of the individual diodes can be turned off and on independently. At least two of the energy sources in the array or matrix can be collectively controlled such that the at least two of the energy sources can be turned off and on simultaneously. In some instances, all the energy sources in the array or matrices are collectively controlled (e.g., such that all of the energy sources can be turned off and on simultaneously). The energy per unit area or intensity of at least two energy source in the matrix or array can be modulated independently (e.g., by a control mechanism or system). At times, the energy per unit area or intensity of at least two of the energy sources in the matrix or array can be modulated collectively (e.g., by a control mechanism). At times, the energy per unit area or intensity of all of the energy sources in the matrix or array can be modulated collectively (e.g., by a control mechanism).

The energy source can scan along the source surface and/or target surface by mechanical movement of the energy source(s), one or more adjustable reflective mirrors, or one or more polygon light scanners. The energy source(s) may project energy using a DLP modulator, one-dimensional scanner, two-dimensional scanner, or any combination thereof. The energy source(s) can be stationary. The target, intermediate, and/or source surface can translate vertically, horizontally, or in an angle.

The energy source can be modulated. The energy beam emitted by the energy source can be modulated. The modulator can include amplitude modulator, phase modulator, or polarization modulator. The modulation may alter the intensity of the energy beam. The modulation may alter the current supplied to the energy source (e.g., direct modulation). The modulation may affect the energy beam (e.g., external modulation such as external light modulator). The modulation may include direct modulation (e.g., by a modulator). The modulation may include an external modulator. The modulator can include an aucusto-optic modulator or an electro-optic modulator. The modulator can comprise an absorptive modulator or a refractive modulator. The modulation may alter the absorption coefficient the material that is used to modulate the energy beam. The modulator may alter the refractive index of the material that is used to modulate the energy beam.

At least two of the energy source(s) can be independently or collectively controllable by a control mechanism (e.g., computer). At times, at least two of the energy sources can be controlled independently or collectively by the control mechanism.

The printed of the 3D object (e.g., in its final form) can be retrieved soon after cooling of a hardened material layer. Soon after cooling may be at most about 1 day, 12 hours, 6 hours, 3 hours, 2 hours, 1 hour, 40 min, 30 minutes (min), 15 min, 5 min, 240 sec, 220 sec, 200 sec, 180 sec, 160 sec, 140 sec, 120 sec, 100 sec, 80 sec, 60 sec, 40 sec, 30 sec, 20 sec, 10 sec, 9 sec, 8 sec, 7 sec, 6 sec, 5 sec, 4 sec, 3 sec, 2 sec, or 1 sec. Soon after cooling may be between any of the aforementioned time values (e.g., from about 1 sec to about 1 day, from about 1 sec to about 1 hour, from about 30 min to about 1 day, from about 20 sec to about 240 sec, from about sec to about 12 hours, from about 12 hours to about 30 min, from about 1 sec to about 1 hour, or from about 30 sec to about 40 min). In some cases, the cooling can occur by method comprising active cooling by convection using a cooled gas or gas mixture comprising argon, nitrogen, helium, neon, krypton, xenon, hydrogen, carbon monoxide, carbon dioxide, or oxygen. In some cases, a cooling gas can be directed to the hardened material (e.g., 3D object) for cooling the hardened material during its retrieval. Cooling may be cooling to a temperature that allows a person to handle the 3D object. Cooling may be cooling to a handling temperature.

In some cases, unused material can surround the 3D object in the material bed. The unused material (e.g., remainder) can be substantially removed from the 3D object. Substantial removal may refer to material covering at most about 20%, 15%, 10%, 8%, 6%, 4%, 2%, 1%, 0.5%, or 0.1% of the surface of the 3D object after removal. Substantial removal may refer to removal of all the material that was disposed in the material bed and remained as particulate material at the end of the 3D printing process (i.e., the remainder), except for at most about 10%, 3%, 1%, 0.3%, or 0.1% of the weight of the remainder. Substantial removal may refer to removal of all the remainder except for at most about 50%, 10%, 3%, 1%, 0.3%, or 0.1% of the weight of the printed 3D object. The unused material can be removed to permit retrieval of the 3D object without digging through the material bed. For example, the unused material can be suctioned out of the material bed by one or more vacuum ports (e.g., built adjacent to the material bed), by brushing off the remainder of unused material, by lifting the 3D object from the unused material, by allowing the unused material to flow away from the 3D object (e.g., by opening an exit opening port on the side(s) or on the bottom of the material bed from which the unused material can (e.g., flowingly) exit). After the unused material is evacuated, the 3D object can be removed and the unused material can be re-circulated to a material reservoir for use in future builds (e.g., 3D prints).

The 3D object can be generated on a mesh substrate. A solid platform (e.g., base or substrate) can be disposed underneath the mesh such that the particulate material stays confined in the material bed and the mesh holes are blocked. The blocking of the mesh holes may not allow a substantial amount of particulate material to flow though. The mesh can be moved (e.g., vertically or at an angle) relative to the solid platform by pulling on one or more posts connected to either the mesh or the solid platform (e.g., at the one or more edges of the mesh or of the base) such that the mesh becomes unblocked. The one or more posts can be removable from the one or more edges by a threaded connection. The mesh substrate can be lifted out of the material bed with the 3D object to retrieve the 3D object such that the mesh becomes unblocked. Alternatively or additionally, the building platform can be tilted, horizontally moved such that the mesh becomes unblocked. The building platform can include the base, substrate, or bottom of the enclosure. When the mesh is unblocked, at least part of the unused particulate material flows from the mesh while the 3D object remains on the mesh. The 3D object can be built on a construct comprising a first and a second mesh, such that at a first position the holes of the first mesh are completely obstructed by the solid parts of the second mesh such that no particulate material can flow though the two meshes at the first position, as both mesh holes become blocked. The first mesh, the second mesh, or both can be (E.g., controllably) moved (e.g., horizontally or in an angle) to a second position. At the second position, the holes of the first mesh and the holes of the second mesh are at least partially aligned such that the particulate material disposed in the material bed is able to flow through the holes to a position below the two meshes, leaving the exposed 3D object resting on at least one of the meshes. The mesh can be of a size such that the unused material will sift through the mesh as the 3D object is exposed from the material bed. In some cases, the mesh can be attached to a pulley or other mechanical device such that the mesh can be moved (e.g., lifted) out of the material bed with the 3D part.

In some cases, a layer of the 3D object is formed within at most about 1 hour (h), 30 minutes (min), 20 min, 10 min, 5 min, 1 min, 40 seconds (sec), 20 sec, 10 sec, 9 sec, 8 sec, 7 sec, 6 sec, 5 sec, 4 sec, 3 sec, 2 sec, or 1 sec. A layer of the 3D object can be formed within at least about 30 min, 20 min, 10 min, 5 min, 1 min, 40 sec, 20 sec, 10 sec, 9 sec, 8 sec, 7 sec, 6 sec, 5 sec, 4 sec, 3 sec, 2 sec, or 1 sec. A layer of the 3D can be formed within any time between the aforementioned time scales (e.g., from about 1 hour to about 1 sec, from about 1 sec to about 1 min, from about 1 sec to about 40 sec, from about 10 sec to about 1 sec, or from about 1 sec to about 5 sec). The layer of the 3D object can have a FLS of the printed 3D object.

The generated 3D object can require very little or no further processing after its retrieval. In some examples, the diminished further processing or lack thereof, will afford a 3D printing process that requires smaller amount of energy and/or less waste as compared to commercially available 3D printing processes. The smaller amount can be smaller by at least about 1.1, 1.3, 1.5, 2, 3, 4, 5, 6, 7, 8, 9, or 10. The smaller amount may be smaller by any value between the aforementioned values (e.g., from about 1.1 to about 10, or from about 1.5 to about 5). Further processing may comprise trimming, as disclosed herein. Further processing may comprise polishing (e.g., sanding). For example, in some cases the generated 3D object can be retrieved and finalized without removal of transformed material and/or auxiliary features. The 3D object can be retrieved when the 3D part, composed of hardened (e.g., solidified) material, is at a handling temperature that is suitable to permit the removal of the 3D object from the material bed without its substantial deformation. Substantial deformation is in relation to the intended purpose of the 3D object. The handling temperature can be a temperature that is suitable for packaging of the 3D object (e.g., without substantial deformation). The handling temperature a can be at most about 120° C., 100° C., 80° C., 60° C., 40° C., 30° C., 25° C., 20° C., 10° C., or 5° C. The handling temperature can be of any value between the aforementioned temperature values (e.g., from about 120° C. to about 20° C., from about 40° C. to about 5° C., or from about 40° C. to about 10° C.).

The 3D object can be formed without auxiliary support and/or without contacting a building platform (e.g., a base, a substrate, or a bottom of an enclosure). The one or more auxiliary features (e.g., which may include a base support) can be used to hold and/or restrain the 3D object (E.g., during its formation). In some cases, one or more auxiliary supports can be used to anchor or hold a 3D object (or a portion thereof) in a material bed. The one or more auxiliary supports (e.g., features) can be specific to a 3D part. These one or more auxiliary supports may increase the time needed to form the 3D object. The one or more auxiliary features can be removed prior to use or distribution of the 3D object. The longest dimension of a cross-section of an auxiliary feature can be at most about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be at least about 50 nm, 100 nm, 200 nm, 300 nm, 400 nm, 500 nm, 600 nm, 700 nm, 800 nm, 900 nm, or 1000 nm, 1 μm, 3 μm, 10 μm, 20 μm, 30 μm, 100 μm, 200 μm, 300 μm, 400 μm, 500 μm, 700 μm, 1 mm, 3 mm, 5 mm, 10 mm, 20 mm, 30 mm, 50 mm, 100 mm, or 300 mm. The longest dimension of a cross-section of an auxiliary feature can be any value between the above-mentioned values (e.g., from about 50 nm to about 300 mm, from about 5 μm to about 10 mm, from about 50 nm to about 10 mm, or from about 5 mm to about 300 mm). Eliminating the need for one or more auxiliary features can decrease the time and/or cost associated with generating the 3D part. In some examples, the 3D object may be formed with auxiliary features. In some examples, the 3D object may be formed with contact to the container accommodating the material bed (e.g., side(s) and/or bottom of the container). The auxiliary support may contact, and not connect (e.g., anchor) to the platform.

The methods, apparatuses, software, and/or systems provided herein can result in fast and efficient formation of 3D object(s). In some cases, the 3D object can be transported within at most about 120 min, 100 min, 80 min, 60 min, 40 min, 30 min, 20 min, 10 min, or 5 min after the last layer of the object hardens (e.g., solidifies). In some cases, the 3D object can be transported within at least about 120 min, 100 min, 80 min, 60 min, 40 min, 30 min, 20 min, 10 min, or 5 min after the last layer of the object hardens. In some cases, the 3D object can be transported within any time between the above-mentioned values (e.g., from about 5 min to about 120 min, from about 5 min to about 60 min, or from about 60 min to about 120 min). The 3D object can be transported once it cools to a temperature of at most about 100° C., 90° C., 80° C., 70° C., 60° C., 50° C., 40° C., 30° C., 25° C., 20° C., 15° C., 10° C., or 5° C. The 3D object can be transported once it cools to a temperature value between the above-mentioned temperature values (e.g., from about 5° C. to about 100° C., from about 5° C. to about 40° C., or from about 15° C. to about 40° C.). Transporting the 3D object can comprise packaging and/or labeling the 3D object. In some cases, the 3D object can be transported directly to a consumer, government, organization, company, hospital, medical practitioner, engineer, retailer, or any other entity or individual that is interested in receiving the 3D object. Transporting comprises not (e.g., substantially) deforming the 3D object.

The system, software, method and/or apparatus can comprise a controlling mechanism (e.g., a controller) comprising a computer-processing unit (e.g., a computer) coupled to any of the systems, software, methods and/or apparatuses mentioned herein, or their respective components (e.g., the energy source(s)). The computer can be operatively coupled through a wired or through a wireless connection. In some cases, the computer can be on board a user device. A user device can be a laptop computer, desktop computer, tablet, smartphone, or another computing device. The user device can be portable or stationary. The controller can be in communication with a cloud computer system or a server. The controller can be programmed to (e.g., selectively) direct the energy source(s) to apply energy to the at least a portion of the source surface and/or target surface with a certain energy beam characteristics (e.g., power per unit area). The controller can be in communication with the scanner configured to articulate the energy source(s) to apply energy to at least a portion of the source surface and/or target surface at a certain energy beam characteristics (e.g., power per unit area). The characteristics may comprise wavelength, power, power per unit area, amplitude, trajectory, footprint, intensity, energy, or charge. The charge can be electrical and/or magnetic charge.

The scanner can be included in an optical system that is configured to direct energy from a first energy source to a predetermined position on the source surface, target surface, or the stream of falling particulate material (e.g., 805). The controller can be programmed to control a trajectory of the energy source(s) with the aid of the optical system. The control system can regulate a supply of energy from the energy source to the material (e.g., at the target surface and/or the stream of falling particulate material) to form a transformed material. Transformed may comprise transformation in physical state (e.g., solid to liquid) or in shape of the pre-transformed (e.g., particulate) material.

One or more of the system components can be contained in the enclosure (e.g., platform seals, FIG. 1, 103). One or more of the system components can be contained out of the enclosure (e.g., an energy source, FIG. 1, 114). The enclosure can include a reaction space that is suitable for introducing a precursor to form a 3D object, such as a particulate material (e.g., 104). The enclosure can contain the building platform (e.g., 102 and 109). The energy source may be disposed outside of the enclosure (e.g., FIG. 1, 114), and the emitted energy beam (e.g., 101) can travel into the enclosure (e.g., 115) though an optical window (e.g., 116) that (e.g., substantially) retains the characteristics of the energy beam (e.g., amplitude, power per unit area, focus, or cross section) as it travels though the optical window.

In some cases, the enclosure can be a vacuum chamber, a positive pressure chamber, or an ambient pressure chamber. The enclosure can comprise a gaseous environment with a controlled pressure, temperature, and/or gas composition. The gas composition in the environment contained by the enclosure can comprise a substantially oxygen free environment. For example, the gas composition can contain at most at most about 100,000 parts per million (ppm), 10,000 ppm, 1000 ppm, 500 ppm, 400 ppm, 200 ppm, 100 ppm, 50 ppm, 10 ppm, 5 ppm, 1 ppm, 100,000 parts per billion (ppb), 10,000 ppb, 1000 ppb, 500 ppb, 400 ppb, 200 ppb, 100 ppb, 50 ppb, 10 ppb, 5 ppb, 1 ppb, 100,000 parts per trillion (ppt), 10,000 ppt, 1000 ppt, 500 ppt, 400 ppt, 200 ppt, 100 ppt, 50 ppt, 10 ppt, 5 ppt, or 1 ppt oxygen. The gas composition in the environment contained within the enclosure can comprise a substantially moisture (e.g., water) free environment. The gaseous environment can comprise at most about 100,000 ppm, 10,000 ppm, 1000 ppm, 500 ppm, 400 ppm, 200 ppm, 100 ppm, 50 ppm, 10 ppm, 5 ppm, 1 ppm, 100,000 ppb, 10,000 ppb, 1000 ppb, 500 ppb, 400 ppb, 200 ppb, 100 ppb, 50 ppb, 10 ppb, 5 ppb, 1 ppb, 100,000 ppt, 10,000 ppt, 1000 ppt, 500 ppt, 400 ppt, 200 ppt, 100 ppt, 50 ppt, 10 ppt, 5 ppt, or 1 ppt water (e.g., humidity). The gaseous environment can comprise a gas selected from the group consisting of argon, nitrogen, helium, neon, krypton, xenon, hydrogen, carbon monoxide, carbon dioxide, and oxygen. The gaseous environment can comprise air. The gas can be an ultrahigh purity gas. For example, the ultrahigh purity gas can be at least about 99%, 99.9%, 99.99%, or 99.999% pure. The gas may comprise less than about 2 ppm oxygen, less than about 3 ppm moisture, less than about 1 ppm hydrocarbons, or less than about 6 ppm nitrogen. The enclosure can be maintained under vacuum or under an inert, dry, non-reactive and/or oxygen reduced (or otherwise controlled) atmosphere (e.g., a nitrogen (N₂), helium (He), or argon (Ar) atmosphere). In some examples, the enclosure is under vacuum. The atmosphere can be provided by providing an inert, dry, non-reactive, and/or oxygen reduced gas (e.g., Ar) and/or flowing the gas through the chamber.

In some examples, a pressure system is in (e.g., fluid) communication with the enclosure. The pressure system can be configured to regulate the pressure in the enclosure. In some examples, the pressure system includes one or more vacuum pumps selected from the group consisting of mechanical pumps, rotary vain pumps, turbomolecular pumps, ion pumps, cryopumps, and diffusion pumps. The one or more vacuum pumps may comprise Rotary vane pump, diaphragm pump, liquid ring pump, piston pump, scroll pump, screw pump, Wankel pump, external vane pump, roots blower, multistage Roots pump, Toepler pump, or Lobe pump. The one or more vacuum pumps may comprise momentum transfer pump, regenerative pump, entrapment pump, Venturi vacuum pump, or team ejector. The pressure system can include valves (e.g., throttle valves). The pressure system can comprise a pressure sensor for measuring the pressure of the chamber and relaying the pressure to the controller, which can regulate the pressure with the aid of one or more vacuum pumps of the pressure system. The pressure sensor can be coupled to a control system. The pressure can be electronically or manually controlled.

In some examples, the pressure system includes one or more pumps. The one or more pumps may comprise a positive displacement pump. The positive displacement pump may comprise rotary-type positive displacement pump, reciprocating-type positive displacement pump, or linear-type positive displacement pump. The positive displacement pump may comprise rotary lobe pump, progressive cavity pump, rotary gear pump, piston pump, diaphragm pump, screw pump, gear pump, hydraulic pump, rotary vane pump, regenerative (peripheral) pump, peristaltic pump, rope pump, or flexible impeller. Rotary positive displacement pump may comprise gear pump, screw pump, or rotary vane pump. The reciprocating pump comprises plunger pump, diaphragm pump, piston pumps displacement pumps, or radial piston pump. The pump may comprise a valveless pump, steam pump, gravity pump, eductor-j et pump, mixed-flow pump, bellow pump, axial-flow pumps, radial-flow pump, velocity pump, hydraulic ram pump, impulse pump, rope pump, compressed-air-powered double-diaphragm pump, triplex-style plunger pump, plunger pump, peristaltic pump, roots-type pumps, progressing cavity pump, screw pump, or gear pump.

The software, apparatuses, systems, and/or methods presented herein can facilitate formation of custom (e.g., or stock) 3D objects for a customer. A customer can be an individual, corporation, organization, government organization, non-profit organization, or another type of organization or entity. A customer can submit a request for formation of a 3D object. The customer can provide an item of value in exchange for the 3D object. The customer can provide a design or a model for the desired/requested 3D object. The customer can provide the design in the form of a stereo lithography (STL) file. The customer can provide a design where the design can be a definition of the shape and dimensions of the 3D object in any other numerical or physical form. In some cases, the customer can provide a 3D model, sketch, and/or image as a design of an object to be generated. The design can be transformed to instructions usable by the 3D printer to (e.g., additively) generate the 3D object. The customer can further provide a request to form the 3D object from a specific material(s) or group of materials. For example, the customer can specify that the 3D object should be made from one or more than one of the materials used for 3D printing described herein. The customer can request a specific material within that group of material (e.g., a specific elemental metal, a specific alloy, a specific ceramic or a specific allotrope of elemental carbon). In some cases, the design does not contain auxiliary features.

In response to the customer request the 3D object can be generated. In some cases, the 3D object can be formed by an additive 3D printing process. Additively generating the 3D object can comprise successively depositing and melting a powder comprising one or more materials as specified by the customer. The 3D object can subsequently be delivered to the customer. The 3D object can be formed without generation (e.g., during the 3D printing) or removal of auxiliary features. Auxiliary features can be support features that prevent a 3D object (or a portions thereof) from shifting, deforming or moving during formation. In some cases, the 3D object can be additively generated in a period of at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 sec, or 10 sec. In some cases, the 3D object can be additively generated in a period between any of the aforementioned time periods (e.g., from about 10 sec to about 7 days, from about 10 sec to about 12 hours, from about 12 hours to about 7 days, or from about 12 hours to about 10 min).

The 3D object (e.g., that is generated for the customer) can have an average deviation value (from its intended dimensions) of at most about 0.5 microns (μm), 1 μm, 3 μm, 10 μm, 30 μm, 100 μm, or 300 μm. The deviation can be any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). The 3D object can have a deviation from the intended dimensions in a specific direction according to the formula Dv+L/K_{Dv}, wherein Dv is a deviation value, L is the length of the 3D object in a specific direction, and K_{Dv} is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, or 300 μm. Dv can have any value between the aforementioned values (e.g., from about 0.5 μm to about 300 μm, from about 10 μm to about 50 μm, from about 15 μm to about 85 μm, from about 5 μm to about 45 μm, or from about 15 μm to about 35 μm). K_{dv} can have a value of at most about 3000, 2500, 2000, 1500, 1000, or 500. K_{dv} can have a value of at least about 500, 1000, 1500, 2000, 2500, or 3000. K_{dv} can have any value between the aforementioned values (e.g., from about 3000 to about 500, from about 1000 to about 2500, from about 500 to about 2000, from about 1000 to about 3000, or from about 1000 to about 2500). The deviation may be in shape and/or in volume.

The 3D object may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%).

The 3D object (e.g., that is generated for the customer) can have an average density deviation value (from its intended dimensions) of at most about 30%, 20%, 10%, 5%, 2%, 1%, or 0.5%. The 3D object may have an average density deviation value between any of the aforementioned values (e.g., from about 30% to about 0.5%, from about 30% to about 10%, or from about 10% to about 0.5%). The material density of the generated 3D object may be (e.g., substantially) the requested material density of the 3D object. Substantially may be relative to the intended use of the 3D object.

The intended dimensions of the 3D object (or a portion thereof) can be derived from a model design. The 3D part can have the stated accuracy value immediately after its formation, without additional processing or manipulation. Receiving the order for the 3D object, formation of the 3D object, and delivery of the 3D object to the customer can take at most about 7 days, 6 days, 5 days, 3 days, 2 days, 1 day, 12 hours, 6 hours, 5 hours, 4 hours, 3 hours, 2 hours, 1 hour, 30 min, 20 min, 10 min, 5 min, 1 min, 30 seconds, or 10 seconds. In some cases, the 3D object can be (e.g., additively) generated in a period between any of the aforementioned time periods (e.g., from about 10 sec to about 7 days, from about 10 sec to about 12 hours, from about 12 hours to about 7 days, or from about 12 hours to about 10 min). The time can vary based on the physical characteristics of the 3D object, including the size and/or complexity of the 3D object. The generation of the 3D object can be performed without iterative and/or without corrective printing. The 3D object may be devoid of auxiliary supports (e.g., during the 3D printing) or an auxiliary support mark(s) (e.g., that is indicative of a presence or removal of the auxiliary support feature).

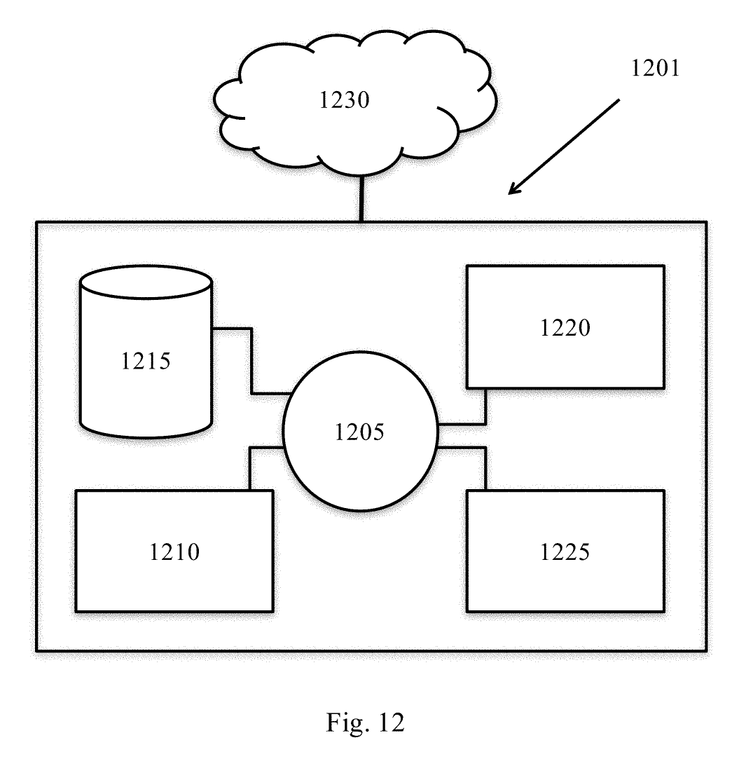

The methods, systems, software, and/or apparatuses disclosed herein may incorporate a controller mechanism that controls one or more of the components described herein. The controller may comprise a central processing unit (herein “CPU”). The controllers or control mechanisms (e.g., comprising a computer system) may be programmed to implement methods of the disclosure. The controller may control at least one component of the systems and/or apparatuses disclosed herein. FIG. 12 schematically depicts a computer system 1201 that is programmed or otherwise configured to facilitate the formation of a 3D object according to the methods provided herein. The computer system 1201 can regulate various features of printing methods, apparatuses and systems of the present disclosure, such as for example, regulating charging, translation, heating, cooling and/or maintaining the temperature of a material bed, process parameters (e.g., chamber pressure and/or temperature), scanning route (e.g., of the energy beam), trajectory (e.g., of the particulate material), application of the amount of energy emitted to a selected location, or any combination thereof. The computer system 1201 can be part of, or be in communication with, a 3D printing system and/or apparatus. The computer may be coupled to one or more mechanisms disclosed herein, and/or any parts thereof. For example, the computer may be coupled to one or more sensors, valves, switches, motors, pumps, or any combination thereof.

The computer system 1201 can include a central processing unit (CPU, also “processor,” “computer” and “computer processor” used herein) 1205, which can be a single core or multi core processor, or a plurality of processors for parallel processing. Alternatively or in addition to, the computer system 1201 can include a circuit, such as an application-specific integrated circuit (ASIC). The computer system 1201 also includes memory or memory location 1210 (e.g., random-access memory, read-only memory, or flash memory), electronic storage unit 1215 (e.g., hard disk), communication interface 1220 (e.g., network adapter) for communicating with one or more other systems, and peripheral devices 1225, such as cache, other memory, data storage and/or electronic display adapters. The memory 1210, storage unit 1215, interface 1220, and peripheral devices 1225 can be in communication with the CPU 1205 through a communication bus (solid lines), such as a motherboard. The storage unit 1215 can be a data storage unit (or data repository) for storing data. The computer system 1201 can be operatively coupled to a computer network (“network”) 1230 with the aid of the communication interface 1220. The network 1230 can be the Internet, an Internet and/or extranet, or an intranet and/or extranet that is in communication with the Internet. The network 1230, in some cases, is a telecommunication and/or data network. The network 1230 can include one or more computer servers, which can enable distributed computing, such as cloud computing. The network 1230, in some cases with the aid of the computer system 1201, can implement a peer-to-peer network, which may enable devices coupled to the computer system 1201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, or write back.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and/or saved programs. The storage unit 1215 can store user data, e.g., user preferences and/or user programs. The computer system 1201, in some cases, can include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein can be implemented by way of machine (e.g., computer processor) executable code stored on an electronic storage location of the computer system 1201, such as for example, on the memory 1210 and/or electronic storage unit 1215. The machine executable or machine-readable code can be provided in the form of software. During use, the processor 1205 can execute the code. In some cases, the code can be retrieved from the storage unit 1215 and stored on the memory 1210 for ready access by the processor 1205. In some situations, the electronic storage unit 1215 can be precluded, and machine-executable instructions can be stored on memory 1210.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems, apparatuses, and/or methods provided herein, such as the computer system 1201, can be embodied in programming (e.g., software). Various aspects of the technology may be thought of as “products” or “articles of manufacture” typically in the form of machine (or processor) executable code and/or associated data that is carried on or embodied in a type of machine-readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof; such as various semiconductor memories, tape drives, and/or disk drives, which may provide non-transitory storage at any time for the software programming. All or portions of the software may at times be communicated through the Internet or various other telecommunication networks. Such communications, for example, may enable loading of the software from one computer or processor into another. For example, from a management server or host computer into the computer platform of an application server. Another type of media that may bear the software elements includes optical (e.g., electromagnetic), or electrical waves, such as used across physical interfaces between local devices, through wired and/or optical landline networks and over various air-links. The physical elements that carry such waves, such as wired links, wireless links, or optical links may also be considered as media bearing the software. As used herein, unless restricted to non-transitory, tangible “storage” media, terms such as computer or machine “readable medium” refer to any medium that participates in providing instructions to a processor for execution.

Hence, a machine-readable medium, such as computer-executable code, may take many forms, including but not limited to, a tangible storage medium, a carrier wave medium, or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables, wire (e.g., copper wire), and/or fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms that have been pre-programmed. The feedback mechanism may comprise an encoder. The encoder may comprise an optical encoder (e.g., an absolute optical linear encoder). The feedback mechanisms may rely on input from sensors (described herein) that are connected to the control unit (i.e., control system or control mechanism (e.g., computer). The computer system may store historical data concerning various aspects of the operation of the 3D printing system. The historical data may be retrieved at predetermined times and/or at a whim. The historical data may be accessed by an operator and/or user. The historical and/or operative data may be displayed on a display unit. The display unit (e.g., monitor) may display various parameters of the 3D printing system (e.g., as described herein) in real-time or in a delayed time. Real-time may refer to during the 3D printing process. The display unit may display the current 3D printed object, the ordered 3D printed object, or both. The display unit may display the printing progress of the 3D printed object. The display unit may display at least one of the total time, time remaining, and time expanded on printing the 3D object. The display unit may display the status of sensors, their reading, and/or time for their calibration or maintenance. The display unit may display the type of particulate material(s) used and/or various characteristics of the material such as temperature and flowability of the particulate material. The display unit may display the amount of oxygen, water, and/or pressure in the printing chamber (i.e., the chamber where the 3D object is being printed). The computer may generate a report comprising various parameters of the 3D printing at predetermined time(s), on a request (e.g., from an operator), at a whim, or any combination thereof. The display unit may comprise a screen and/or a sound. The display unit may comprise a printer. The controller may provide a report. The report may comprise any items recited as optionally displayed by the display unit.

Methods, systems, and/or apparatuses of the present disclosure can be implemented by way of one or more algorithms. An algorithm can be implemented by way of software upon execution by one or more computer processors.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations, or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for forming a three-dimensional object, comprising:
(a) generating a first pattern comprising a powder material on a first surface, which first pattern is in accordance with a model design of the three-dimensional object, wherein the first surface comprises a curved surface;
(b) depositing at least a portion of the powder material directly from the first pattern on the first surface to a second surface though a gap, wherein the first surface and the second surface are separated by the gap; and
(c) forming at least a portion of a generated three-dimensional object from the at least a portion of the powder material on the second surface, which generated three-dimensional object substantially corresponds to the model design of the three-dimensional object.

2. The method of claim 1, wherein directly from the first pattern on the first surface to a second surface though a gap comprises obstacle free through the gap.

3. The method of claim 1, wherein the gap is an atmospheric gap.

4. The method of claim 1, wherein the gap comprises a gas.

5. The method of claim 1, wherein the gap excludes a third surface to which the powder material is deposited.

6. The method of claim 1, wherein the generating in (a) comprises an attractive force.

7. The method of claim 6, wherein the attractive force comprises electrical or magnetic force.

8. The method of claim 1, wherein the first surface comprises a photoconductive material.

9. The method of claim 1, wherein the generating in (a) comprises using an energy beam.

10. The method of claim 9, wherein the energy beam comprises an alteration in a charge of the first surface.

11. The method of claim 1, wherein the second surface is an exposed surface of a powder bed or a platform.

12. The method of claim 11, wherein the second surface is an exposed surface of a powder bed.

13. The method of claim 1, wherein the forming comprises layer by layer forming.

14. The method of claim 1, wherein the second surface is substantially planar.

15. The method of claim 1, wherein the depositing comprises an electrode that repels the powder material from the first surface.

16. The method of claim 1, wherein the depositing comprises an electrode that attracts the powder material from the first surface.

17. The method of claim 1, wherein the depositing comprises using a charged particle optical device.

18. The method of claim 1, wherein the depositing comprises imaging.

19. The method of claim 18, wherein the imaging comprises forming on the second surface a second pattern comprising the powder material of the first pattern.

20. The method of claim 19, wherein the second pattern is substantially identical to the first pattern.

21. The method of claim 19, wherein the second pattern is substantially distorted as compared to the first pattern.

22. The method of claim 21, wherein substantially distorted comprised at least partially enlarged.

23. The method of claim 21, wherein substantially distorted comprised at least partially blurred.

24. The method of claim 21, wherein substantially distorted comprised at least partially focused.

25. The method of claim 21, wherein substantially distorted comprised at least partially shifted.

26. The method of claim 1, wherein the depositing comprises deforming at least a portion of the powder material.

27. The method of claim 26, wherein the deforming comprises plastically deforming.

28. The method of claim 1, wherein the generated three-dimensional object deviates by at most about a sum of 25 micrometers and 1/1000 times a fundamental length scale of the model design of the three-dimensional object.

29. The method of claim 1, wherein a shape of the generated three-dimensional object deviates by at most about ten percent from the model design of the three-dimensional object.

30. The method of claim 1, wherein a volume of the generated three-dimensional object deviates by at most about ten percent from the model design of the three-dimensional object.

31. The method of claim 1, wherein a material density of the generated three-dimensional object deviates by at most about ten percent from a requested material density of the three-dimensional object.
